(19) United States
(12) Patent Application Publication
(10) Pub. No.: US 2016/0227253 A1
(43) Pub. Date: Aug. 4, 2016

(54) DECODING DEVICE, DECODING METHOD, ENCODING DEVICE AND ENCODING METHOD

(71) Applicant: SONY CORPORATION, Tokyo (JP)

(72) Inventor: Kazushi Sato, Kanagawa (JP)

(73) Assignee: SONY CORPORATION, Tokyo (JP)

(21) Appl. No.: 15/022,060

(22) PCT Filed: Sep. 29, 2014
(86) PCT No.: PCT/JP2014/075841

§ 371 Date: Mar. 15, 2016

(30) Foreign Application Priority Data
Oct. 11, 2013 (JP) 2013-214119
Nov. 11, 2013 (JP) 2013-233161

(51) Int. Cl. H04N 19/625; H04N 19/44; H04N 19/139; H04N 19/70; H04N 19/30; H04N 19/107; H04N 19/117; H04N 19/86; H04N 19/159; H04N 19/124; H04N 19/61; H04N 19/593; H04N 19/82; H04N 19/122; H04N 19/52

(52) U.S. Cl. CPC H04N 19/625; H04N 19/52; H04N 19/44; H04N 19/139; H04N 19/70; H04N 19/30; H04N 19/107; H04N 19/117; H04N 19/86; H04N 19/159; H04N 19/124; H04N 19/61; H04N 19/593; H04N 19/82; H04N 19/122

(57) ABSTRACT

The present disclosure relates to a decoding device, a decoding method, an encoding device, and an encoding method, which are capable of improving encoding efficiency by optimizing a transform skip. An inverse orthogonal transform unit performs a transform skip in one of a horizontal direction and a vertical direction on residual information serving as a difference between an image and a predicted image of the image that has undergone the transform skip in one of the horizontal direction and the vertical direction. The present disclosure can be applied to, for example, a decoding device according to a high efficiency video coding (HEVC) scheme in which a transform skip can be performed.

### TECHNICAL FIELD

The present disclosure relates to a decoding device, a decoding method, an encoding device, and an encoding method, and more particularly, a decoding device, a decoding method, an encoding device, and an encoding method, which are capable of improving coding efficiency by optimizing a transform skip.

### BACKGROUND ART

In recent years, devices complying with a scheme such as a Moving Picture Experts Group phase (MPEG) in which compression is performed by orthogonal transform such as discrete cosine transform (DCT) and motion compensation using image information-specific redundancy have become widespread for the purpose of information delivery of broadcasting stations and information reception in general households.

Particularly, MPEG 2 (ISO/IEC 13818-2) scheme is defined as a general-purpose image encoding scheme. MPEG 2 is a standard that covers interlaced scan images, progressive scan images, standard resolution images, and high definition images. MPEG 2 is now being widely used in a wide range of applications such as professional use and consumer use. Using the MPEG 2 scheme, for example, a high compression rate and an excellent image quality can be implemented by allocating a bit rate of 4 to 8 Mbps in the case of an interlaced scanned image of a standard resolution having 720×480 pixels and a code amount of 18 to 22 MBps in the case of an interlaced scanned image of a high resolution having 1920×1088 pixels.

MPEG 2 is mainly intended for high definition coding suitable for broadcasting but does not support an encoding scheme having a coding amount (bit rate) lower than that of MPEG 1, that is, an encoding scheme of a high compression rate. With the spread of mobile terminals, it is considered that the need for such an encoding scheme will increase in the future, and thus an MPEG 4 encoding scheme has been standardized. An international standard for an image encoding scheme of MPEG 4 was approved as ISO/IEC 14496-2 in December, 1998.

Further, in recent years, standards such as H.26L (ITU-T Q6/16 VCEG) for the purpose of image encoding for video conferences have been standardized. H.26L requires a larger computation amount for encoding and decoding than in encoding schemes such as MPEG 2 or MPEG 4, but is known to implement high encoding efficiency.

Further, currently, as one activity of MPEG 4, standardization of incorporating even a function that is not supported in H.26L and implementing high encoding efficiency based on H.26L has been performed as a Joint Model of Enhanced-Compression Video Coding. As a standardization schedule, an international standard called H.264 and MPEG-4 Part10 (Advanced Video Coding (AVC)) was established in March, 2003.

Furthermore, as an extension of H.264/AVC, Fidelity Range Extension (FRExt) including an encoding tool necessary for professional use such as RGB or a chrominance signal format of 4:2:2 or 4:4:4 or 8×8 discrete cosine transform (DCT) and a quantization matrix which are specified in MPEG-2 was standardized in February, 2005. As a result, the AVC scheme has become an encoding scheme capable of also expressing film noise included in movies well and is being used in a wide range of applications such as Blu-ray™ Discs (BD).

However, in recent years, there is an increasing need for high compression rate encoding capable of compressing an image of about 4000×2000 pixels, which is 4 times that of a high-definition image, or delivering a high-definition image in a limited transmission capacity environment such as the Internet. To this end, improvements in encoding efficiency have been under continuous review by Video Coding Experts Group (VCEG) under ITU-T.

Further, currently, in order to further improve the encoding efficiency to be higher than in AVC, Joint Collaboration Team-Video Coding (JCTVC), which is a joint standardization organization of ITU-T and ISO/IEC, has been standardizing an encoding scheme called High Efficiency Video Coding (HEVC). Non-Patent Document 1 was currently issued as a draft in October, 2013.

Meanwhile, in HEVC, it is possible to use a function such as a transform skip in which orthogonal transform or inverse orthogonal transform is not performed on a transform unit (TU) when the TU size is 4×4 pixels.

In other words, when an image to be currently encoded is a computer graphics (CG) or an unnatural image such as a screen of a personal computer, 4×4 pixels is likely to be selected as the TU size. Further, in the unnatural image, there are cases in which when the orthogonal transform is not performed, the encoding efficiency is increased. Thus, in HEVC, when the TU size is 4×4 pixels, the transform skip applied to improve the encoding efficiency.

The transform skip is applicable to both a luminance signal and a chrominance signal. The transform skip is applicable regardless of whether encoding is performed in the intra prediction mode or the inter prediction mode.

On the other hand, in Non-Patent Document 2, an encoding scheme of improving encoding an image or screen content of a chrominance signal format such as 4:2:2 or 4:4:4 has been reviewed.

Further, in Non-Patent Document 3, the encoding efficiency when the transform skip is applied to the TU having the larger size than 4×4 pixels has been reviewed.

In addition, in Non-Patent Document 4, an application of the transform skip to the minimum size of the TU when the minimum size of the TU is 8×8 pixels rather than 4×4 pixels has been reviewed.

### CITATION LIST

### Non-Patent Documents

Non-Patent Document 1: Benjamin Bross, Gary J. Sullivan, Ye-Kui Wang, “Editors' proposed corrections to HEVC version 1,” JCTVC-M0432_v3, 2013.4.18-4.26
Non-Patent Document 2: David Flynn, Joel Sole, Teruhiko Suzuki, “High Efficiency Video Coding (HEVC), Range Extension text specification: Draft 4,” JCTVC-N1005_v1, 2013.4.18-4.26
Non-Patent Document 3: Xiulian Peng, Jizheng Xu, Liwei Guo, Joel Sole, Marta Karczewicz, “Non-RCE2:Transform skip on large TUs,” JCTVC-N0288_r1, 2013.7.25-8.2
Non-Patent Document 4: Kwanghyun Won, Seungha Yang, Byeungwoo Jeon, “Transform skip based on minimum TU size,” JCTVC-N0167, 2013.7.25-8.2

### SUMMARY OF THE INVENTION

### Problems to be Solved by the Invention

In HEVC, it is difficult to set whether or not the transform skip is executed separately in a horizontal direction and a vertical direction. Thus, the transform skip is performed in neither the horizontal direction nor the vertical direction or performed in both the horizontal direction and the vertical direction.

However, there are cases in which when the orthogonal transform is performed in one of the horizontal direction and the vertical direction, the encoding efficiency is improved or when the orthogonal transform is not performed in the other of the horizontal direction and the vertical direction, the encoding efficiency is improved, and vice versa. In this case, it is desirable to improve the encoding efficiency by performing transform skip optimization such that the transform skip is not performed in one of the horizontal direction and the vertical direction, and the transform skip is performed in the other of the horizontal direction and the vertical direction.

The present disclosure was made in light of the foregoing, and it is desirable to improve the encoding efficiency by optimizing the transform skip.

### Solutions to Problems

A decoding device according to the first aspect of the present disclosure includes an inverse orthogonal transform unit that performs a transform skip in one of a horizontal direction and a vertical direction on a difference between an image and a predicted image of the image that has undergone the transform skip in one of the horizontal direction and the vertical direction.

A decoding method according to the first aspect of the present disclosure corresponds to the decoding device according to the first aspect of the present disclosure.

In the first aspect of the present disclosure, the transform skip in one of the horizontal direction and the vertical direction is performed on a difference of an image and a predicted image of the image that has undergone the transform skip in one of the horizontal direction and the vertical direction.

An encoding device according to the second aspect of the present disclosure includes an orthogonal transform unit that performs a transform skip in one of a horizontal direction and a vertical direction on a difference between an image and a predicted image of the image.

An encoding method according to the second aspect of the present disclosure corresponds to the encoding device according to the second aspect of the present disclosure.

In the second aspect of the present disclosure, the transform skip is performed on a difference between an image and a predicted image of the image in one of the horizontal direction and the vertical direction.

The decoding devices according to the first aspect and the encoding devices according to the second aspect may be implemented by causing a computer to execute a program.

The program executed by the computer to implement the decoding devices according to the first aspect and the encoding devices according to the second aspect may be provided such that the program is transmitted via a transmission medium or recorded in a recording medium.

The decoding device according to the first aspect and the encoding device according to the second aspect may be an independent device or may be an internal block configuring a single device.

### Effects of the Invention

According to the first aspect of the present disclosure, it is possible to perform decoding. Further, according to the first aspect of the present disclosure, it is possible decode an encoded stream in which the encoding efficiency has been improved by optimizing the transform skip.

According to the second aspect of the present disclosure, it is possible to perform encoding. Further, according to the second aspect of the present disclosure, it is possible improve the encoding efficiency by optimizing the transform skip.

The effects described herein are not necessarily limited, and any effect described in the present disclosure may be obtained.

### BRIEF DESCRIPTION OF DRAWINGS

FIG. 1 is a block diagram illustrating an exemplary configuration of an encoding device according to a first embodiment of the present disclosure.

FIG. 2 is a diagram for describing transmission of a scaling list.

FIG. 3 is a block diagram illustrating an exemplary configuration of an encoding unit of FIG. 1.

FIG. 4 is a diagram for describing a CU.

FIG. 5 is a block diagram illustrating an exemplary configuration of an orthogonal transform unit, a quantization unit, and a skip control unit of FIG. 3.

FIG. 6 is a diagram for describing a method of deciding a scaling list through a list decision unit of FIG. 5.

FIG. 7 is a block diagram illustrating an exemplary configuration of an inverse quantization unit, an inverse orthogonal transform unit, and a skip control unit of FIG. 3.

FIG. 8 is a diagram illustrating an example of syntax of residual_coding.

FIG. 9 is a diagram illustrating an example of syntax of residual_coding.

FIG. 10 is a flowchart for describing a stream generation process.

FIG. 11 is a flowchart for describing the details of an encoding process of FIG. 10.

FIG. 12 is a flowchart for describing the details of an encoding process of FIG. 10.

FIG. 13 is a flowchart for describing a horizontal/vertical orthogonal transform process of FIG. 11.

FIG. 14 is a flowchart for describing a horizontal/vertical inverse orthogonal transform process of FIG. 12.

FIG. 15 is a block diagram illustrating an exemplary configuration of a decoding device according to a first embodiment of the present disclosure.

FIG. 16 is a block diagram illustrating an exemplary configuration of a decoding unit of FIG. 15.

FIG. 17 is a flowchart for describing an image generation process of a decoding device of FIG. 15.

FIG. 18 is a flowchart for describing the details of a decoding process of FIG. 17.

FIG. 19 is a diagram illustrating an example of a PU of inter prediction.

FIG. 20 is a diagram illustrating a shape of a PU of inter prediction.

FIG. 21 is a block diagram illustrating an exemplary configuration of an encoding unit of an encoding device according to a second embodiment of the present disclosure.

FIG. 22 is a diagram for describing a rotation process by a rotation unit.

FIG. 23 is a flowchart for describing an encoding process of an encoding unit of FIG. 21.

FIG. 24 is a flowchart for describing an encoding process of an encoding unit of FIG. 21.

FIG. 25 is a flowchart for describing the details of a rotation process of FIG. 23.

FIG. 26 is a block diagram illustrating an exemplary configuration of a decoding unit of a decoding device according to a second embodiment according to the present disclosure.

FIG. 27 is a flowchart for describing a decoding process of a decoding unit of FIG. 26.

FIG. 28 is a block diagram illustrating an exemplary hardware configuration of a computer.

FIG. 29 is a diagram illustrating an exemplary multi-view image coding scheme.

FIG. 30 is a diagram illustrating an exemplary configuration of a multi-view image encoding device to which the present disclosure is applied.

FIG. 31 is a diagram illustrating an exemplary configuration of a multi-view image decoding device to which the present disclosure is applied.

FIG. 32 is a diagram illustrating an exemplary scalable image coding scheme.

FIG. 33 is a diagram for describing exemplary spatial scalable coding.

FIG. 34 is a diagram for describing exemplary temporal scalable coding.

FIG. 35 is a diagram for describing exemplary scalable coding of a signal-to-noise ratio.

FIG. 36 is a diagram illustrating an exemplary configuration of a scalable image encoding device to which the present disclosure is applied.

FIG. 37 is a diagram illustrating an exemplary configuration of a scalable image decoding device to which the present disclosure is applied.

FIG. 38 is a diagram illustrating an exemplary schematic configuration of a television device to which the present disclosure is applied.

FIG. 39 is a diagram illustrating an exemplary schematic configuration of a mobile telephone to which the present disclosure is applied.

FIG. 40 is a diagram illustrating an exemplary schematic configuration of a recording/reproducing device to which the present disclosure is applied.

FIG. 41 is a diagram illustrating an exemplary schematic configuration of an imaging device to which the present disclosure is applied.

FIG. 42 is a block diagram illustrating a scalable coding application example.

FIG. 43 is a block diagram illustrating another scalable coding application example.

FIG. 44 is a block diagram illustrating another scalable coding application example.

FIG. 45 illustrates an exemplary schematic configuration of a video set to which the present disclosure is applied.

FIG. 46 illustrates an exemplary schematic configuration of a video processor to which the present disclosure is applied.

FIG. 47 illustrates another exemplary schematic configuration of a video processor to which the present disclosure is applied.

### MODE FOR CARRYING OUT THE INVENTION

### First Embodiment

### Exemplary Configuration of Encoding Device According to First Embodiment

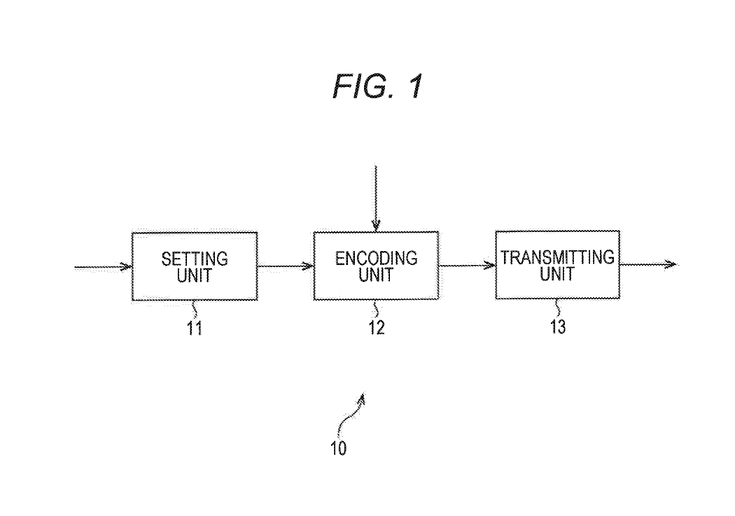

FIG. 1 is a block diagram illustrating an exemplary configuration of an encoding device according to a first embodiment of the present disclosure.

An encoding device 10 of FIG. 1 includes a setting unit 11, an encoding unit 12, and a transmitting unit 13 and encodes an image according to a scheme based on a HEVC scheme.

Specifically, the setting unit 11 of the encoding device 10 sets a Sequence Parameter Set (SPS) including a scaling list (a quantization matrix). The setting unit 11 sets a Picture Parameter Set (PPS) including the scaling list, skip permission information (transform_skip enabled_flag) indicating whether or not an application of the transform skip is permitted, and the like. The skip permission information is 1 when the application of the transform skip is permitted and 0 when the application of the transform skip is not permitted.

The setting unit 21 sets Video Usability Information (VUI), Supplemental Enhancement Information (SEI), and the like. The setting unit 11 supplies the encoding unit 32 with the set parameter sets such as the SPS, the PPS, the VUI, and the SEI.

An image of a frame unit is input to the encoding unit 12. The encoding unit 12 encodes the input image with reference to the parameter sets supplied from the setting unit 11 according to the scheme based on the HEVC scheme. The encoding unit 12 generates an encoded stream from encoded data obtained as a result of encoding and the parameter sets, and supplies the encoded stream to the transmitting unit 13.

The transmitting unit 13 transmits the encoded stream supplied from the encoding unit 12 to a decoding device which will be described later.

(Description of Transmission of Scaling List)

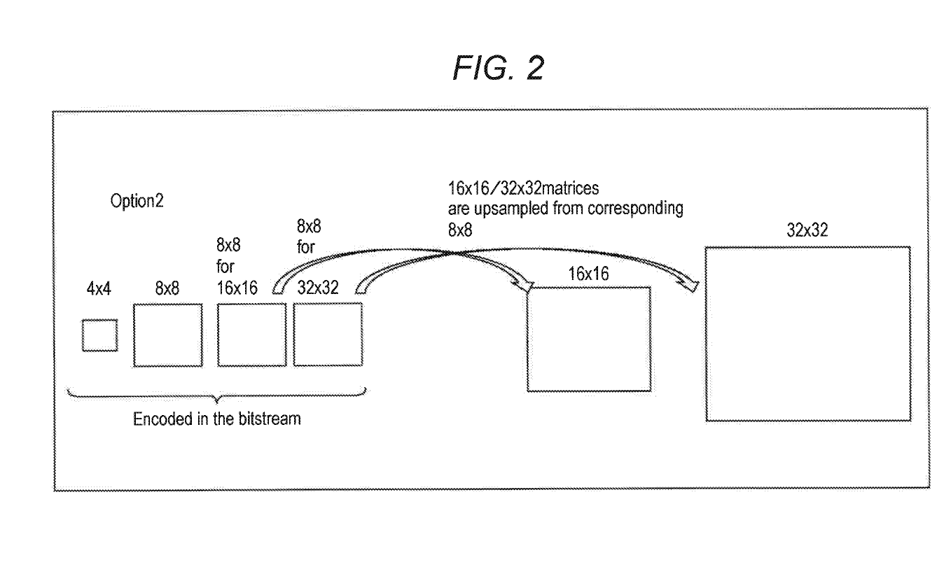

FIG. 2 is a diagram for describing transmission of the scaling list.

In HEVC, 4×4 pixels, 8×8 pixels, 16×16 pixels, or 32×32 pixels can be selected as the TU size as illustrated in FIG. 2. Thus, the scaling list is prepared for each of the sizes. However, since a data amount of the scaling list for the TU having the large size such as 16×16 pixels or 32×32 pixels is large, transmission of the scaling list lowers the encoding efficiency.

In this regard, the scaling list for the TU having the large size such as 16×1.6 pixels or 32×32 pixels is down-sampled to an 8×8 matrix, set to the SPS or the PPS, and transmitted as illustrated in FIG. 2. However, a direct current (DC) component has large influence on an image quality and is thus separately transmitted.

The decoding device up-samples the transmitted scaling list serving as the 8×8 matrix through a zero-order hold, and restores the scaling list for the TU having the large size such as 16×16 pixels or 32×32 pixels.

(Exemplary Configuration of Encoding Unit)

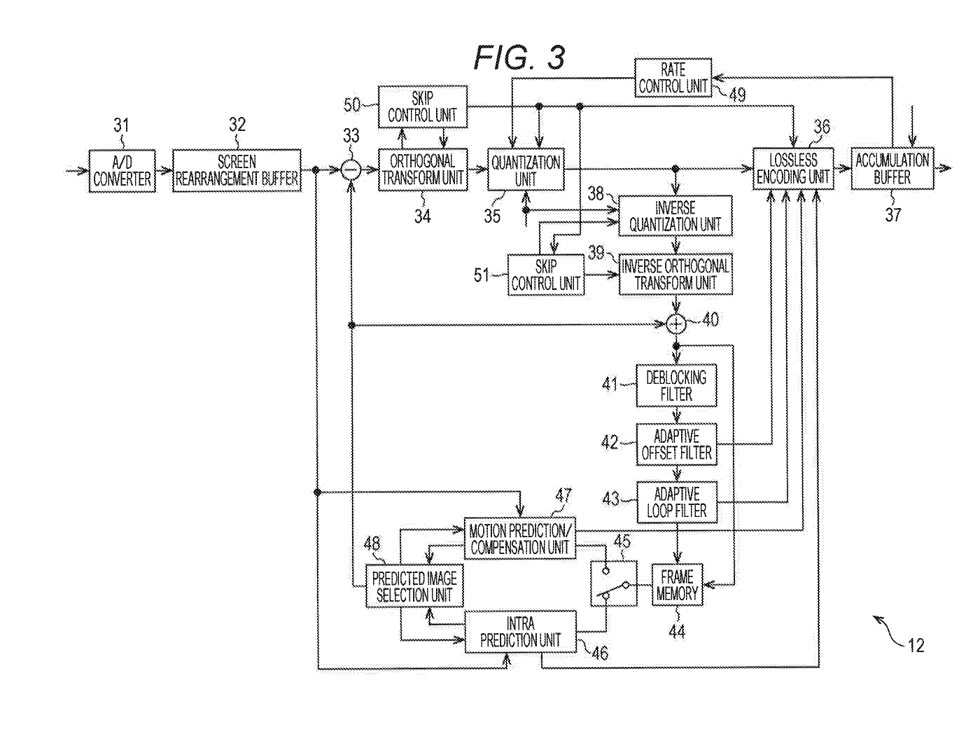

FIG. 3 is a block diagram illustrating an exemplary configuration of the encoding unit 12 of FIG. 1.

An encoding unit 12 of FIG. 3 includes an A/D converter 31, a screen rearrangement buffer 32, an operation unit 33, an orthogonal transform unit 34, a quantization unit 35, a lossless encoding unit 36, an accumulation buffer 37, an inverse quantization unit 38, an inverse orthogonal transform unit 39, and an addition unit 40. The encoding unit 12 further includes a deblocking filter 41, an adaptive offset filter 42, an adaptive loop filter 43, a frame memory 44, a switch 45, an intra prediction unit 46, a motion prediction/compensation unit 47, a predicted image selection unit 48, and a rate control unit 49. The encoding unit 12 further includes a skip control unit 50 and a skip control unit 51.

The A/D converter 31 of the encoding unit 12 performs A/D conversion on an image of a frame unit input as an encoding target. The A/D converter 31 outputs the image serving as the converted digital signal to be stored in the screen rearrangement buffer 32.

The screen rearrangement buffer 32 rearranges the stored image of the frame unit of a display order in an encoding order according to a GOP structure. The screen rearrangement buffer 32 outputs the rearranged image to the operation unit 33, the intra prediction unit 46, and the motion prediction/compensation unit 47.

The operation unit 33 performs encoding by subtracting a predicted image supplied from the predicted image selection unit 48 from the image supplied from the screen rearrangement buffer 32. The operation unit 33 outputs an image obtained as the result to the orthogonal transform unit 34 as residual information (a difference). Further, when no predicted image is supplied from the predicted image selection unit 48, the operation unit 33 outputs an image read from the screen rearrangement buffer 32 to the orthogonal transform unit 34 without change as the residual information.

The orthogonal transform unit 34 performs the orthogonal transform process in the horizontal direction on the residual information provided from the operation unit 33 in units of TUs based on a control signal supplied from the skip control unit 50. Further, the orthogonal transform unit 34 performs the orthogonal transform process in the vertical direction on the result of the orthogonal transform process in the horizontal direction in units of TUs based on the control signal.

The sizes of the TU include 4×4 pixels, 8×8 pixels, 16×16 pixels, and 32×32 pixels. An example of the orthogonal transform scheme includes a discrete cosine transform (DCT). An orthogonal transform matrix of the DCT when the TU is 4×4 pixels, 8×8 pixels, or 16×16 pixels is obtained by thinning out an orthogonal transform matrix of the DCT when the TU is 32×32 pixels to ⅛, ¼, or ½. Thus, the orthogonal transform unit 34 preferably includes an operation unit which is common to all the sizes of the TU, and the orthogonal transform unit 34 need not include an operation unit for each size of the TU.

Further, when an optimal prediction mode is the intra prediction mode, and the TU is 4×4 pixels, discrete sine transform (DST) is used as the orthogonal transform scheme. As described above, when the optimal prediction mode is the intra prediction mode, and the TU is 4×4 pixels, that is, when it is remarkable that as it is closer to an encoded neighboring image, the residual information decreases, the DST is used as the orthogonal transform scheme, and thus the encoding efficiency is improved.

The orthogonal transform unit 34 supplies the residual information that has undergone the orthogonal transform process in the vertical direction to the skip control unit 50 as a final orthogonal transform process result. Further, the orthogonal transform unit 34 supplies an orthogonal transform process result corresponding to an optimal transform skip decided by the skip control unit 50 to the quantization unit 35.

The quantization unit 35 holds the scaling list of each TU size included in the SPS or the PPS. The quantization unit 35 decides the scaling list based on transform skip information indicating the optimal transform skip supplied from the skip control unit 50 and the held scaling list in units of TUs. The quantization unit 35 quantizes the orthogonal transform process result supplied from the orthogonal transform unit 34 using the scaling list in units of TUs. The quantization unit 35 supplies a quantized value obtained as a result of quantization to the lossless encoding unit 36.

The lossless encoding unit 36 acquires the transform skip information supplied from the skip control unit 50. The lossless encoding unit 36 acquires information (hereinafter, referred to as “intra prediction mode information”) indicating an optimal intra prediction mode from the intra prediction unit 46. Further, the lossless encoding unit 36 acquires information (hereinafter, referred to as “inter prediction mode information”) indicating an optimal inter prediction mode, a motion vector, information specifying a reference image, and the like from the motion prediction/compensation unit 47.

Further, the lossless encoding unit 36 acquires offset filter information related to an offset filter from the adaptive offset filter 42, and acquires a filter coefficient from the adaptive loop filter 43.

The lossless encoding unit 36 performs lossless encoding such as variable length coding (for example, context-adaptive variable length coding (CAVLC)) or arithmetic coding (for example, context-adaptive binary arithmetic coding (CABAC)) on the quantized value supplied from the quantization unit 35.

Further, the lossless encoding unit 36 performs lossless encoding on either of the intra prediction mode information and the inter prediction mode information, the motion vector, the information specifying the reference image, the transform skip information, the offset filter information, and the filter coefficient as encoding information related to encoding. The lossless encoding unit 36 supplies the encoding information and the quantized value that have undergone the lossless encoding to be accumulated in the accumulation buffer 37 as encoded data.

The encoding information that has undergone the lossless encoding may be regarded as header information (for example, a slice header) of the quantized value that has undergone the lossless encoding. For example, the transform skip information is set to residual_coding.

The accumulation buffer 37 temporarily stores the encoded data supplied from the lossless encoding unit 36. The accumulation buffer 37 supplies the stored encoded data to the transmitting unit 13 as an encoded stream together with the parameter sets supplied from the setting unit 11 of FIG. 1.

The quantized value output from the quantization unit 35 is also input to the inverse quantization unit 38. The inverse quantization unit 38 holds the scaling list of each TU size included in the SPS or the PPS. The inverse quantization unit 38 decides the scaling list based on the transform skip information supplied from the skip control unit 51 and the held scaling list in units of TUs. The inverse quantization unit 38 performs inverse quantization on the quantized value using the scaling list in units of TUs. The inverse quantization unit 38 supplies the orthogonal transform process result obtained as a result of inverse quantization to the inverse orthogonal transform unit 39.

The inverse orthogonal transform unit 39 performs the inverse orthogonal transform process in the horizontal direction on the orthogonal transform process result supplied from the inverse quantization unit 38 based on the control signal supplied from the skip control unit 51 in units of TUs. Then, the inverse orthogonal transform unit 39 performs the inverse orthogonal transform process in the vertical direction on the orthogonal transform process result that has undergone the inverse orthogonal transform process in the horizontal direction based on the control signal in units of TUs. Examples of the inverse orthogonal transform scheme include an inverse DCT (IDCT) and inverse DST (IDST). The inverse orthogonal transform unit 39 supplies the residual information obtained as a result of the inverse orthogonal transform process in the vertical direction to the addition unit 40.

The addition unit 40 adds the residual information supplied from the inverse orthogonal transform unit 39 to the predicted image supplied from the predicted image selection unit 48, and decodes the addition result. The addition unit 40 supplies the decoded image to the deblocking filter 41 and the frame memory 44.

The deblocking filter 41 performs an adaptive deblocking filter process for removing block distortion on the decoded image supplied from the addition unit 40, and supplies an image obtained as a result to the adaptive offset filter 42.

The adaptive offset filter 42 performs an adaptive offset filter (sample adaptive offset (SAO)) process for mainly removing ringing on the image that has undergone the adaptive deblocking filter process by the deblocking filter 41.

Specifically, the adaptive offset filter 42 decides a type of an adaptive offset filter process for each largest coding unit (LCU) serving as a maximum coding unit, and obtains an offset used in the adaptive offset filter process. The adaptive offset filter 42 performs the decided type of the adaptive offset filter process on the image that has undergone the adaptive deblocking filter process using the obtained offset.

The adaptive offset filter 42 supplies the image that has undergone the adaptive offset filter process to the adaptive loop filter 43. Further, the adaptive offset filter 42 supplies the type of the performed adaptive offset filter process and the information indicating the offset to the lossless encoding unit 36 as the offset filter information.

For example, the adaptive loop filter 43 is configured with a two-dimensional Wiener Filter. The adaptive loop filter 43 performs an adaptive loop filter (ALF) process on the image that has undergone the adaptive offset filter process and has been supplied from the adaptive offset filter 42, for example, in units of LCUs.

Specifically, the adaptive loop filter 43 calculates a filter coefficient used in the adaptive loop filter process in units of LCUs such that a residue between an original image serving as an image output from the screen rearrangement buffer 32 and the image that has undergone the adaptive loop filter process is minimized. Then, the adaptive loop filter 43 performs the adaptive loop filter process on the image that has undergone the adaptive offset filter process using the calculated filter coefficient in units of LCUs.

The adaptive loop filter 43 supplies the image that has undergone the adaptive loop filter process to the frame memory 44. Further, the adaptive loop filter 43 supplies the filter coefficient used in the adaptive loop filter process to the lossless encoding unit 36.

Here, the adaptive loop filter process is assumed to be performed in units of LCUs, but a processing unit of the adaptive loop filter process is not limited to an LCU. Here, as the processing unit of the adaptive offset filter 42 is identical to the processing unit of the adaptive loop filter 43, processing can be efficiently performed.

The frame memory 44 accumulates the image supplied from the adaptive loop filter 43 and the image supplied from the addition unit 40. Adjacent images in a prediction unit (PU) among images that are accumulated in the frame memory 44 but have not undergone the filter process are supplied to the intra prediction unit 46 via the switch 45 as a neighboring image. On the other hand, the image that have undergone the filter process and accumulated in the frame memory 44 are output to the motion prediction/compensation unit 47 via the switch 45 as the reference image.

The intra prediction unit 46 performs intra prediction processes of all intra prediction modes serving as a candidate in units of PUs using the neighboring image read from the frame memory 44 via the switch 45.

Further, the intra prediction unit 46 calculates a cost function value (which will be described in detail later) for all the intra prediction modes serving as a candidate based on the image read from the screen rearrangement buffer 32 and the predicted image generated as a result of the intra prediction process. Then, the intra prediction unit 46 decides an intra prediction mode in which the cost function value is smallest as the optimal intra prediction mode.

The intraprediction unit 46 supplies the predicted image generated in the optimal intra prediction mode and the corresponding cost function value to the predicted image selection unit 48. When a notification indicating selection of the predicted image generated in the optimal intra prediction mode is given from the predicted image selection unit 48, the intra prediction unit 46 supplies the intra prediction mode information to the lossless encoding unit 36.

Further, the cost function value is also called a rate distortion (RD) cost and calculated based on a technique of either of a high complexity mode and a low complexity mode decided by a joint model (JM) that is reference software, for example, in the H.264/AVC scheme. Further, the reference software in the H.264/AVC scheme is found at http://iphome.hhi.de/suehring/tml/index.htm.

Specifically, when the high complexity mode is employed as the cost function value calculation technique, up to decoding is supposedly performed on all prediction modes serving as a candidate, and a cost function value expressed by the following Formula (1) is calculated on each of the prediction modes.

[Mathematical Formula 1]

Cost(Mode)=D+λ·R (1)

D indicates a difference (distortion) between an original image and a decoded image, R indicates a generated coding amount including up to orthogonal transform coefficients, and γ indicates a Lagrange undetermined multiplier given as a function of a quantization parameter QP.

Meanwhile, when the low complexity mode is employed as the cost function value calculation technique, generation of a predicted image and calculation of a coding amount of encoding information are performed on all prediction modes serving as a candidate, and a cost function expressed by the following Formula (2) is calculated on each of the prediction modes.

[Mathematical Formula 2]

Cost(Mode)=D+QPtoQuant(QP)·Header_Bit (2)

D indicates a difference (distortion) between an original image and a predicted image, Header_Bit indicates a coding amount of encoding information, and QPtoQuant indicates a function given as a function of the quantization parameter QP.

In the low complexity mode, since only the predicted image has only to be generated for all the prediction modes, and it is unnecessary to generate the decoded image, a computation amount is small.

The intra prediction mode is a mode indicating the size of the PU, the prediction direction, and the like.

The motion prediction/compensation unit 47 performs a motion prediction/compensation process for all the inter prediction modes serving as a candidate in units of PUs. Specifically, the motion prediction/compensation unit 47 detects motion vectors of all the inter prediction modes serving as a candidate based on the image supplied from the screen rearrangement buffer 32 and the reference image read from the frame memory 44 via the switch 45 in units of PUs. The motion prediction/compensation unit 47 performs a compensation process on the reference image based on the detected motion vector in units of PUs, and generates the predicted image.

At this time, the motion prediction/compensation unit 47 calculates the cost function values for all the inter prediction modes serving as a candidate based on the image supplied from the screen rearrangement buffer 32 and the predicted image, and decides the inter prediction mode in which the cost function value is smallest as the optimal inter prediction mode. Then, the motion prediction/compensation unit 47 supplies the cost function value of the optimal inter prediction mode and the corresponding predicted image to the predicted image selection unit 48. Further, when a notification indicating selection of the predicted image generated in the optimal inter prediction mode is given from the predicted image selection unit 48, the motion prediction/compensation unit 47 outputs the inter prediction mode information, the corresponding motion vector, the information specifying the reference image, and the like to the lossless encoding unit 36. The inter prediction mode is a mode indicating the size of the PU and the like.

The predicted image selection unit 48 decides one of the optimal intra prediction mode and the optimal inter prediction mode that is smaller in the corresponding cost function value as the optimal prediction mode based on the cost function values supplied from the intra prediction unit 46 and the motion prediction/compensation unit 47. Then, the predicted image selection unit 48 supplies the predicted image of the optimal prediction mode to the operation unit 33 and the addition unit 40. Further, the predicted image selection unit 48 notifies the intra prediction unit 46 or the motion prediction/compensation unit 47 of the selection of the predicted image of the optimal prediction mode.

The rate control unit 49 controls a rate of the quantization operation of the quantization unit 35 such that neither an overflow nor an underflow occurs based on the encoded data accumulated in the accumulation buffer 37.

The skip control unit 50 supplies a horizontal skip on signal for performing control such that the transform skip in the horizontal direction is performed and a vertical skip on signal for performing control such that the transform skip in the vertical direction is performed to the orthogonal transform unit 34 as the control signal when the TU is 4×4 pixels. Further, the skip control unit 50 supplies a horizontal skip off signal for performing control such that the transform skip in the horizontal direction is not performed and the vertical skip on signal to the orthogonal transform unit 34 as the control signal.

Further, the skip control unit 50 supplies the horizontal skip on signal and a vertical skip off signal for performing control such that the transform skip in the vertical direction is not performed to the orthogonal transform unit 34 as the control signal. Furthermore, the skip control unit 50 supplies the horizontal skip off signal and the vertical skip off signal to the orthogonal transform unit 34 as the control signal.

When the TU size is 4×4 pixels, the skip control unit 50 calculates the cost function values for four orthogonal transform process results supplied from the orthogonal transform unit 34 according to the control signals in units of TUs. The skip control unit 50 generates the transform skip information indicating the presence or absence of the transform skip in the horizontal direction and the vertical direction corresponding to the orthogonal transform process result in which the cost function value is minimum as the optimal transform skip in units of TUs. Further, the skip control unit 50 supplies the control signal corresponding to the optimal transform skip to the orthogonal transform unit 34 again.

When the TU size is not 4×4 pixels, the skip control unit 50 generates the transform skip information indicating the absence of the transform skip in the horizontal direction and the vertical direction as the optimal transform skip. Further, the skip control unit 50 supplies the horizontal skip off signal and the vertical skip off signal to the orthogonal transform unit 34 as the control signal corresponding to the optimal transform skip. The skip control unit 50 supplies the generated transform skip information to the quantization unit 35, the lossless encoding unit 36, and the skip control unit 51.

The skip control unit 51 supplies the transform skip information supplied from the skip control unit 50 to the inverse quantization unit 38. Further, the skip control unit 51 supplies the control signal corresponding to the optimal transform skip indicated by the transform skip information to the inverse orthogonal transform unit 39.

(Description of Coding Unit)

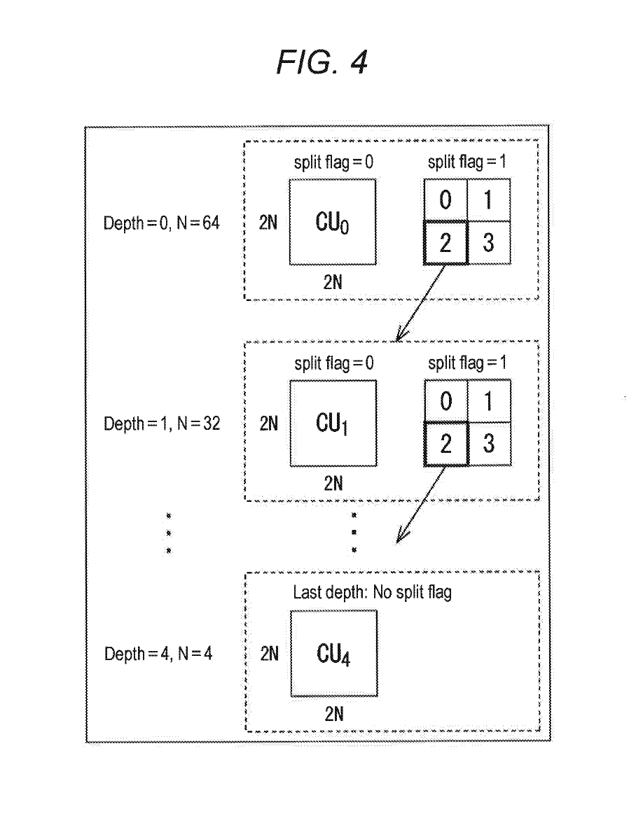

FIG. 4 is a diagram for describing a coding unit (CU) serving as an encoding unit in the HEVC scheme.

In the HEVC scheme, since an image of a large image frame such as ultra high definition (UHD) of 4000×2000 pixels is also a target, it is not optimal to fix a size of a coding unit to 16×16 pixels. Thus, in the HEVC scheme, a CU is defined as a coding unit.

The CU undertakes the same role of a macroblock in the AVC scheme. Specifically, the CU is divided into PUs or TUs.

However, the size of the CU is a square that varies for each sequence and is represented by pixels of a power of 2. Specifically, the CU is set such that the LCU serving as the maximum size of the CU is divided into two in the horizontal direction and the vertical direction an arbitrary number of times so that it is not smaller than a smallest coding unit (SCU) serving as the minimum size of the CU. In other words, when the LCU is hierarchized so that a size of an upper layer is one fourth (¼) of a size of a lower layer until the LCU becomes the SCU, a size of an arbitrary layer is the size of the CU.

For example, in FIG. 4, the size of the LCU is 128, and the size of the SCU is 8. Thus, a hierarchical depth of the LCU is 0 to 4, and a hierarchical depth number is 5. In other words, the number of divisions corresponding to the CU is any one of 0 to 4.

Further, information designating the sizes of the LCU and the SCU is included in the SPS. The number of divisions corresponding to the CU is designated by split_flag indicating whether or not division is further performed in each layer. The details of the CU are described in Non-Patent Document 1.

The TU size may be designated using split_transform_flag, similarly to split_flag of the CU. The maximum number of divisions of the TU at the time of the inter prediction and the maximum number of divisions of the TU at the time of the intra prediction are designated by the SPS as max_transform_hierarchy_depth_inter and max_transform_hierarchy_depth_intra, respectively.

In this specification, a coding tree unit (CTU) is assumed to be a unit including a coding tree block (CTB) of the LCU and a parameter used when processing is performed on the LCU base (level). Further, a CU configuring a CTU is assumed to be a unit including a coding block (CB) and a parameter used when processing is performed on the CU base (level).

(Exemplary Configuration of Orthogonal Transform Unit 34, Quantization Unit 35, and Skip Control Unit 50)

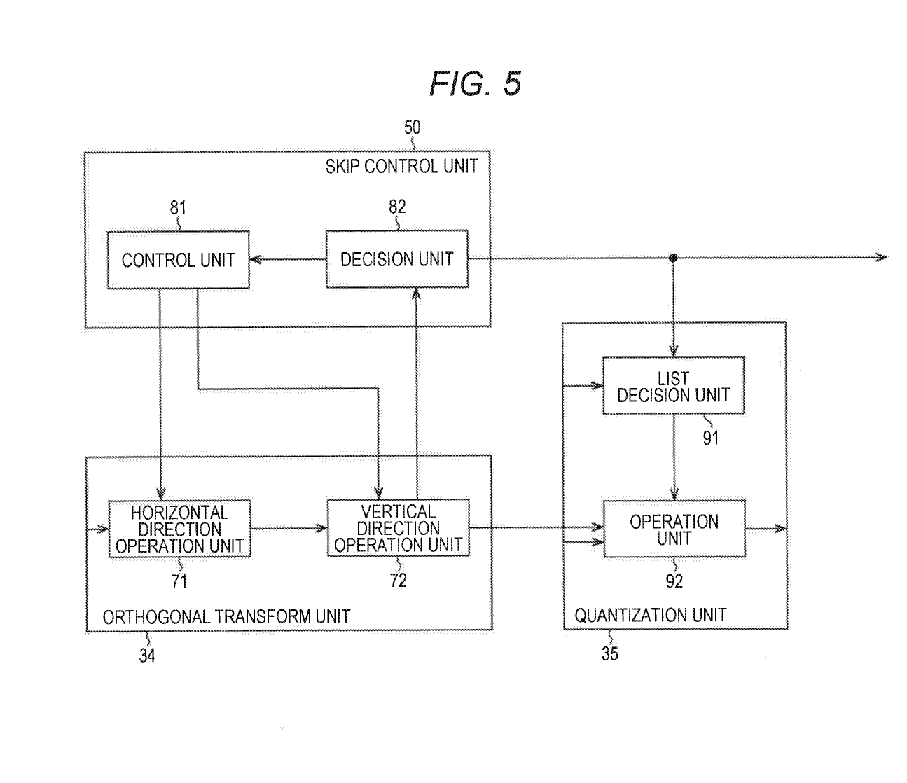

FIG. 5 is a block diagram illustrating an exemplary configuration of the orthogonal transform unit 34, the quantization unit 35, and the skip control unit 50 of FIG. 3.

The orthogonal transform unit 34 includes a horizontal direction operation unit 71 and a vertical direction operation unit 72 as illustrated in FIG. 5.

The horizontal direction operation unit 71 of the orthogonal transform unit 34 performs the orthogonal transform process in the horizontal direction on the residual information provided from the operation unit 33 of FIG. 3 based on the control signal supplied from the skip control unit 50 in units of TUs. Specifically, the horizontal direction operation unit 71 performs the orthogonal transform in the horizontal direction on the residual information based on the horizontal skip off signal in units of TUs. Then, the horizontal direction operation unit 71 supplies the orthogonal transform coefficient obtained as a result to the vertical direction operation unit 72 as the result of the orthogonal transform process in the horizontal direction.

Further, the horizontal direction operation unit 71 performs the transform skip in the horizontal direction on the residual information based on the horizontal skip on signal in units of TUs. Then, the horizontal direction operation unit 71 supplies the residual information provided from the operation unit 33 to the vertical direction operation unit 72 as the result of the orthogonal transform process in the horizontal direction.

The vertical direction operation unit 72 performs the orthogonal transform process in the vertical direction on the result of the orthogonal transform process in the horizontal direction supplied from the horizontal direction operation unit 71 based on the control signal supplied from the skip control unit 50 in units of TUs. Specifically, the vertical direction operation unit 72 performs the orthogonal transform in the vertical direction on the result of the orthogonal transform process in the horizontal direction based on the vertical skip off signal in units of TUs. Then, when the control signal supplied from the skip control unit 50 is not the control signal corresponding to the optimal transform skip that has been supplied again, the vertical direction operation unit 72 supplies the orthogonal transform coefficient obtained as the result of the orthogonal transform in the vertical direction to the skip control unit 50 as the final orthogonal transform process result.

Further, the vertical direction operation unit 72 performs the transform skip in the vertical direction on the result of the orthogonal transform process in the horizontal direction based on the vertical skip on signal in units of TUs. Then, when the control signal supplied from the skip control unit 50 is not the control signal corresponding to the optimal transform skip that has been supplied again, the vertical direction operation unit 72 supplies the result of the orthogonal transform process in the horizontal direction to the skip control unit 50 as the final orthogonal transform process result.

When the control signal supplied from the skip control unit 50 is the control signal corresponding to the optimal transform skip that has been supplied again, the vertical direction operation unit 72 supplies the final orthogonal transform process result to the quantization unit 35.

The skip control unit 50 includes a control unit 81 and a decision unit 82.

When the TU size is 4×4 pixels, the control unit 81 of the skip control unit 50 generates the horizontal skip off signal and the vertical skip off signal, the horizontal skip on signal and the vertical skip off signal, the horizontal skip off signal and the vertical skip on signal, and the horizontal skip off signal and the vertical skip off signal as the control signal in units of TUs in the described order. The control unit 81 supplies the control signals to the orthogonal transform unit 34 in units of TUs. Further, the control unit 81 supplies the control signal corresponding to the optimal transform skip supplied from the decision unit 82 to the horizontal direction operation unit 71 and the vertical direction operation unit 72 in units of TUs.

When the TU size is 4×4 pixels, the decision unit 82 calculates the cost function value for the four orthogonal transform process results supplied from the vertical direction operation unit 72 in units of TUs. The decision unit 82 decides the presence or absence of the transform skip in the horizontal direction and the vertical direction corresponding to the orthogonal transform process result in which the cost function value is minimum as the optimal transform skip in units of TUs. On the other hand, when the TU size is not 4×4 pixels, the decision unit 82 decides the absence of the transform skip in the horizontal direction and the vertical direction as the optimal transform skip in units of TUs.

The decision unit 82 supplies the optimal transform skip to the control unit 81 in units of TUs. Further, the decision unit 82 generates the transform skip information in units of TUs, and supplies the transform skip information to the quantization unit 35, the lossless encoding unit 36, and the skip control unit 51.

The quantization unit 35 includes a list decision unit 91 and an operation unit 92.

The list decision unit 91 holds the scaling list of each TU size included in the SPS or the PPS. The list decision unit 91 decides the scaling list based on the transform skip information supplied from the decision unit 82 and the held scaling list in units of TUs, and supplies the decided scaling list to the operation unit 92.

The operation unit 92 performs quantization on the orthogonal transform process result supplied from the vertical direction operation unit 72 using the scaling list supplied from the list decision unit 91 in units of TUs. The rate of the quantization operation is controlled by the rate control unit 49. The operation unit 92 supplies the quantized value obtained as a result of quantization to the lossless encoding unit 36 and the inverse quantization unit 38 of FIG. 3.

(Description of Scaling List Decision Method)

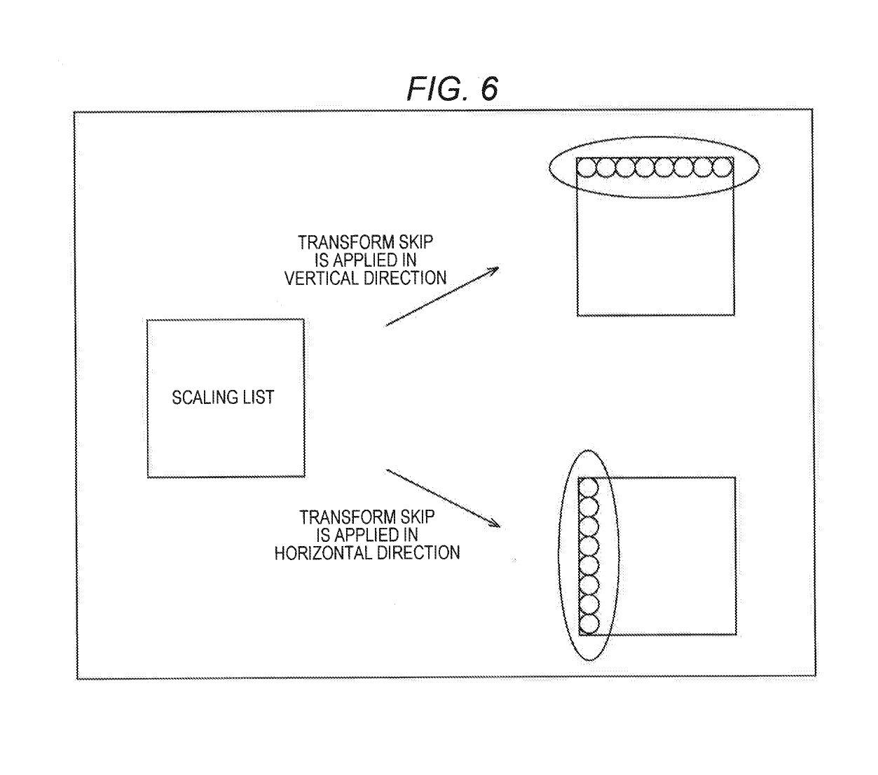

FIG. 6 is a diagram for describing a method of deciding the scaling list through the list decision unit 91 of FIG. 5.

As illustrated in FIG. 6, when the transform skip information indicates the absence of the transform skip in the horizontal direction and the presence of the transform skip in the vertical direction, the list decision unit 91 reads a value of a first row of the scaling list of a size of a current TU (8×8 pixels in FIG. 6). Then, the list decision unit 91 decides the scaling list in which the read value of the first row is used as values of all rows as the scaling list of the current TU. In other words, when only the transform skip in the vertical direction is performed on the current TU, the scaling list that changes in a row direction but does not change in a column direction is decided as the scaling list of the current TU.

On the other hand, when the transform skip information indicates the absence of the transform skip in the vertical direction and the presence of the transform skip in the horizontal direction as illustrated in FIG. 6, the list decision unit 91 reads a value of a first column of the scaling list of the size of the current TU (8×8 pixels in the example of FIG. 6). Then, the list decision unit 91 decides the scaling list in which the read value of the first column is used as values of all columns as the scaling list of the current TU. In other words, when only the transform skip in the horizontal direction is performed on the current TU, the scaling list that changes in the column direction but does not change in the row direction is decided as the scaling list of the current TU.

Further, when the transform skip information indicates the presence of the transform skip in the horizontal direction and the vertical direction, the list decision unit 91 decides the scaling list in which the DC component of the held scaling list is applied to all components as the scaling list of the current TU. In this case, the list decision unit 91 may decide a flat matrix as the scaling list of the current TU.

As described above, when the transform skip is performed in either of the horizontal direction and the vertical direction, the scaling list in the direction in which the transform skip is performed is not used. As a result, it is possible to prevent a weight coefficient in a frequency domain from being used when the orthogonal transform process result in the pixel domain in the direction in which the transform skip is performed is quantized. Accordingly, the encoding efficiency is improved.

(Exemplary Configuration of Inverse Quantization Unit 38, Inverse Orthogonal Transform Unit 39, and Skip Control Unit 51)

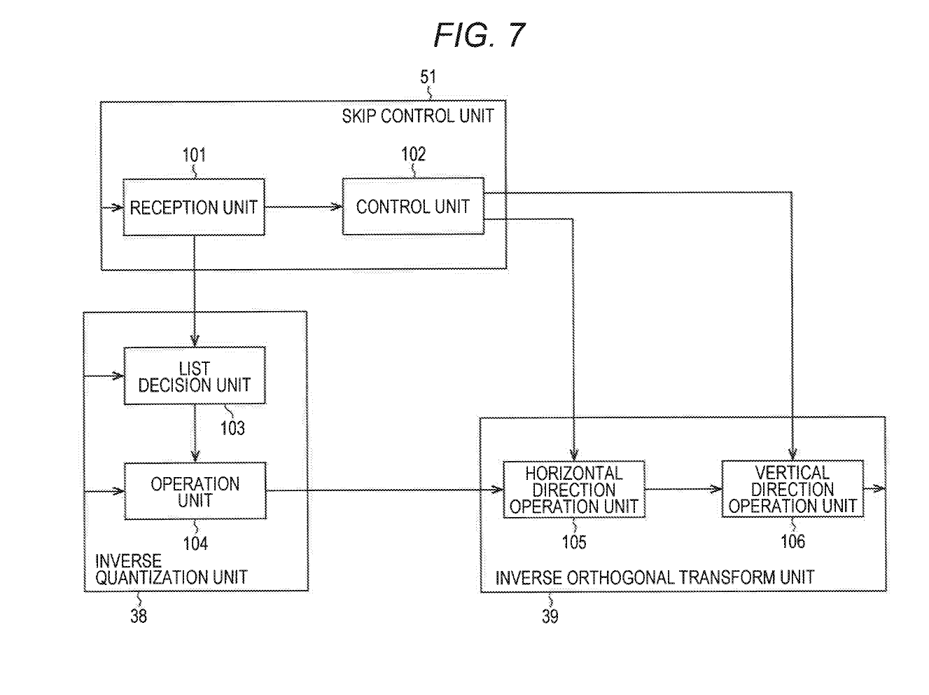

FIG. 7 is a block diagram illustrating an exemplary configuration of the inverse quantization unit 38, the inverse orthogonal transform unit 39, and the skip control unit 51 of FIG. 3.

The skip control unit 51 includes a reception unit 101 and a control unit 102 as illustrated in FIG. 7.

The reception unit 101 of the skip control unit 51 receives the transform skip information from the skip control unit 50 in units of TUs. The reception unit 101 supplies the transform skip information to the inverse quantization unit 38 and the control unit 102 in units of TUs.

The control unit 102 generates one of the horizontal skip on signal and the horizontal skip off signal and one of the vertical skip on signal and the vertical skip off signal as the control signal based on the transform skip information supplied from the reception unit 101 in units of TUs.

Specifically, when the transform skip information indicates the absence of the transform skip in the horizontal direction and the vertical direction, the control unit 102 generates the horizontal skip off signal and the vertical skip off signal as the control signal. Further, when the transform skip information indicates the presence of the transform skip in the horizontal direction and the absence of the transform skip in the vertical direction, the control unit 102 generates the horizontal skip on signal and the vertical skip off signal as the control signal.

On the other hand, when the transform skip information indicates the absence of the transform skip in the horizontal direction and the presence of the transform skip in the vertical direction, the control unit 102 generates the horizontal skip off signal and the vertical skip on signal as the control signal. Further, when the transform skip information indicates the presence of the transform skip in the horizontal direction and the vertical direction, the control unit 102 generates the horizontal skip on signal and the vertical skip on signal as the control signal. The control unit 102 supplies the generated control signal to the inverse orthogonal transform unit 39.

The inverse quantization unit 38 includes a list decision unit 103 and an operation unit 104.

The list decision unit 103 holds the scaling list of each TU size included in the SPS or the PPS. The list decision unit 103 decides the scaling list based on the transform skip information supplied from the reception unit 101 and the held scaling list in units of TUs, similarly to the list decision unit 91 of FIG. 5. The list decision unit 103 supplies the scaling list to the operation unit 104 in units of TUs.

The operation unit 104 performs inverse quantization on the quantized value supplied from the operation unit 92 of FIG. 5 using the scaling list supplied from the list decision unit 103 in units of TUs. The operation unit 104 supplies the orthogonal transform process result obtained as a result of inverse quantization to the inverse orthogonal transform unit 39.

The inverse orthogonal transform unit 39 includes a horizontal direction operation unit 105 and a vertical direction operation unit 106.

The horizontal direction operation unit 105 of the inverse orthogonal transform unit 39 performs the inverse orthogonal transform process in the horizontal direction on the orthogonal transform process result supplied from the operation unit 104 based on the control signal supplied from the control unit 102 in units of TUs.

Specifically, the horizontal direction operation unit 105 performs the inverse orthogonal transform in the horizontal direction on the orthogonal transform process result based on the horizontal skip off signal in units of TUs. Then, the horizontal direction operation unit 105 supplies the result obtained by performing the inverse orthogonal transform in the horizontal direction on the orthogonal transform process result to the vertical direction operation unit 106 as the result of the inverse orthogonal transform process in the horizontal direction.

Further, the horizontal direction operation unit 105 performs the transform skip in the horizontal direction on the orthogonal transform process result based on the horizontal skip on signal in units of TUs. Then, the horizontal direction operation unit 105 supplies the orthogonal transform process result to the vertical direction operation unit 106 as the result of the inverse orthogonal transform process in the horizontal direction.

The vertical direction operation unit 106 performs the inverse orthogonal transform process in the vertical direction on the result of the inverse orthogonal transform process in the horizontal direction supplied from the horizontal direction operation unit 105 based on the control signal supplied from the control unit 102 in units of TUs.

Specifically, the vertical direction operation unit 106 performs the inverse orthogonal transform in the vertical direction on the result of the inverse orthogonal transform process in the horizontal direction based on the vertical skip off signal in units of TUs. Then, the vertical direction operation unit 106 supplies the residual information obtained as the result of the inverse orthogonal transform in the vertical direction to the addition unit 40 of FIG. 3.

Further, the vertical direction operation unit 106 performs the transform skip in the vertical direction on the result of the inverse orthogonal transform process in the horizontal direction based on the vertical skip on signal in units of TUs. Then, the vertical direction operation unit 106 supplies the residual information serving as the result of the inverse orthogonal transform process in the horizontal direction to the addition unit 40.

(Example of Syntax of Residual_Coding)

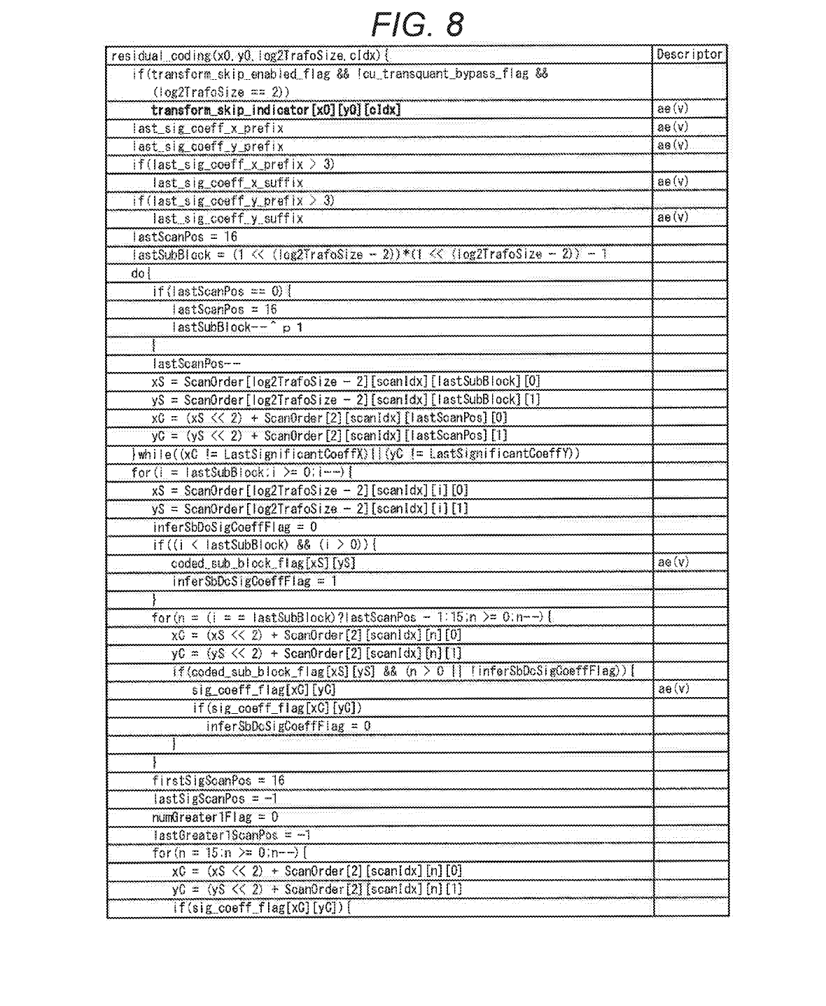

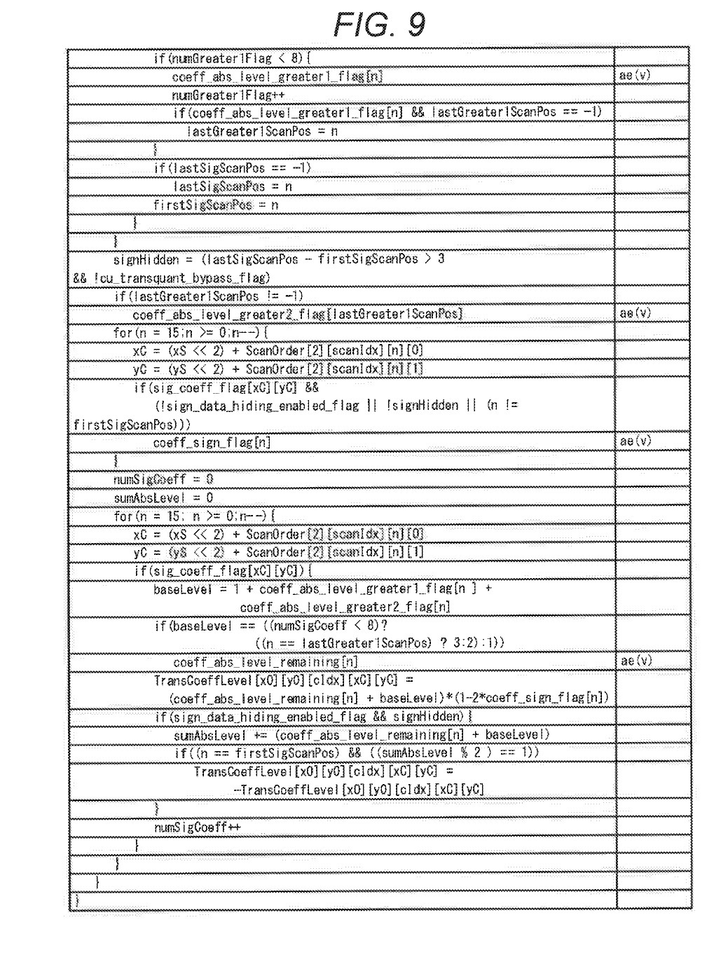

FIGS. 8 and 9 are diagrams illustrating an example of syntax of residual_coding.

For each TU, the transform skip information (transform_skip_indicator) of the TU is set to residual_coding as illustrated in FIG. 8. The transform skip information is information indicating the optimal transform skip, that is, information identifying which of the transform skip in the horizontal direction and the transform skip in the vertical direction has been performed on the residual information.

The transform skip information is 0 when it indicates the absence of the transform skip in the horizontal direction and the vertical direction and 1 when it indicates the presence of the transform skip in the horizontal direction and the absence of the transform skip in the vertical direction. Further, the transform skip information is 2 when it indicates the absence of the transform skip in the horizontal direction and the presence of the transform skip in the vertical direction and 3 when it indicates the presence of the transform skip in the horizontal direction and the vertical direction.

On the other hand, in HEVC in which it is difficult to set the presence or absence of the transform skip separately in the horizontal direction and the vertical direction, a transform skip flag (transform_skip_flag) identifying that the transform skip has been performed in both the horizontal direction and the vertical direction is set to residual_coding. The transform skip flag is 1 when it indicates that the transform skip has been performed and 0 when it indicates that the transform skip has not been performed.

(Description of Process of Encoding Device)

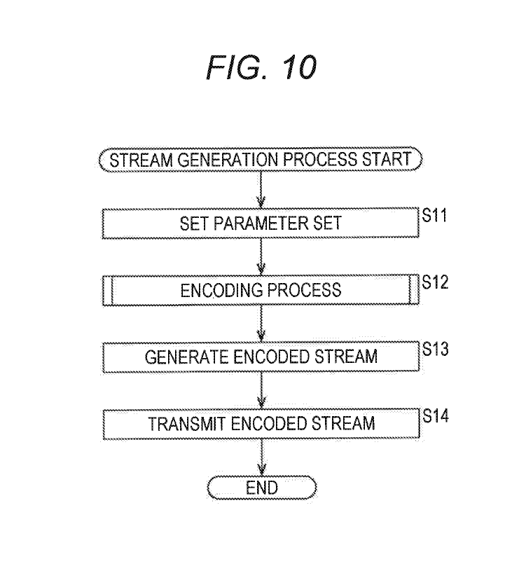

FIG. 10 is a flowchart for describing a stream generation process of the encoding device 10 of FIG. 1.

In step S11 of FIG. 10, the setting unit 11 of the encoding device 10 sets the parameter sets. The setting unit 11 supplies the set parameter sets to the encoding unit 12.

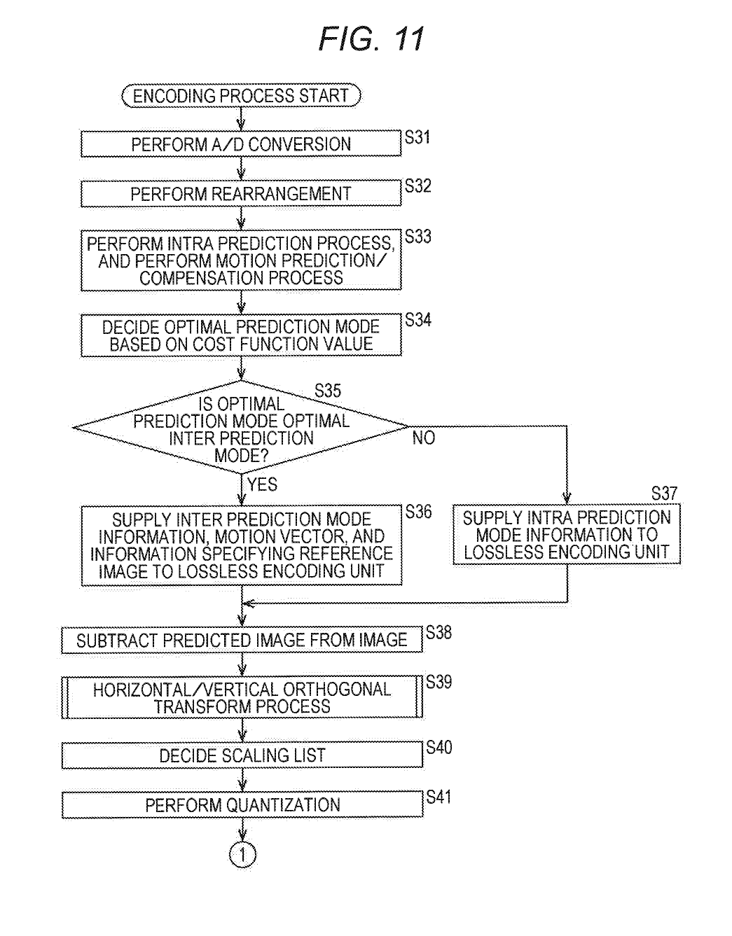

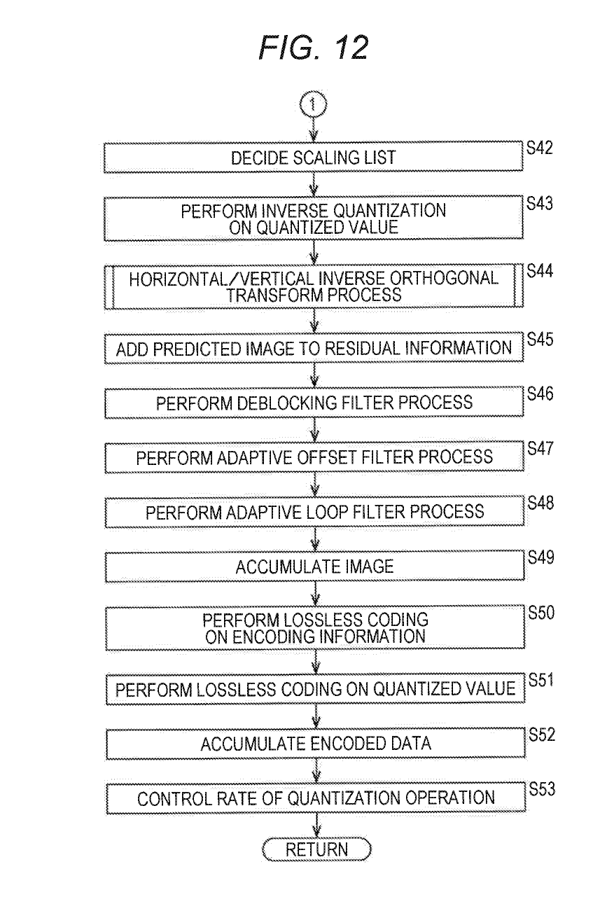

In step S12, the encoding unit 12 performs an encoding process for encoding an image of a frame unit input from the outside according to the scheme based on the HEVC scheme. The details of the encoding process will be described later with reference to FIGS. 11 and 12.

In step S13, the accumulation buffer 37 of the encoding unit 12 (FIG. 3) generates an encoded stream from the parameter sets supplied from the setting unit 11 and the encoded data accumulated therein, and supplies the encoded stream to the transmitting unit 13.

In step S14, the transmitting unit 13 transmits the encoded stream supplied from the setting unit 11 to the decoding device which will be described later, and ends the process.

FIGS. 11 and 12 are flowcharts for describing the details of the encoding process of step S12 of FIG. 10.

In step S31 of FIG. 11, the A/D converter 31 of the encoding unit 12 (FIG. 3) performs A/D conversion on an image of a frame unit input as an encoding target. The A/D converter 31 outputs the image serving as the converted digital signal to be stored in the screen rearrangement buffer 32.

In step S32, the screen rearrangement buffer 32 rearranges the stored image of the frame of a display order in an encoding order according to a GOP structure. The screen rearrangement buffer 32 supplies the rearranged image of the frame unit to the operation unit 33, the intra prediction unit 46, and the motion prediction/compensation unit 47.

In step S33, the intra prediction unit 46 performs intra prediction processes of all intra prediction modes serving as a candidate in units of PUs. Further, the intra prediction unit 46 calculates the cost function value for all the intra prediction modes serving as a candidate based on the image read from the screen rearrangement buffer 32 and the predicted image generated as a result of the intra prediction process. Then, the intra prediction unit 46 decides the intra prediction mode in which the cost function value is smallest as the optimal intra prediction mode. The intra prediction unit 46 supplies the predicted image generated in the optimal intra prediction mode and the corresponding cost function value to the predicted image selection unit 48.

The motion prediction/compensation unit 47 performs a motion prediction/compensation process for all the inter prediction modes serving as a candidate in units of PUs. The motion prediction/compensation unit 47 calculates the cost function values for all the inter prediction modes serving as a candidate based on the image supplied from the screen rearrangement buffer 32 and the predicted image, and decides the inter prediction mode in which the cost function value is smallest as the optimal inter prediction mode. Then, the motion prediction/compensation unit 47 supplies the cost function value of the optimal inter prediction mode and the corresponding predicted image to the predicted image selection unit 48.

In step S34, the predicted image selection unit 48 decides one of the optimal intra prediction mode and the optimal inter prediction mode that is smaller in the corresponding cost function value as the optimal prediction mode based on the cost function values supplied from the intra prediction unit 46 and the motion prediction/compensation unit 47 through the process of step S33. Then, the predicted image selection unit 48 supplies the predicted image of the optimal prediction mode to the operation unit 33 and the addition unit 40.

In step S35, the predicted image selection unit 48 determines whether or not the optimal prediction mode is the optimal inter prediction mode. When the optimal prediction mode is determined to be the optimal inter prediction mode in step S35, the predicted image selection unit 48 gives a notification indicating selection of the predicted image generated in the optimal inter prediction mode to the motion prediction/compensation unit 47.

Then, in step S36, the motion prediction/compensation unit 47 supplies the inter prediction mode information, the motion vector, and the information specifying the reference image to the lossless encoding unit 36, and the process proceeds to step S38.

On the other hand, when the optimal prediction mode is determined to be not the optimal inter prediction mode in step S35, that is, when the optimal prediction mode is the optimal intra prediction mode, the predicted image selection unit 48 gives a notification indicating selection of the predicted image generated in the optimal intra prediction mode to the intra prediction unit 46. Then, in step S37, the intra prediction unit 46 supplies the intra prediction mode information to the lossless encoding unit 36, and the process proceeds to step S38.

In step S38, the operation unit 33 performs encoding by subtracting the predicted image supplied from the predicted image selection unit 48 from the image supplied from the screen rearrangement buffer 32. The operation unit 33 outputs an image obtained as a result to the orthogonal transform unit 34 as the residual information.

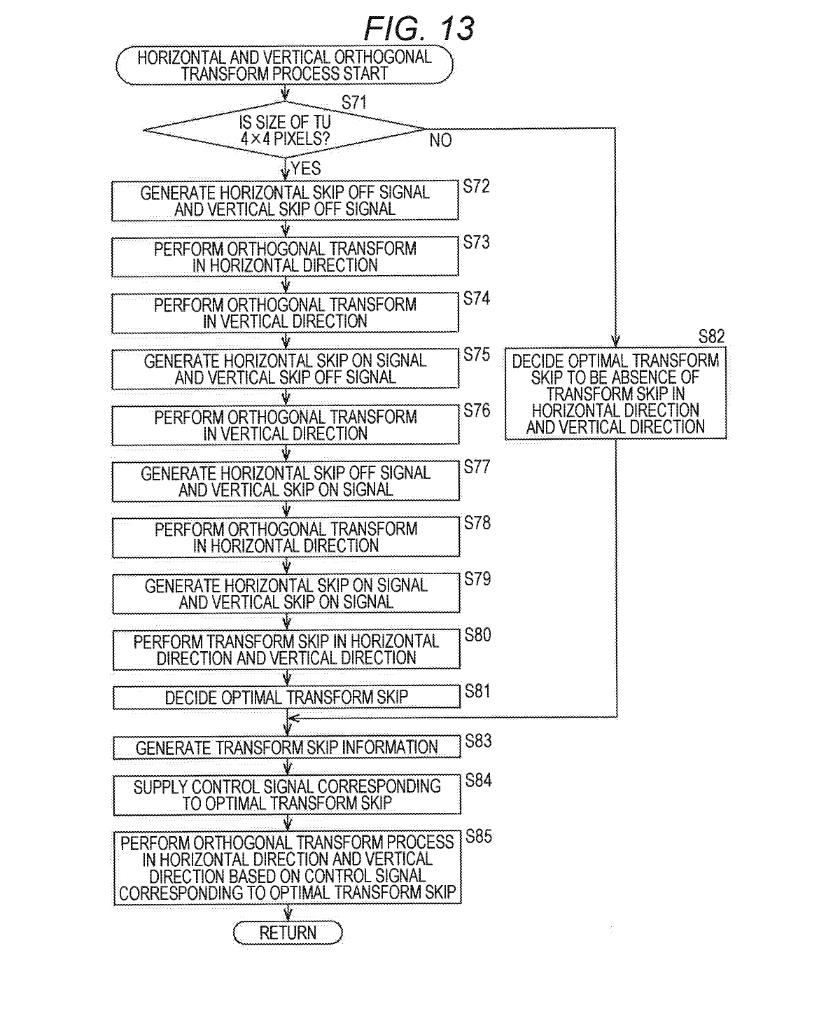

In step S39, the encoding unit 12 performs the horizontal/vertical orthogonal transform process in which the orthogonal transform process in the horizontal direction and the vertical direction is performed on the residual information in units of TUs. The horizontal/vertical orthogonal transform process will be described in detail with reference to FIG. 13 which will be described later.

In step S40, the list decision unit 91 of the quantization unit 35 (FIG. 5) decides the scaling list based on the transform skip information supplied from the skip control unit 50 and the held scaling list in units of TUs. The list decision unit 91 supplies the scaling list to the operation unit 92 in units of TUs.

In step S41, the operation unit 92 quantizes the orthogonal transform process result supplied from the orthogonal transform unit 34 using the scaling list supplied from the list decision unit 91 in units of TUs. The quantization unit 35 supplies the quantized value obtained as a result of quantization to the lossless encoding unit 36 and the inverse quantization unit 38.

In step S42 of FIG. 12, the list decision unit 103 of the inverse quantization unit 38 (FIG. 7) decides the scaling list based on the transform skip information supplied from the skip control unit 50 and the held scaling list in units of TUs. The list decision unit 103 supplies the scaling list to the operation unit 104 in units of TUs.

In step S43, the operation unit 104 performs inverse quantization on the quantized value supplied from the operation unit 92 using the scaling list supplied from the list decision unit 103 in units of TUs. The operation unit 104 supplies the orthogonal transform process result obtained as a result of inverse quantization to the inverse orthogonal transform unit 39.

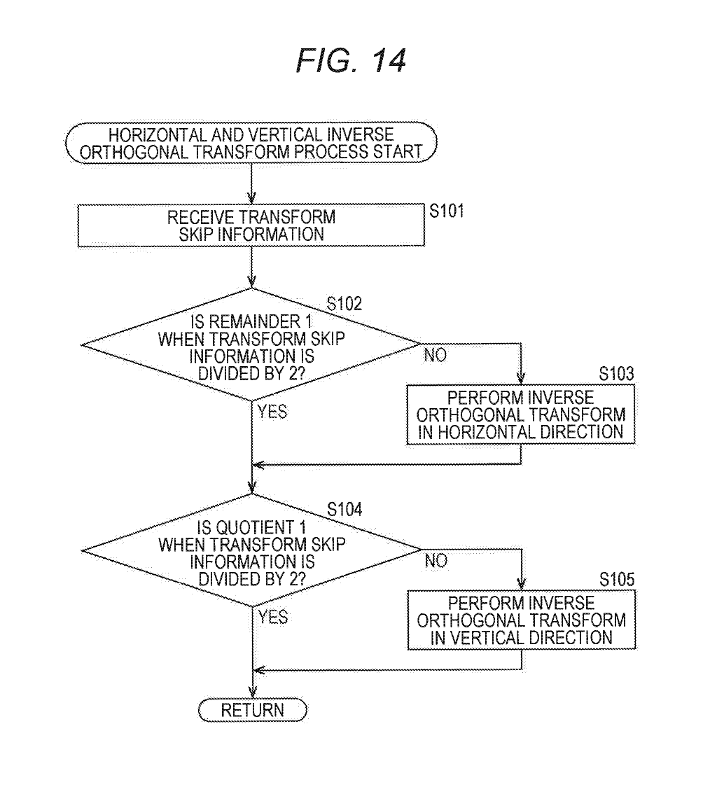

In step S44, the encoding unit 12 performs the horizontal/vertical inverse orthogonal transform process in which the inverse orthogonal transform process in the horizontal direction and the vertical direction are performed on the orthogonal transform process result based on the transform skip information in units of TUs. The horizontal/vertical inverse orthogonal transform process will be described in detail with reference to FIG. 14 which will be described later.

In step S45, the addition unit 40 adds the residual information supplied from the vertical direction operation unit 106 of the inverse orthogonal transform unit 39 (FIG. 7) to the predicted image supplied from the predicted image selection unit 48, and decodes the addition result. The addition unit 40 supplies the decoded image to the deblocking filter 41 and the frame memory 44.

In step S46, the deblocking filter 41 performs the deblocking filter process on the decoded image supplied from the addition unit 40. The deblocking filter 41 supplies an image obtained as a result to the adaptive offset filter 42.

In step S47, the adaptive offset filter 42 performs the adaptive offset filter process on the image supplied from the deblocking filter 41 for each LCU. The adaptive offset filter 42 supplies an image obtained as a result to the adaptive loop filter 43. Further, the adaptive offset filter 42 supplies the offset filter information to the lossless encoding unit 36 for each LCU.

In step S48, the adaptive loop filter 43 performs the adaptive loop filter process on the image supplied from the adaptive offset filter 42 for each LCU. The adaptive loop filter 43 supplies an image obtained as a result to the frame memory 44. Further, the adaptive loop filter 43 supplies the filter coefficient used in the adaptive loop filter process to the lossless encoding unit 36.

In step S49, the frame memory 44 accumulates the image supplied from the adaptive loop filter 43 and the image supplied from the addition unit 40. Adjacent images in a PU among images that are accumulated in the frame memory 44 but have not undergone the filter process are supplied to the intra prediction unit 46 via the switch 45 as a neighboring image. On the other hand, the images that have undergone the filter process and accumulated in the frame memory 44 are output to the motion prediction/compensation unit 47 via the switch 45 as the reference image.

In step S50, the lossless encoding unit 36 performs lossless encoding either of the intra prediction mode information and the inter prediction mode information, the motion vector, the information specifying the reference image, the transform skip information, the offset filter information, and the filter coefficient as the encoding information.

In step S51, the lossless encoding unit 36 performs lossless encoding on the quantized value supplied from the quantization unit 35. Then, the lossless encoding unit 36 generates the encoded data from the encoding information that has undergone the lossless encoding in the process of step S50 and the quantized value that has undergone the lossless encoding, and supplies the generated encoded data to the accumulation buffer 37.

In step S52, the accumulation buffer 37 temporarily accumulates the encoded data supplied from the lossless encoding unit 36.

In step S53, the rate control unit 49 controls a rate of the quantization operation of the quantization unit 35 such that neither an overflow nor an underflow occurs based on the encoded data accumulated in the accumulation buffer 37. Then, the process returns to step S12 of FIG. 10 and then proceeds to step S13.

In the encoding process of FIGS. 11 and 12, in order to simplify description, the intra prediction process and the motion prediction/compensation process are constantly performed, but practically, only one of the intra prediction process and the motion prediction/compensation process may be performed according to a picture type or the like.

FIG. 13 is a flowchart for describing the horizontal/vertical orthogonal transform process of step S39 of FIG. 11. The horizontal/vertical orthogonal transform process is performed in units of TUs.

In step S71 of FIG. 13, the control unit 81 of the skip control unit 50 (FIG. 5) determines whether or not the TU size is 4×4 pixels. When the TU size is determined to be 4×4 pixels in step S71, the process proceeds to step S72.

In step S72, the control unit 81 generates the horizontal skip off signal and the vertical skip off signal, and supplies the horizontal skip off signal and the vertical skip off signal to the horizontal direction operation unit 71 and the vertical direction operation unit 72 as the control signal.

In step S73, the horizontal direction operation unit 71 of the orthogonal transform unit 34 performs the orthogonal transform in the horizontal direction on the residual information supplied from the operation unit 33 based on the horizontal skip off signal supplied from the control unit 81. Then, the horizontal direction operation unit 71 supplies the orthogonal transform coefficient obtained as a result to the vertical direction operation unit 72 as the result of the orthogonal transform process in the horizontal direction.

In step S74, the vertical direction operation unit 72 performs the orthogonal transform in the vertical direction on the result of the orthogonal transform process in the horizontal direction supplied from the horizontal direction operation unit 71 based on the vertical skip off signal supplied from the control unit 81. Then, the vertical direction operation unit 72 supplies the orthogonal transform coefficient obtained as a result to the decision unit 82 as the final orthogonal transform process result.

In step S75, the control unit 81 generates the horizontal skip on signal and the vertical skip off signal, and supplies the horizontal skip on signal and the vertical skip off signal to the horizontal direction operation unit 71 and the vertical direction operation unit 72 as the control signal. Thus, the horizontal direction operation unit 71 performs the transform skip based on the horizontal skip on signal, and supplies the residual information supplied from the operation unit 33 to the vertical direction operation unit 72 as the result of the orthogonal transform process in the horizontal direction.

In step S76, the vertical direction operation unit 72 performs the orthogonal transform in the vertical direction on the result of the orthogonal transform process in the horizontal direction supplied from the horizontal direction operation unit 71 based on the vertical skip off signal supplied from the control unit 81. Then, the vertical direction operation unit 72 supplies the orthogonal transform coefficient obtained as a result to the decision unit 82 as the final orthogonal transform process result.

In step S77, the control unit 81 generates the horizontal skip off signal and the vertical skip on signal, and supplies the horizontal skip off signal and the vertical skip on signal to the horizontal direction operation unit 71 and the vertical direction operation unit 72 as the control signal.

In step S78, the horizontal direction operation unit 71 performs the orthogonal transform in the horizontal direction on the residual information supplied from the operation unit 33 based on the horizontal skip off signal supplied from the control unit 81. Then, the horizontal direction operation unit 71 supplies the orthogonal transform coefficient obtained as a result to the vertical direction operation unit 72 as the result of the orthogonal transform process in the horizontal direction. The vertical direction operation unit 72 performs the transform skip based on the vertical skip on signal supplied from the control unit 81, and supplies the result of the orthogonal transform process in the horizontal direction supplied from the horizontal direction operation unit 71 to the decision unit 82 as the final orthogonal transform process result.

In step S79, the control unit 81 generates the horizontal skip on signal and the vertical skip on signal, and supplies the horizontal skip on signal and the vertical skip on signal to the horizontal direction operation unit 71 and the vertical direction operation unit 72 as the control signal.

In step S80, the horizontal direction operation unit 71 and the vertical direction operation unit 72 perform the transform skip in the horizontal direction and the transform skip in the vertical direction based on the control signal supplied from the control unit 81. As a result, the residual information supplied from the operation unit 33 is supplied to the decision unit 82 as the final orthogonal transform process result.

In step S81, the decision unit 82 decides the optimal transform skip by calculating the cost function value for the four orthogonal transform process results supplied from the vertical direction operation unit 72 through the process of steps S74, S76, S78, and S80. The decision unit 82 supplies the optimal transform skip to the control unit 81, and the process proceeds to step S83.

On the other hand, when the TU size is determined to be not 4×4 pixels in step S71, the process proceeds to step S82. In step S82, the decision unit 82 decides the optimal transform skip to be the absence of the transform skip in the horizontal direction and the vertical direction. The decision unit 82 supplies the optimal transform skip to the control unit 81, and the process proceeds to step S83.

In step S83, the decision unit 82 generates the transform skip information indicating the optimal transform skip decided in step S81 or step S82. The decision unit 82 supplies the transform skip information to the quantization unit 35, the lossless encoding unit 36, and the skip control unit 51.

In step S84, the control unit 81 supplies the control signal corresponding to the optimal transform skip supplied from the decision unit 82 to the horizontal direction operation unit 71 and the vertical direction operation unit 72.

In step S85, the horizontal direction operation unit 71 and the vertical direction operation unit 72 perform the orthogonal transform process in the horizontal direction and the vertical direction based on the control signal supplied from the control unit 81 corresponding to the optimal transform skip. The vertical direction operation unit 72 supplies the final orthogonal transform process result obtained as a result to the quantization unit 35. Then, the process returns to step S39 of FIG. 11 and then proceeds to step S40.

In the above description, when the TU size is 4×4 pixels, the optimal transform skip is decided, and then the orthogonal transform process in the horizontal direction and the vertical direction corresponding to the optimal transform skip is performed, but it may not be performed. In this case, the vertical direction operation unit 72 temporarily holds the final orthogonal transform process result, decides the optimal transform skip, and then outputs the final orthogonal transform process result corresponding to the held optimal transform skip.

FIG. 14 is a flowchart for describing the horizontal/vertical inverse orthogonal transform process of step S44 of FIG. 12. The horizontal/vertical inverse orthogonal transform process is performed in units of TUs.

In step S101 of FIG. 14, the reception unit 101 of the skip control unit 51 (FIG. 7) receives the transform skip information supplied from the decision unit 82 of FIG. 5.

In step S102, the control unit 102 determines whether or not a remainder is 1 when the transform skip information is divided by 2.

When the remainder is determined to be 1 when the transform skip information is divided by 2 in step S102, that is, when the transform skip information is 1 or 3, the control unit 102 generates the horizontal skip on signal. Then, the control unit 102 supplies the horizontal skip on signal to the inverse orthogonal transform unit 39 as the control signal.

Thus, the horizontal direction operation unit 105 of the inverse orthogonal transform unit 39 performs the transform skip in the horizontal direction on the orthogonal transform process result supplied from the operation unit 104. Then, the horizontal direction operation unit 105 supplies the orthogonal transform process result supplied from the operation unit 104 to the vertical direction operation unit 106 as the orthogonal transform process result that has undergone the inverse orthogonal transform process in the horizontal direction, and the process proceeds to step S104.

On the other hand, when the remainder is determined to be not 1 when the transform skip information is divided by 2 in step S102, that is, when the transform skip information is 0 or 2, the control unit 102 generates the horizontal skip off signal. Then, the control unit 102 supplies the horizontal skip off signal to the inverse orthogonal transform unit 39 as the control signal.

Then, in step S103, the horizontal direction operation unit 105 performs the inverse orthogonal transform in the horizontal direction on the orthogonal transform process result supplied from the operation unit 104 based on the horizontal skip off signal. Then, the horizontal direction operation unit 105 supplies the orthogonal transform process result that has undergone the inverse orthogonal transform in the horizontal direction to the vertical direction operation unit 106 as the orthogonal transform process result that has undergone the inverse orthogonal transform process in the horizontal direction, and the process proceeds to step S104.

In step S104, the control unit 102 determines whether or not a quotient is 1 when the transform skip information supplied from the decision unit 82 is divided by 2.

When the quotient is determined to be 1 when the transform skip information supplied from the decision unit 82 is divided by 2 in step S104, that is, when the transform skip information is 2 or 3, the control unit 102 generates the vertical skip on signal. Then, the control unit 102 supplies the vertical skip on signal to the inverse orthogonal transform unit 39 as the control signal.

Thus, the vertical direction operation unit 106 the transform skip in the vertical direction on the orthogonal transform process result that has undergone the inverse orthogonal transform process in the horizontal direction and supplied from the horizontal direction operation unit 105. Then, the vertical direction operation unit 106 supplies the residual information serving as the orthogonal transform process result that has undergone the inverse orthogonal transform process in the horizontal direction to the addition unit 40 of FIG. 3. Then, the process returns to step S44 of FIG. 12 and then proceeds to step S45.

On the other hand, when the quotient is determined to be not 1 when the transform skip information supplied from the decision unit 82 is divided by 2 in step S104, that is, when the transform skip information is 0 or 1, the control unit 102 generates the vertical skip off signal. Then, the control unit 102 supplies the vertical skip off signal to the inverse orthogonal transform unit 39 as the control signal.

Then, in step S105, the vertical direction operation unit 106 performs the inverse orthogonal transform in the vertical direction on the orthogonal transform process result that has undergone the inverse orthogonal transform process in the horizontal direction and supplied from the horizontal direction operation unit 105 based on the vertical skip off signal. Then, the vertical direction operation unit 106 supplies the residual information obtained as a result to the addition unit 40. Then, the process returns to step S44 of FIG. 12 and then proceeds to step S45.

As described above, the encoding device 10 can perform the transform skip in one of the horizontal direction and the vertical direction and thus optimize the transform skip. As a result, the encoding efficiency can be improved.

(Exemplary Configuration of Decoding Device According to First Embodiment)

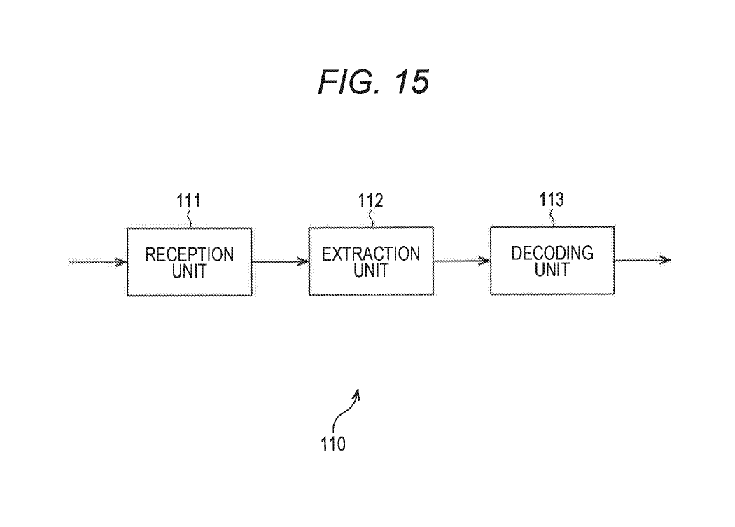

FIG. 15 is a block diagram illustrating an exemplary configuration of a decoding device that decodes the encoded stream transmitted from the encoding device 10 of FIG. 1 according to the first embodiment of the present disclosure.

A decoding device 110 of FIG. 15 includes a reception unit 111, an extraction unit 112, and a decoding unit 113.

The reception unit 111 of the decoding device 110 receives the encoded stream transmitted from the encoding device 10 of FIG. 1, and supplies the encoded stream to the extraction unit 112.

The extraction unit 112 extracts the parameter sets and the encoded data from the encoded stream supplied from the reception unit 111, and supplies the parameter sets and the encoded data to the decoding unit 113.

The decoding unit 113 decodes the encoded data supplied from the extraction unit 112 according to the scheme based on the HEVC scheme. At this time, the decoding unit 113 also refers to the parameter sets supplied from the extraction unit 112 as necessary. The decoding unit 113 outputs an image obtained as a result of decoding.

(Exemplary Configuration of Decoding Unit)

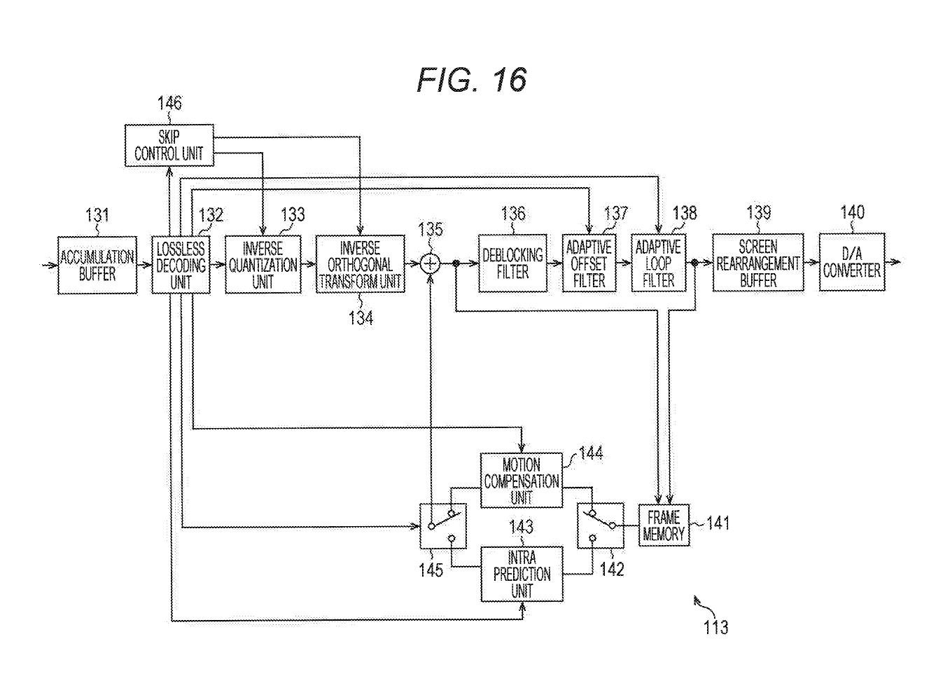

FIG. 16 is a block diagram illustrating an exemplary configuration of the decoding unit 113 of FIG. 15.

The decoding unit 113 of FIG. 16 includes an accumulation buffer 131, a lossless decoding unit 132, an inverse quantization unit 133, an inverse orthogonal transform unit 134, an addition unit 135, a deblocking filter 136, an adaptive offset filter 137, an adaptive loop filter 138, and a screen rearrangement buffer 139. The decoding unit 113 further includes a D/A converter 140, a frame memory 141, a switch 142, an intra prediction unit 143, a motion compensation unit 144, a switch 145, and a skip control unit 146.

The accumulation buffer 131 of the decoding unit 113 receives the encoded data from the extraction unit 112 of FIG. 15 and accumulates the encoded data. The accumulation buffer 131 supplies the accumulated encoded data to the lossless decoding unit 132.

The lossless decoding unit 132 obtains the quantized value and the encoding information by performing lossless decoding such as variable length decoding or arithmetic decoding on the encoded data supplied from the accumulation buffer 131. The lossless decoding unit 132 supplies the quantized value to the inverse quantization unit 133. Further, the lossless decoding unit 132 supplies the intra prediction mode information serving as the encoding information and the like to the intra prediction unit 143. The lossless decoding unit 132 supplies the motion vector, the inter prediction mode information, the information specifying the reference image, and the like to the motion compensation unit 144.

Further, the lossless decoding unit 132 supplies either of the intra prediction mode information and the inter prediction mode information serving as the encoding information to the switch 145. The lossless decoding unit 132 supplies the offset filter information serving as the encoding information to the adaptive offset filter 137. The lossless decoding unit 132 supplies the filter coefficient serving as the encoding information to the adaptive loop filter 138.

Further, the lossless decoding unit 132 supplies the transform skip information serving as the encoding information to the skip control unit 146.

An image is decoded such that the inverse quantization unit 133, the inverse orthogonal transform unit 134, the addition unit 135, the deblocking filter 136, the adaptive offset filter 137, the adaptive loop filter 138, the frame memory 141, the switch 142, the intra prediction unit 143, the motion compensation unit 144, and the skip control unit 146 perform the same process as the inverse quantization unit 38, the inverse orthogonal transform unit 39, the addition unit 40, the deblocking filter 41, the adaptive offset filter 42, the adaptive loop filter 43, the frame memory 44, the switch 45, the intra prediction unit 46, the motion prediction/compensation unit 47, and the skip control unit 51 of FIG. 3.

Specifically, the inverse quantization unit 133 has a similar configuration to the inverse quantization unit 38 of FIG. 7. The inverse quantization unit 133 holds the scaling list of each TU size included in the SPS or the PPS supplied from the extraction unit 112 of FIG. 15. The inverse quantization unit 133 decides the scaling list based on the transform skip information supplied from the skip control unit 146 and the held scaling list in units of TUs. The inverse quantization unit 133 performs inverse quantization on the quantized value supplied from the lossless decoding unit 132 using the scaling list in units of TUs. The inverse quantization unit 133 supplies the orthogonal transform process result obtained as a result to the inverse orthogonal transform unit 134.

The inverse orthogonal transform unit 134 has a similar configuration to the inverse orthogonal transform unit 39 of FIG. 7. The inverse orthogonal transform unit 134 performs the inverse orthogonal transform process in the horizontal direction on the orthogonal transform process result supplied from the inverse quantization unit 133 based on the control signal supplied from the skip control unit 146 in units of TUs. Then, the inverse orthogonal transform unit 134 performs the inverse orthogonal transform process in the vertical direction on the orthogonal transform process result that has undergone the inverse orthogonal transform process in the horizontal direction based on the control signal in units of TUs. The inverse orthogonal transform unit 134 supplies the residual information obtained as a result of the inverse orthogonal transform process in the vertical direction to the addition unit 135.

The addition unit 135 performs the decoding by adding the residual information supplied from the inverse orthogonal transform unit 134 to the predicted image supplied from the switch 145. The addition unit 135 supplies the decoded image to the deblocking filter 136 and the frame memory 141.

The deblocking filter 136 performs the adaptive deblocking filter process on the image supplied from the addition unit 135, and supplies an image obtained as a result to the adaptive offset filter 137.

The adaptive offset filter 137 performs the adaptive offset filter process of the type indicated by the offset filter information on the image that has undergone the adaptive deblocking filter process using the offset indicated by the offset filter information supplied from the lossless decoding unit 132 for each LCU. The adaptive offset filter 137 supplies the image that has undergone the adaptive offset filter process to the adaptive loop filter 138.

The adaptive loop filter 138 performs the adaptive loop filter process on the image supplied from the adaptive offset filter 137 using the filter coefficient supplied from the lossless decoding unit 132 for each LCU. The adaptive loop filter 138 supplies an image obtained as a result to the frame memory 141 and the screen rearrangement buffer 139.

The screen rearrangement buffer 139 stores the image supplied from the adaptive loop filter 138 in units of frames. The screen rearrangement buffer 139 rearranges the stored image of the frame unit arranged in the encoding order in the original display order, and supplies the resulting image to the D/A converter 140.

The D/A converter 140 performs D/A conversion on the image of the frame unit supplied from the screen rearrangement buffer 139, and outputs the resulting image.

The frame memory 141 accumulates the image supplied from the adaptive loop filter 138 and the image supplied from the addition unit 135. Adjacent images in a PU among images that are accumulated in the frame memory 141 but have not undergone the filter process are supplied to the intra prediction unit 143 via the switch 142 as a neighboring image. On the other hand, the image that have undergone the filter process and accumulated in the frame memory 141 are supplied to the motion compensation unit 144 via the switch 142 as the reference image.

The intra prediction unit 143 performs the intra prediction process of the optimal intra prediction mode indicated by the intra prediction mode information supplied from the lossless decoding unit 132 using the neighboring image read from the frame memory 141 via the switch 142. The intra prediction unit 143 supplies the predicted image generated as a result to the switch 145.

The motion compensation unit 144 reads the reference image specified by the information specifying the reference image supplied from the lossless decoding unit 132 from the frame memory 141 via the switch 142. The motion compensation unit 144 performs the motion compensation process of the optimal inter prediction mode indicated by the inter prediction mode information supplied from the lossless decoding unit 132 using the motion vector supplied from the lossless decoding unit 132 and the reference image. The motion compensation unit 144 supplies the predicted image generated as a result to the switch 145.

When the intra prediction mode information is supplied from the lossless decoding unit 132, the switch 145 supplies the predicted image supplied from the intra prediction unit 143 to the addition unit 135. On the other hand, when the inter prediction mode information is supplied from the lossless decoding unit 132, the switch 145 supplies the predicted image supplied from the motion compensation unit 144 to the addition unit 135.

The skip control unit 146 has a similar configuration to the skip control unit 51 of FIG. 7. The skip control unit 146 receives the transform skip information supplied from the lossless decoding unit 132, and supplies the transform skip information to the inverse quantization unit 133. Further, the skip control unit 146 supplies the control signal corresponding to the optimal transform skip indicated by the transform skip information to the inverse orthogonal transform unit 134.

(Description of Process of Decoding Device)

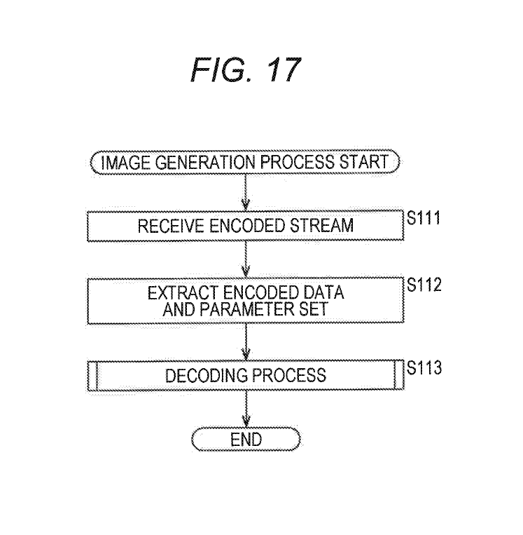

FIG. 17 is a flowchart for describing an image generation process of the decoding device 110 of FIG. 15.

In step S111 of FIG. 17, the reception unit 111 of the decoding device 110 receives the encoded stream transmitted from the encoding device 10 of FIG. 1, and supplies the encoded stream to the extraction unit 112.

In step S112, the extraction unit 112 extracts the encoded data and the parameter sets from the encoded stream supplied from the reception unit 111, and supplies the encoded data and the parameter sets to the decoding unit 113.

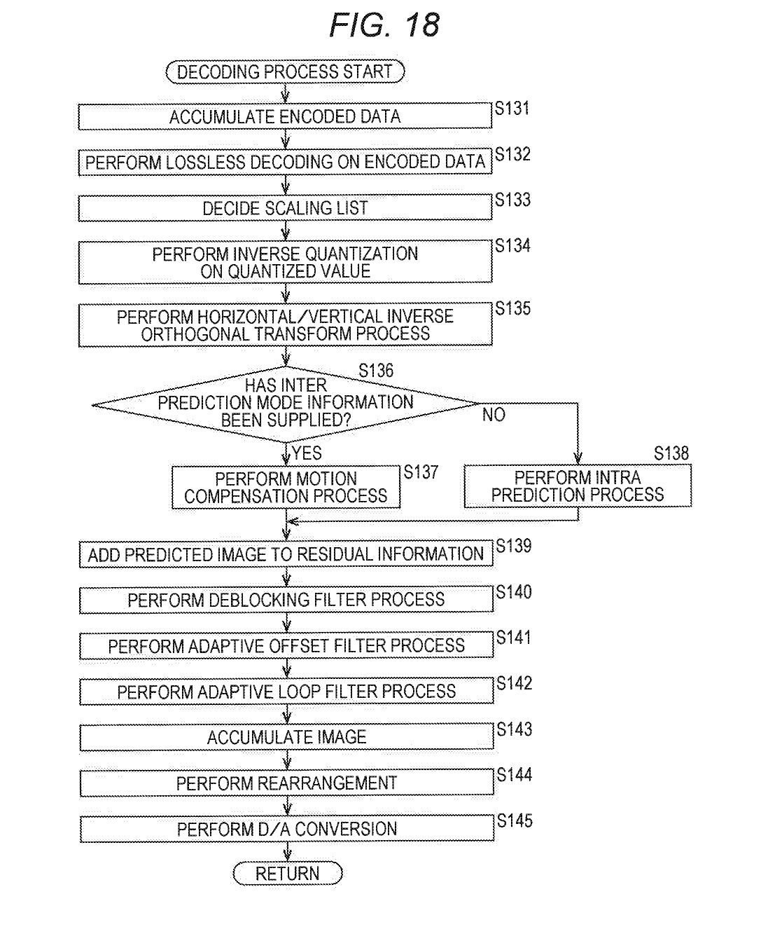

In step S113, the decoding unit 113 performs the decoding process for decoding the encoded data supplied from the extraction unit 112 according to the scheme based on the HEVC scheme using the parameter sets supplied from the extraction unit 112 as necessary. The decoding process will be described in detail with reference to FIG. 18 which will be described later. Then, the process ends.

FIG. 18 is a flowchart for describing the details of the decoding process of step S113 of FIG. 17.

In step S131 of FIG. 18, the accumulation buffer 131 of the decoding unit 113 (FIG. 16) receives the encoded data of the frame unit from the extraction unit 112 of FIG. 15, and accumulates the encoded data of the frame unit. The accumulation buffer 131 supplies the accumulated encoded data to the lossless decoding unit 132.

In step S132, the lossless decoding unit 132 obtains the quantized value and the encoding information by performing the lossless decoding on the encoded data supplied from the accumulation buffer 131. The lossless decoding unit 132 supplies the quantized value to the inverse quantization unit 133. The lossless decoding unit 132 supplies the transform skip information serving as the encoding information to the skip control unit 146. The skip control unit 146 supplies the transform skip information to the inverse quantization unit 133.

Further, the lossless decoding unit 132 supplies the intra prediction mode information serving as the encoding information and the like to the intra prediction unit 143. The lossless decoding unit 132 supplies the motion vector, the inter prediction mode information, the information specifying the reference image, and the like to the motion compensation unit 144.

Further, the lossless decoding unit 132 supplies either of the intra prediction mode information and the inter prediction mode information serving as the encoding information to the switch 145. The lossless decoding unit 132 supplies the offset filter information serving as the encoding information to the adaptive offset filter 137, and supplies the filter coefficient to the adaptive loop filter 138.

In step S133, the inverse quantization unit 133 decides the scaling list based on the transform skip information supplied from the skip control unit 146 and the held scaling list in units of TUs.

In step S134, the inverse quantization unit 133 performs inverse quantization on the quantized value supplied from the lossless decoding unit 132 using the scaling list in units of TUs. The operation unit 104 supplies the orthogonal transform process result obtained as a result of inverse quantization to the inverse orthogonal transform unit 134.

In step S135, the decoding unit 113 performs the same horizontal/vertical inverse orthogonal transform process as in FIG. 14 on the orthogonal transform process result based on the transform skip information.

In step S136, the motion compensation unit 144 determines whether or not the inter prediction mode information has been supplied from the lossless decoding unit 132. When the inter prediction mode information is determined to have been supplied in step S136, the process proceeds to step S137.

In step S137, the motion compensation unit 144 reads the reference image based on reference image specifying information supplied from the lossless decoding unit 132, and performs the motion compensation process of the optimal inter prediction mode indicated by the inter prediction mode information using the motion vector and the reference image. The motion compensation unit 144 supplies the predicted image generated as a result to the addition unit 135 via the switch 145, and the process proceeds to step S139.

On the other hand, when the inter prediction mode information is determined to have not been supplied in step S136, that is, when the intra prediction mode information has been supplied to the intra prediction unit 143, the process proceeds to step S138.

In step S138, the intra prediction unit 143 performs the intra prediction process of the intra prediction mode indicated by the intra prediction mode information using the neighboring image read from the frame memory 141 via the switch 142. The intra prediction unit 143 supplies the predicted image generated as a result of the intra prediction process to the addition unit 135 via the switch 145, and the process proceeds to step S139.

In step S139, the addition unit 135 performs the decoding by adding the residual information supplied from the inverse orthogonal transform unit 134 to the predicted image supplied from the switch 145. The addition unit 135 supplies the decoded image to the deblocking filter 136 and the frame memory 141.

In step S140, the deblocking filter 136 removes the block distortion by performing the deblocking filter process on the image supplied from the addition unit 135. The deblocking filter 136 supplies an image obtained as a result to the adaptive offset filter 137.

In step S141, the adaptive offset filter 137 performs the adaptive offset filter process on the image that has undergone the deblocking filter process by the deblocking filter 136 based on the offset filter information supplied from the lossless decoding unit 132 for each LCU. The adaptive offset filter 137 supplies the image that has undergone the adaptive offset filter process to the adaptive loop filter 138.

In step S142, the adaptive loop filter 138 performs the adaptive loop filter process on the image supplied from the adaptive offset filter 137 using the filter coefficient supplied from the lossless decoding unit 132 for each LCU. The adaptive loop filter 138 supplies an image obtained as a result to the frame memory 141 and the screen rearrangement buffer 139.

In step S143, the frame memory 141 accumulates the image supplied from the addition unit 135 and the image supplied from the adaptive loop filter 138. Adjacent images in a PU among images that are accumulated in the frame memory 141 but have not undergone the filter process are supplied to the intra prediction unit 143 via the switch 142 as the neighboring image. On the other hand, the images that are accumulated in the frame memory 141 and have undergone the filter process are supplied to the motion compensation unit 144 via the switch 142 as the reference image.

In step S144, the screen rearrangement buffer 139 stores the image supplied from the adaptive loop filter 138 in units of frames, rearranges the stored image of the frame unit arranged in the encoding order in the original display order, and then supplies the resulting image to the D/A converter 140.

In step S145, the D/A converter 140 performs the D/A conversion on the image of the frame unit supplied from the screen rearrangement buffer 139, and outputs the resulting image. Then, the process returns to step S113 of FIG. 17 and ends.

As described above, the decoding device 110 can perform the transform skip in one of the horizontal direction and the vertical direction. As a result, it is possible to decode the encoded stream in which the encoding efficiency in the encoding device 10 has been improved.

The transform skip direction candidate may be the prediction direction of the intra prediction or one according to the shape of the PU of the inter prediction other than both, one, and the other of the horizontal direction and the vertical direction.

In this case, the control unit 81 of FIG. 5 generates the control signal for deciding the optimal transform skip when the TU size is 4×4 pixels based on the prediction direction of the intra prediction or the shape of the PU of the inter prediction.

Specifically, when the optimal prediction mode of the PU corresponding to the current TU is the intra prediction mode, the control unit 81 generates the control signal based on the prediction direction indicated by the intra prediction mode.

For example, when the prediction direction is close to the vertical direction, the control unit 81 generates the horizontal skip on signal and the vertical skip off signal or the horizontal skip off signal and the vertical skip off signal as the control signal. Further, when the prediction direction is close to the horizontal direction, the control unit 81 generates the horizontal skip off signal and the vertical skip on signal or the horizontal skip off signal and the vertical skip off signal as the control signal. Furthermore, when the prediction direction is not close to the vertical direction or the horizontal direction, the control unit 81 generates the horizontal skip on signal and the vertical skip on signal or the horizontal skip off signal and the vertical skip off signal as the control signal.

Further, when the optimal prediction mode of the PU corresponding to the current TU is the inter prediction mode, the control unit 81 generates the control signal based on the shape of the PU of the size indicated by the inter prediction mode.

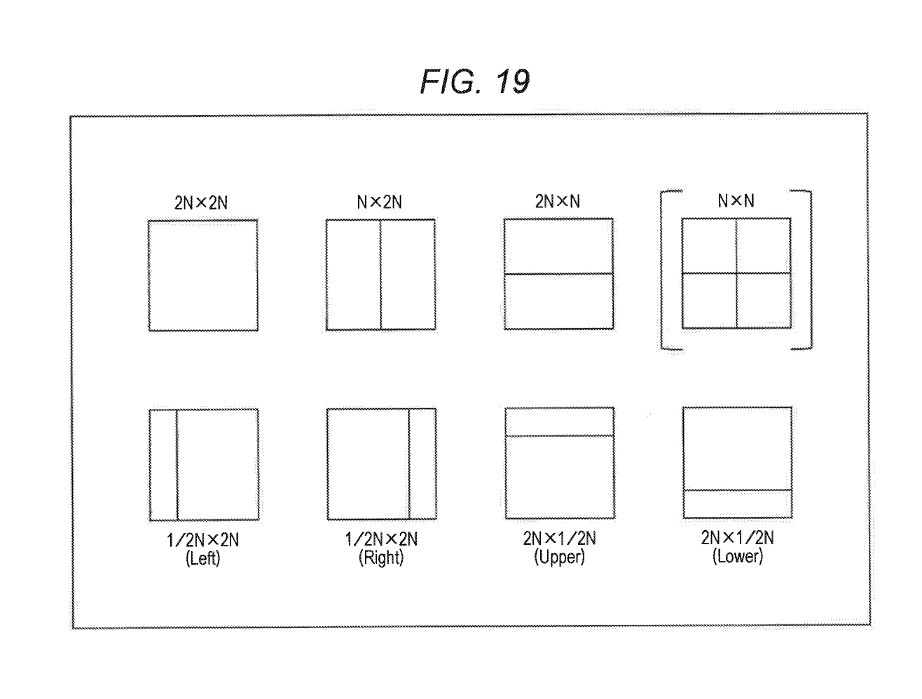

Here, a PU (hereinafter, referred to as an “inter PU”) of the inter prediction is formed as illustrated in FIG. 19. In other words, the inter PU is formed by symmetrically dividing the CU as illustrated in the upper portion of FIG. 19 or by asymmetrically dividing the CU as illustrated in the lower portion of FIG. 19.

Specifically, if the CU is 2N×2N pixels, the inter PU can be 2N×2N pixels serving as the CU, N×2N pixels obtained by dividing the CU into two to be bilaterally symmetric, or 2N×N pixels obtained by dividing the CU into two to be vertically symmetric. However, the inter PU hardly has N×N pixels obtained by dividing the CU into two to be symmetric bilaterally and vertically. Thus, for example, when 8×8 pixels is used as the inter PU, the CU need be 8×8 pixels rather than 16×16 pixels.

Further, the inter PU can be ½N×2N pixels (Left) obtained by dividing the CU into two so that they are asymmetric bilaterally, and the left side is smaller or ½N×2N pixels (Right) obtained by dividing the CU into two so that they are asymmetric bilaterally, and the right side is smaller. Furthermore, the inter PU can be 2N×½N pixels (Upper) obtained by dividing the CU into two so that they are asymmetric vertically, and the upper side is smaller or 2N×½N pixels (Lower) obtained by dividing the CU into two so that they are asymmetric vertically, and the lower side is smaller.

In the HEVC scheme, the minimum size of the CU is 8×8 pixels, and the minimum size of the inter PU is 4×8 pixels or 8×4 pixels.

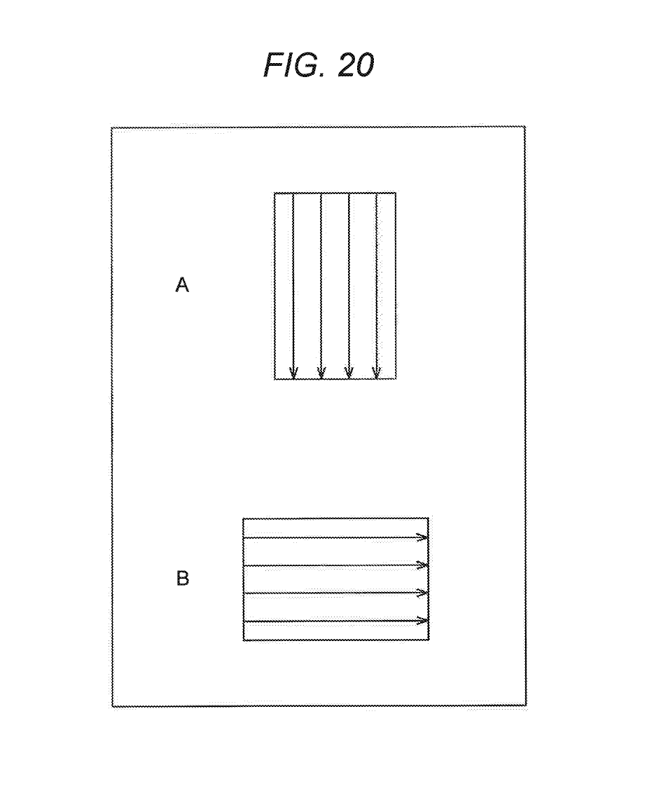

The shape of the inter PU that is N×2N pixels, ½N×2N pixels (Left), or ½N×2N pixels (Right) formed as described above is a vertically long rectangular shape as illustrated in A of FIG. 20. When the optimal prediction mode indicates one of the sizes of the inter PU, a correlation between pixels arranged in the vertical direction in the image to be currently encoded is high. Thus, when the shape of the inter PU of the size indicated by the optimal prediction mode is the vertically long rectangular shape, the control unit 81 generates the horizontal skip on signal and the vertical skip off signal so that the transform skip in the horizontal direction is performed.

On the other hand, the shape of the inter PU that is 2N×N pixels, 2N×½N pixels (Upper), or 2N×½N pixels (Lower) is a horizontally long rectangular shape as illustrated in B of FIG. 20. When the optimal prediction mode indicates one of the sizes of the inter PU, a correlation between pixels arranged in the horizontal direction in the image to be currently encoded is high. Thus, when the shape of the inter PU of the size indicated by the optimal prediction mode is the horizontally long rectangular shape, the control unit 81 generates the horizontal skip off signal and the vertical skip on signal so that the transform skip in the vertical direction is performed.

Further, when the size of the inter PU indicated by the optimal prediction mode is 2N×2N pixels, and the shape of the inter PU is a square shape, the control unit 81 generates the horizontal skip on signal and the vertical skip on signal so that the transform skip in the horizontal direction and the transform skip in the vertical direction are performed.

As described above, when the transform skip direction candidate is the prediction direction of the intra prediction or one according to the shape of the inter PU, the encoding device 10 sets the transform skip flag to residual_coding, and transmits residual_coding rather than the transform skip information. When the transform skip flag indicates the presence of the transform skip, the decoding device 110 performs the transform skip in the prediction direction of the intra prediction or the direction according to the shape of the inter PU.

In the first embodiment, when the TU size is 4×4 pixels, it is possible to perform the transform skip, but the TU size in which the transform skip is possible is not limited to 4×4 pixels. For example, the transform skip may be made possible for the TU of the minimum size as described in Non-Patent Document 4, or the transform skip may be made possible for the TUs of all sizes as described in Non-Patent Document 3. Further, the transform skip may be possible for a TU of a predetermined size or less.

Further, in the first embodiment, when the TU size is 4×4 pixels, the transform skip is made possible, but when the TU size is 4×4 pixels, and the skip permission information is 1, the transform skip may be made possible.

### Second Embodiment

### Exemplary Configuration of Encoding Unit of Encoding Device According to Second Embodiment

An encoding device according to a second embodiment of the present disclosure has a similar configuration to the configuration of the encoding device 10 of FIG. 1 except the encoding unit 12. Thus, the following description will proceed focusing on the encoding unit.

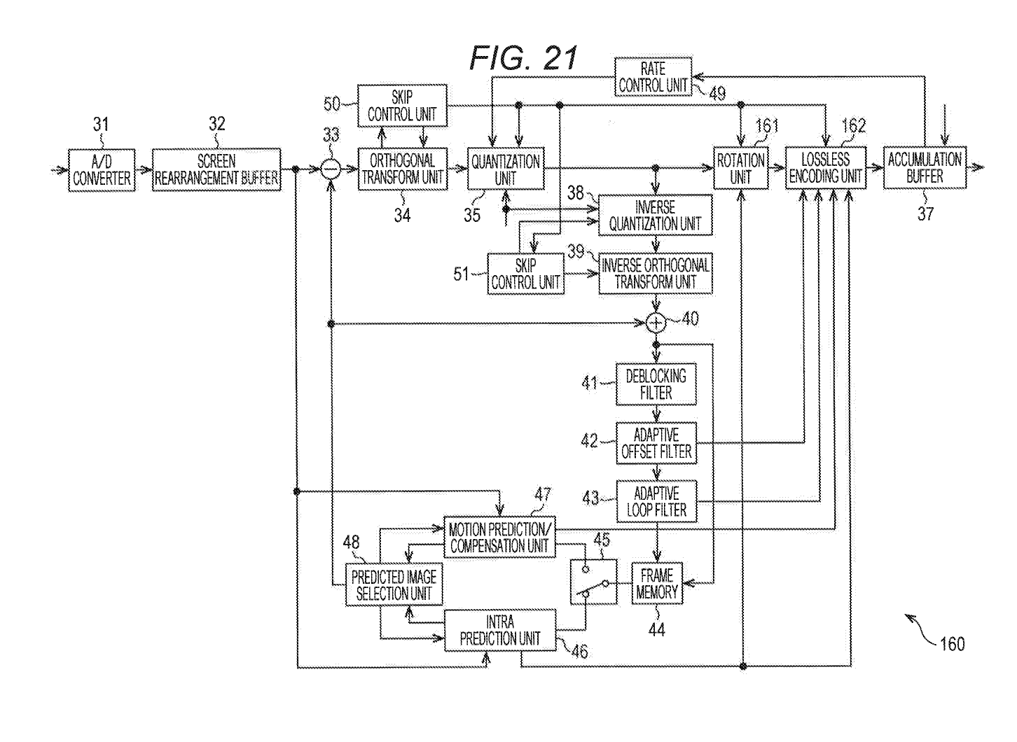

FIG. 21 is a block diagram illustrating an exemplary configuration of an encoding unit of an encoding device according to the second embodiment of the present disclosure.

In the configuration illustrated in FIG. 21, the same components as in FIG. 3 are denoted by the same reference numerals. A duplicated description will appropriately be omitted.

A configuration of an encoding unit 160 of FIG. 21 differs from the configuration of the encoding unit 12 of FIG. 3 in that a rotation unit 161 is newly provided, and a lossless encoding unit 162 is provided instead of the lossless encoding unit 36. The encoding unit 160 rotates the quantized value based on the transform skip information at the time of the intra prediction.

Specifically, the transform skip information output from the skip control unit 50 is input to the rotation unit 161 of the encoding unit 160. Further, the intra prediction mode information output from the intra prediction unit 46 is input to the rotation unit 161. The rotation unit 161 performs a rotation process for rotating a two-dimensional quantized value output from the quantization unit 35 based on the transform skip information and the intra prediction mode information in units of TUs.

In other words, when the optimal prediction mode is the intra prediction mode, for a pixel within the PU at a position close to a neighboring image, the residual information decreases since the correlation between the pixel and a pixel of the neighboring image is high. However, as the distance between the pixel within the PU and the neighboring image is increased, the correlation between the pixel and the pixel of the neighboring image decreases, and the residual information increases. Thus, when the transform skip is performed, and the residual information is quantized, the quantized value converted from the two-dimensional value to the one-dimensional value through the scan process becomes zero at the low-order side and becomes non-zero at the high-order side. As a result, the encoding efficiency is lowered.

Thus, the rotation unit 161 rotates the quantized value in the direction in which the transform skip is performed based on the transform skip information so that the quantized value becomes non-zero at the low-order side and becomes zero at the high-order side. The rotation in both the horizontal direction and the vertical direction when the transform skip in both the horizontal direction and the vertical direction is performed is described in Dake He, Jinb Wang, Gaelle Martin-Cocher, “Rotation of Residual Block for Transform Skipping,” JCTVC-J0093, 2012.7.11-20. The rotation unit 161 supplies the quantized value that has undergone the rotation process to the lossless encoding unit 162.

The lossless encoding unit 162 performs the lossless encoding on the encoding information, similarly to the lossless encoding unit 36 of FIG. 3. Further, the lossless encoding unit 162 performs the lossless encoding on the quantized value that has undergone the rotation process and supplied from the rotation unit 161. At this time, the lossless encoding unit 162 performs the scan process for converting the two-dimensional quantized value that has undergone the rotation process into the one-dimensional quantized value, and performs the lossless encoding on the one-dimensional quantized value. The scan process is performed even when the lossless encoding is performed on the quantized value in the lossless encoding unit 36 of FIG. 3. The lossless encoding unit 162 supplies the encoding information and the quantized value that have undergone the lossless encoding to be accumulated in the accumulation buffer 37 as the encoded data.

(Description of Rotation Process)

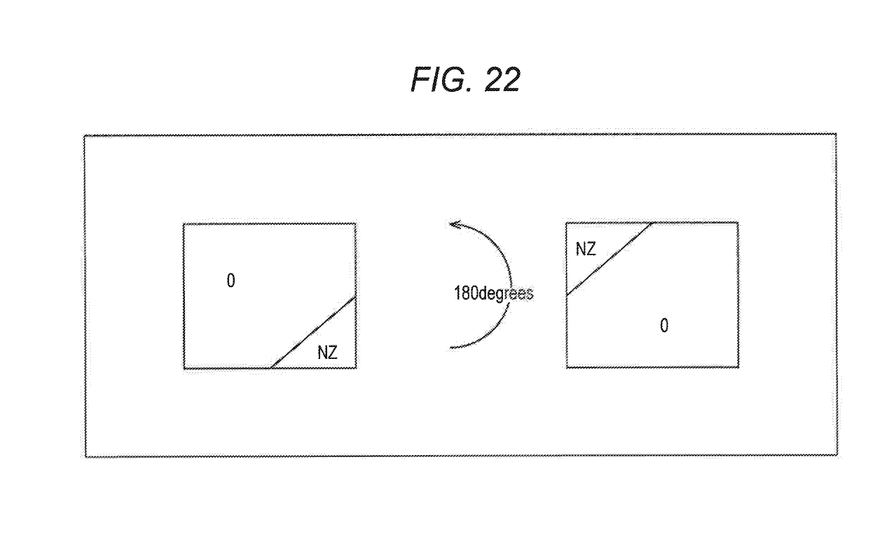

FIG. 22 is a diagram for describing the rotation process performed by the rotation unit 161.

As illustrated at the left of FIG. 22, when the optimal prediction mode is the intra prediction mode, and the transform skip in both the horizontal direction and the vertical direction is performed, a quantized value of an upper left pixel is zero, and a quantized value of a lower right pixel is non-zero (NZ). In other words, the one-dimensional quantized value is zero at the low-order side and is non-zero at the high-order side. Thus, in this case, the rotation unit 161 causes the high-order side of the one-dimensional quantized value and the low-order side to be zero and non-zero by rotating the two-dimensional quantized value 90° in the horizontal direction and 90° in the vertical direction.

Although not illustrated, when the transform skip is performed only in the horizontal direction, a quantized value of a lower left pixel is zero, and a quantized value of an upper right pixel is non-zero. Thus, in this case, the rotation unit 161 causes the high-order side of the one-dimensional quantized value and the low-order side to be zero and non-zero by rotating the two-dimensional quantized value 90° in the horizontal direction.

On the other hand, when the transform skip is performed only in the vertical direction, a quantized value of an upper right pixel is zero, and a quantized value of a lower left pixel is non-zero. Thus, in this case, the rotation unit 161 causes the high-order side of the one-dimensional quantized value and the low-order side to be zero and non-zero by rotating the two-dimensional quantized value 90° in the horizontal direction.

(Description of Encoding Process)

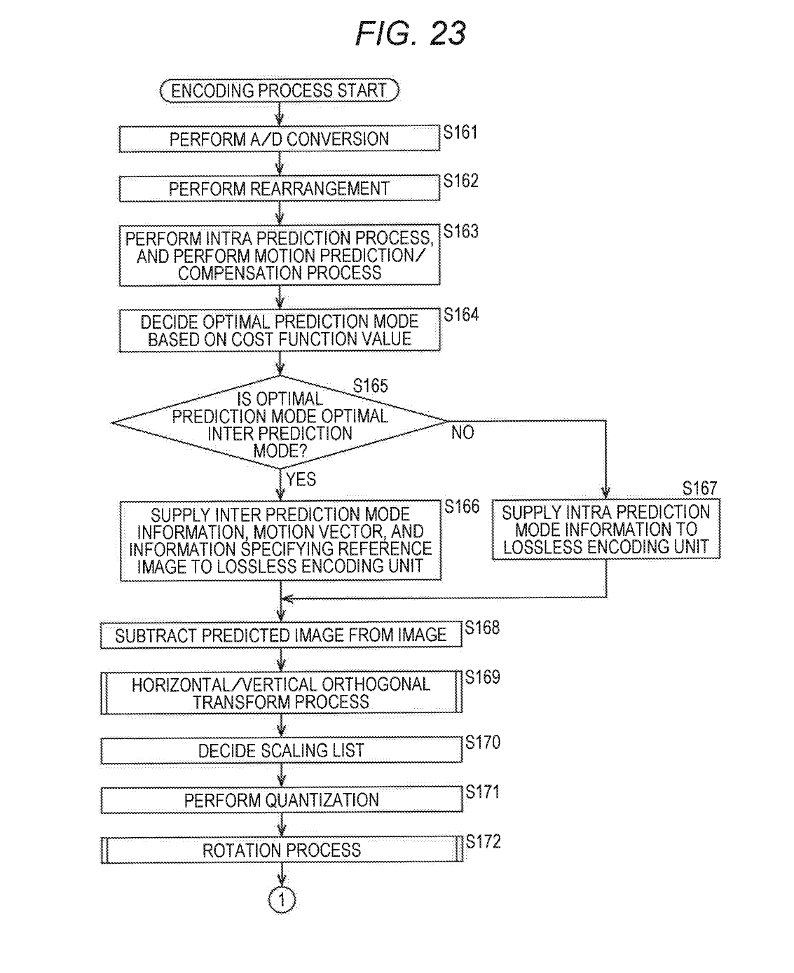

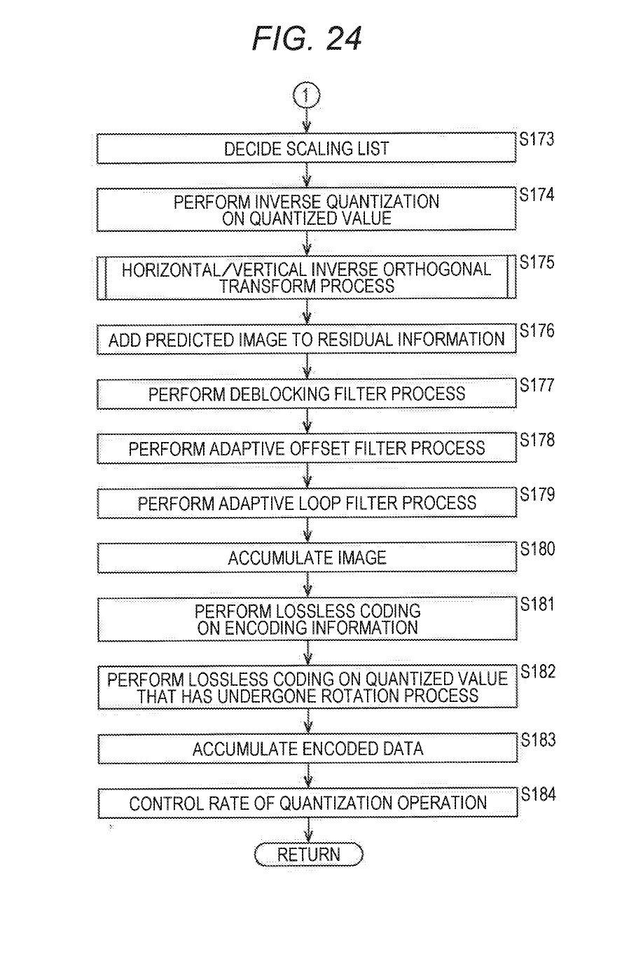

FIGS. 23 and 24 are flowcharts for describing the encoding process of the encoding unit 160 of FIG. 21.

A process of steps S161 to S171 of FIG. 23 is the same as the process of steps S31 to S41 of FIG. 11, and thus a description thereof is omitted.

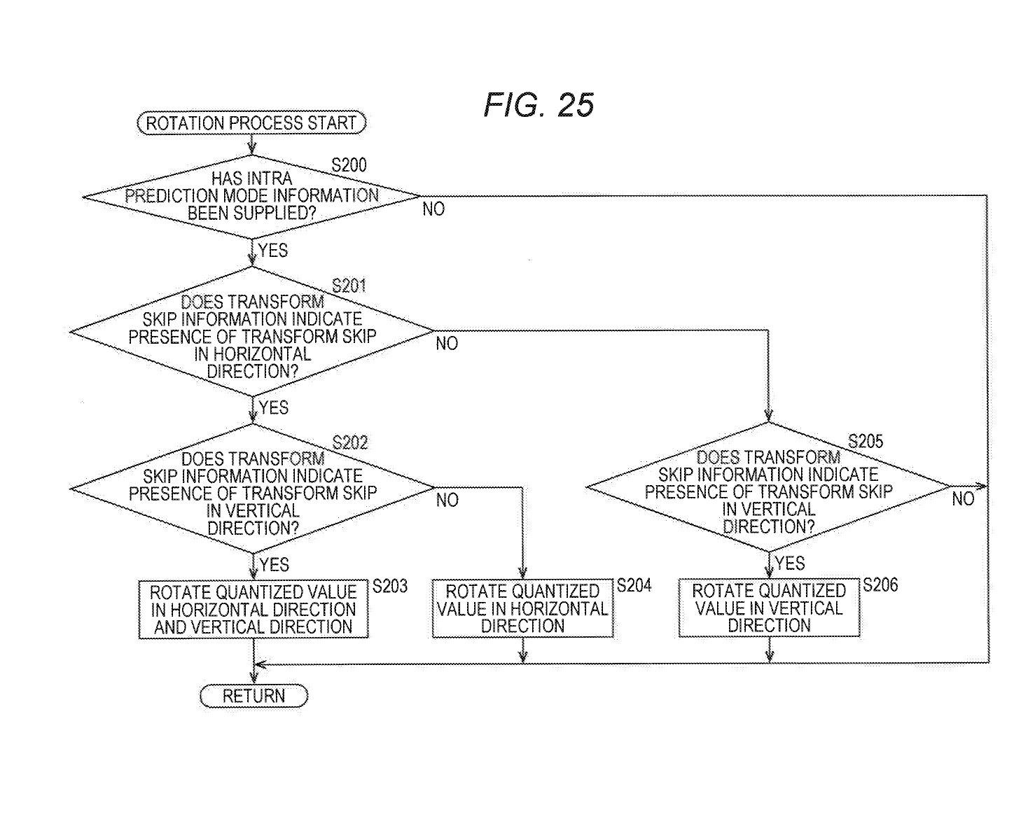

After the process of step S171, in step S172, the rotation unit 161 performs the rotation process for rotating the two-dimensional quantized value output from the quantization unit 35 based on the transform skip information in units of TUs. The rotation process will be described in detail with reference to FIG. 25 which will be described later.

A process of steps S173 to S181 of FIG. 24 is the same as the process of steps S42 to S50 of FIG. 12, and thus a description thereof is omitted.

In step S182, the lossless encoding unit 162 performs the lossless encoding on the quantized value that has undergone the rotation process and supplied from the rotation unit 161. Then, the lossless encoding unit 162 generates the encoded data from the encoding information that has undergone the lossless encoding in the process of step S181 and the quantized value that has undergone the lossless encoding, and supplies the encoded data to the accumulation buffer 37.

A process of steps S183 and S184 is the same as the process of steps S52 and S53 of FIG. 12, and thus a description thereof is omitted.

FIG. 25 is a flowchart for describing the details of the rotation process of step S172 of FIG. 23. The rotation process is performed, for example, in units of TUs.

In step S200 of FIG. 25, the rotation unit 161 determines whether or not the intra prediction mode information has been supplied from the intra prediction unit 46. When the intra prediction mode information is determined to have been supplied in step S200, that is, when the optimal prediction mode is the intra prediction mode, the process proceeds to step S201.

In step S201, the rotation unit 161 determines whether or not the transform skip information supplied from the skip control unit 50 indicates the presence of the transform skip in the horizontal direction.

When the transform skip information is determined to indicate the presence of the transform skip in the horizontal direction in step S201, the process proceeds to step S202. In step S202, the rotation unit 161 determines whether or not the transform skip information indicates the presence of the transform skip in the vertical direction.

When the transform skip information is determined to indicate the presence of the transform skip in the vertical direction in step S202, that is, when the transform skip in the horizontal direction and the vertical direction is performed, the process proceeds to step S203. In step S203, the rotation unit 161 rotates the quantized value supplied from the quantization unit 35 90° in the horizontal direction and the vertical direction. The rotation unit 161 supplies the rotated two-dimensional quantized value to the lossless encoding unit 162. Then, the process returns to step S172 of FIG. 23, and the process proceeds to step S173 of FIG. 24.

On the other hand, when the transform skip information is determined not to indicate the presence of the transform skip in the vertical direction in step S202, that is, when the transform skip in the horizontal direction has been performed but the transform skip in the vertical direction has not been performed, the process proceeds to step S204.

In step S204, the rotation unit 161 rotates the quantized value supplied from the quantization unit 35 90° in the horizontal direction. The rotation unit 161 supplies the rotated two-dimensional quantized value to the lossless encoding unit 162. Then, the process returns to step S172 of FIG. 23, and the process proceeds to step S173 of FIG. 24.

Further, when the transform skip information is determined not to indicate the presence of the transform skip in the horizontal direction in step S201, the process proceeds to step S205.

In step S205, the rotation unit 161 determines whether or not the transform skip information indicates the presence of the transform skip in the vertical direction. When the transform skip information is determined to indicate the presence of the transform skip in the vertical direction in step S205, that is, when the transform skip in the horizontal direction has not been performed but the transform skip in the vertical direction has been performed, the process proceeds to step S206.

In step S206, the rotation unit 161 rotates the quantized value supplied from the quantization unit 35 90° in the vertical direction. The rotation unit 161 supplies the rotated two-dimensional quantized value to the lossless encoding unit 162. Then, the process returns to step S172 of FIG. 23, and the process proceeds to step S173 of FIG. 24.

On the other hand, when the transform skip information is determined not to indicate the presence of the transform skip in the vertical direction in step S205, that is, when the transform skip in both the horizontal direction and the vertical direction has not been performed, the rotation unit 161 supplies the quantized value to the lossless encoding unit 162 without change. Then, the process returns to step S172 of FIG. 23, and the process proceeds to step S173 of FIG. 24.

Further, when the intra prediction mode information is determined to have not been supplied in step S200, that is, when the optimal prediction mode is the inter prediction mode, the rotation unit 161 supplies the quantized value to the lossless encoding unit 162 without change. Then, the process returns to step S172 of FIG. 23, and the process proceeds to step S173 of FIG. 24.

As described above, the encoding unit 160 rotates the quantized value in the direction in which the transform skip is performed and performs the lossless encoding on the rotated quantized value. As a result, at the time of the intra prediction, the high-order side of the one-dimensional quantized value that currently undergoes the lossless encoding becomes zero, and the low-order side becomes non-zero, and thus the encoding efficiency is further improved.

The quantized value that has undergone the rotation process through the rotation unit 161 may inversely be rotated and then supplied to the inverse quantization unit 38. In this case, a rotation unit that performs inverse rotation to the rotation performed by the rotation unit 161 is arranged at a stage prior to the inverse quantization unit 38.

(Exemplary Configuration of Decoding Unit of Decoding Device According to Second Embodiment)

A decoding device according to the second embodiment of the present disclosure has a similar configuration to the configuration of the decoding device 110 of FIG. 15 except the decoding unit 113. Thus, the following description will proceed focusing on the decoding unit.

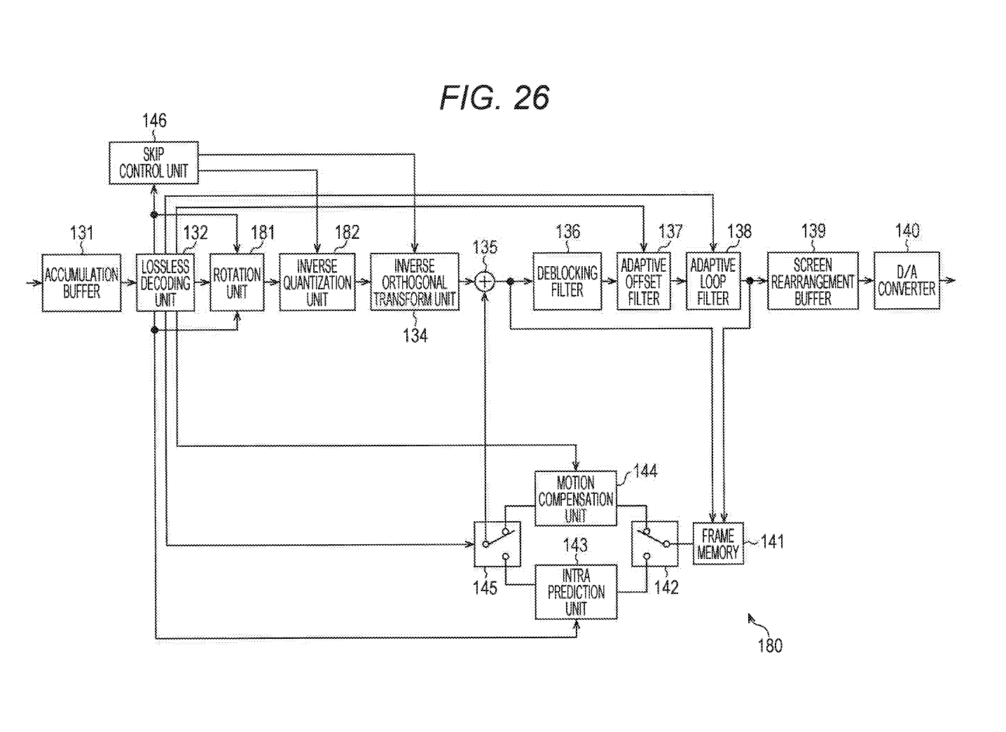

FIG. 26 is a block diagram illustrating an exemplary configuration of a decoding unit of a decoding device according to the second embodiment of the present disclosure.

In the configuration illustrated in FIG. 26, the same components as in FIG. 16 are denoted by the same reference numerals. A duplicated description will appropriately be omitted.

A configuration of a decoding unit 180 of FIG. 26 differs from the configuration of the decoding unit 113 of FIG. 16 in that a rotation unit 181 is newly provided, and an inverse quantization unit 182 is provided instead of the inverse quantization unit 133. The decoding unit 180 performs inverse rotation to the rotation in the encoding unit 160 on the quantized value based on the transform skip information at the time of the intra prediction.

Specifically, the transform skip information, the intra prediction mode information, and the quantized value are supplied from the lossless decoding unit 132 to the rotation unit 181 of the decoding unit 180. The rotation unit 181 performs an inverse rotation process for rotating the quantized value inversely to the rotation in the rotation unit 161 based on the transform skip information and the intra prediction mode information in units of TUs.

In other words, when the intra prediction mode information is supplied, and the transform skip information indicates the presence of the transform skip in the horizontal direction and the vertical direction, the rotation unit 181 rotates the quantized value, inversely to the rotation in the rotation unit 161, 90° in the horizontal direction and 90° in the vertical direction. On the other hand, when the intra prediction mode information is supplied, and the transform skip information indicates the presence of the transform skip in the horizontal direction and the absence of the transform skip in the vertical direction, the rotation unit 181 rotates the quantized value, inversely to the rotation in the rotation unit 161, 90° in the horizontal direction.

Further, when the intra prediction mode information is supplied, and the transform skip information indicates the presence of the transform skip in the vertical direction and the absence of the transform skip in the horizontal direction, the rotation unit 181 rotates the quantized value, inversely to the rotation in the rotation unit 161, 90° in the vertical direction. The rotation unit 181 supplies the quantized value that has undergone the inverse rotation process to the inverse quantization unit 182.

The inverse quantization unit 182 holds the scaling list of each TU size, similarly to the inverse quantization unit 133 of FIG. 16. The inverse quantization unit 182 decides the scaling list in units of TUs, similarly to the inverse quantization unit 133. The inverse quantization unit 182 performs inverse quantization on the quantized value that has undergone the inverse rotation process and supplied from the rotation unit 181 using the scaling list in units of TUs. The inverse quantization unit 182 supplies the orthogonal transform process result obtained as a result to the inverse orthogonal transform unit 134.

(Description of Process of Decoding Device)

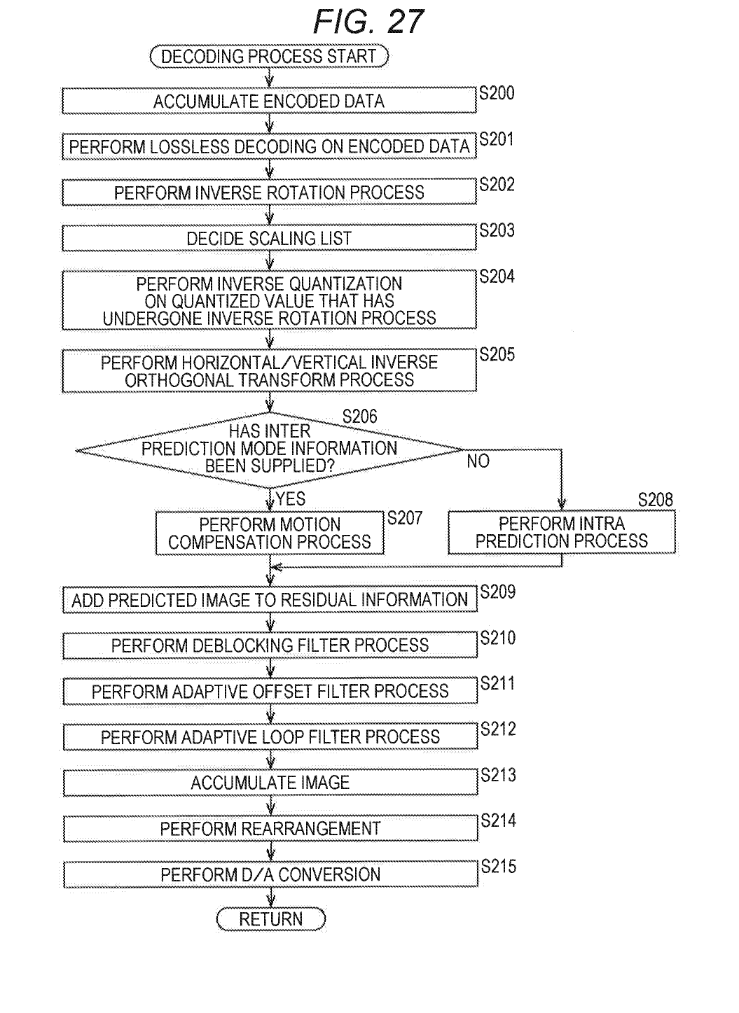

FIG. 27 is a flowchart for describing the decoding process of the decoding unit 180 of FIG. 26.

A process of steps S200 and S201 of FIG. 27 is the same as the process of steps S131 and S132 of FIG. 18, and thus a description thereof is omitted.

In step S202, the rotation unit 181 performs the inverse rotation process based on the transform skip information and the intra prediction mode information. The inverse rotation process is similar to the rotation process of FIG. 25 except that a rotation direction is opposite.

In step S203, the inverse quantization unit 182 decides the scaling list based on the transform skip information supplied from the skip control unit 146 and the held scaling list in units of TUs.

In step S204, the inverse quantization unit 182 performs inverse quantization on the quantized value that has undergone the inverse rotation process and supplied from the rotation unit 181 using the scaling list in units of TUs. The operation unit 104 supplies the orthogonal transform process result obtained as a result of inverse quantization to the inverse orthogonal transform unit 134.

A process of steps S205 to S215 is the same as the process of steps S135 to S145 of FIG. 18, and thus a description thereof is omitted.

As described above, the decoding unit 180 rotates the quantized value that has undergone the lossless decoding in the direction in which the transform skip is performed, inversely to the encoding unit 160. Thus, it is possible to decode the encoded stream in which the encoding efficiency at the time of the intra prediction has been improved by the encoding unit 160.

### Third Embodiment

### Description of Computer According to Present Disclosure

The above-described series of processes may be executed by hardware or software. When the series of processes are executed by software, a program configuring the software is installed in a computer. Here, examples of the computer includes a computer incorporated into dedicated hardware and a general purpose personal computer that includes various programs installed therein and is capable of executing various kinds of functions.

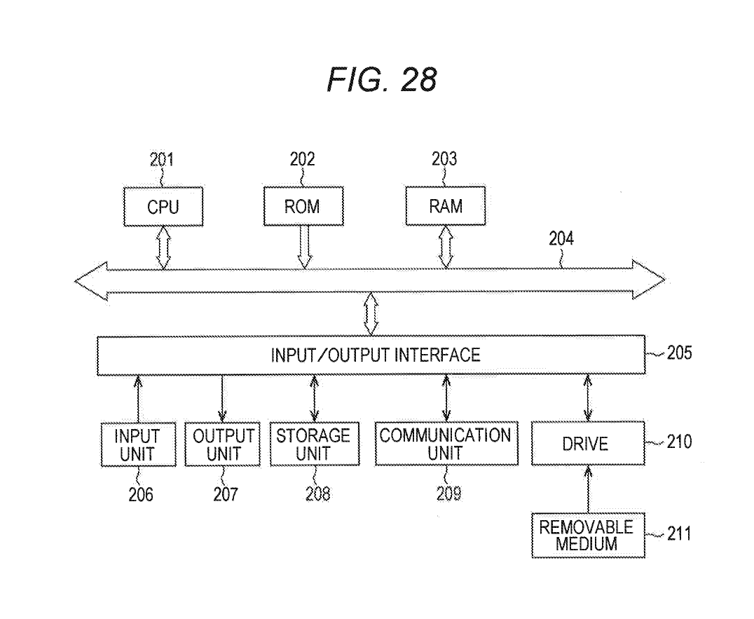

FIG. 28 is a block diagram illustrating an exemplary hardware configuration of a computer that executes the above-described series of processes by a program.

In a computer, a central processing unit (CPU) 201, a read only memory (ROM) 202, and a random access memory (RAM) 203 are connected with one another via a bus 204.

An input/output (I/O) interface 205 is further connected to the bus 204. An input unit 206, an output unit 207, a storage unit 208, a communication unit 209, and a drive 210 are connected to the I/O interface 205.

The input unit 206 includes a keyboard, a mouse, a microphone, and the like. The output unit 207 includes a display, a speaker, and the like. The storage unit 208 includes a hard disk, a non-volatile memory, and the like. The communication unit 209 includes a network interface or the like. The drive 210 drives a removable medium 211 such as a magnetic disk, an optical disk, a magneto optical disk, or a semiconductor memory.

In the computer having the above configuration, the CPU 201 executes the above-described series of processes, for example, by loading the program stored in the storage unit 208 onto the RAM 203 through the I/O interface 205 and the bus 204 and executing the program.

For example, the program executed by the computer (the CPU 201) may be recorded in the removable medium 211 as a package medium or the like and provided. Further, the program may be provided through a wired or wireless transmission medium such as a local area network (LAN), the Internet, or digital satellite broadcasting.

In the computer, the removable medium 211 is mounted to the drive 210, and then the program may be installed in the storage unit 208 through the I/O interface 205. Further, the program may be received by the communication unit 209 via a wired or wireless transmission medium and then installed in the storage unit 208. In addition, the program may be installed in the ROM 202 or the storage unit 208 in advance.

Further, the program may be a program in which the processes are chronologically performed in the order described in this disclosure or may be a program in which the processes are performed in parallel or at necessary timings such as called timings.

### Fourth Embodiment

### Application to Multi-View Image Coding and Multi-View Image Decoding

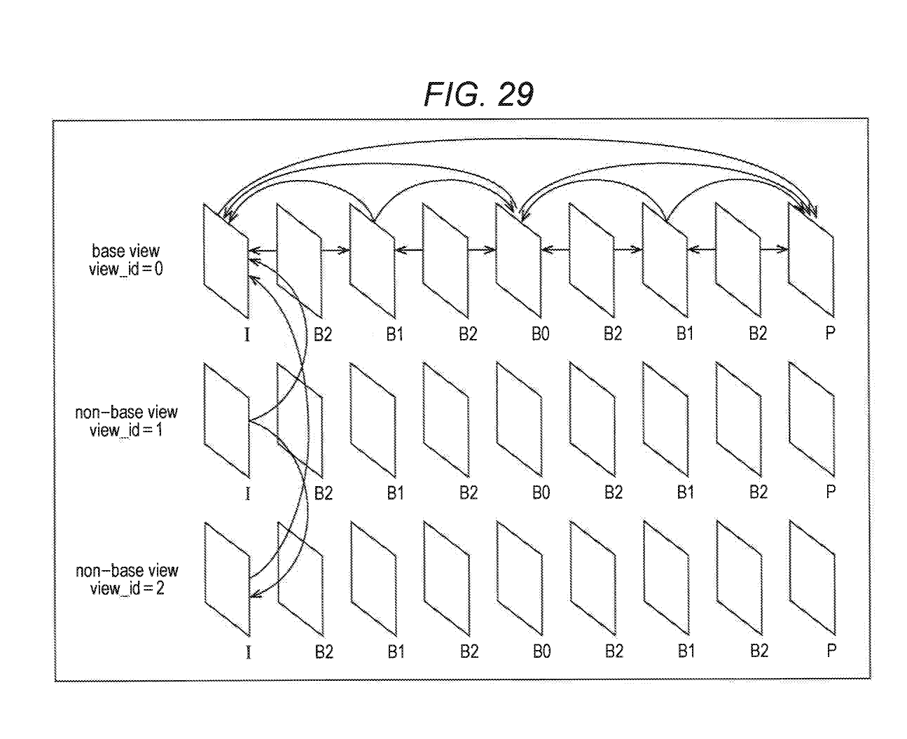

The above-described series of processes can be applied to multi-view image coding and multi-view image decoding. FIG. 29 illustrates an exemplary multi-view image coding scheme.

As illustrated in FIG. 29, a multi-view image includes images of a plurality of views. The plurality of views of the multi-view image include a base view in which encoding and decoding are performed using only an image of its own view without using images of other views and a non-base view in which encoding and decoding are performed using images of other views. As the non-base view, an image of a base view may be used, and an image of another non-base view may be used.

When the multi-view image of FIG. 29 is encoded and decoded, an image of each view is encoded and decoded, but the technique according to the first embodiment may be applied to encoding and decoding of respective views. Accordingly, it is possible to improve the encoding efficiency by the optimization of the transform skip.

Furthermore, the flags or the parameters used in the technique according to the first embodiment may be shared in encoding and decoding of respective views. More specifically, for example, the syntax elements of the SPS, the PPS, and residual_coding may be shared in encoding and decoding of respective views. Of course, any other necessary information may be shared in encoding and decoding of respective views.

Accordingly, it is possible to prevent transmission of redundant information and reduce an amount (bit rate) of information to be transmitted (that is, it is possible to prevent coding efficiency from degrading.

(Multi-View Image Encoding Device)

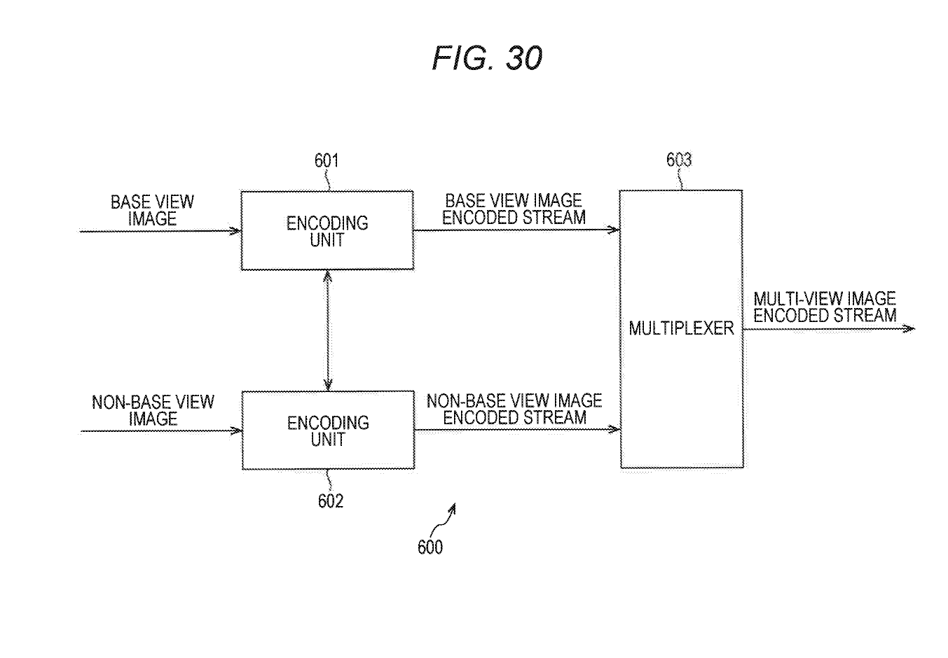

FIG. 30 is a diagram illustrating a multi-view image encoding device that performs the above-described multi-view image coding. A multi-view image encoding device 600 includes an encoding unit 601, an encoding unit 602, and a multiplexer 603 as illustrated in FIG. 30.

The encoding unit 601 encodes a base view image, and generates a base view image encoded stream. The encoding unit 602 encodes a non-base view image, and generates a non-base view image encoded stream. The multiplexer 603 performs multiplexing of the base view image encoded stream generated by the encoding unit 601 and the non-base view image encoded stream generated by the encoding unit 602, and generates a multi-view image encoded stream.

The encoding device 10 (FIG. 1) can be applied as the encoding unit 601 and the encoding unit 602 of the multi-view image encoding device 600. In other words, it is possible to improve the encoding efficiency by optimizing the transform skip when encoding of each view is performed. Further, the encoding unit 601 and the encoding unit 602 can perform encoding using the same flags or parameters (for example, syntax elements related to inter-image processing) (that is, can share the flags or the parameters), and thus it is possible to prevent the coding efficiency from degrading.

(Multi-View Image Decoding Device)

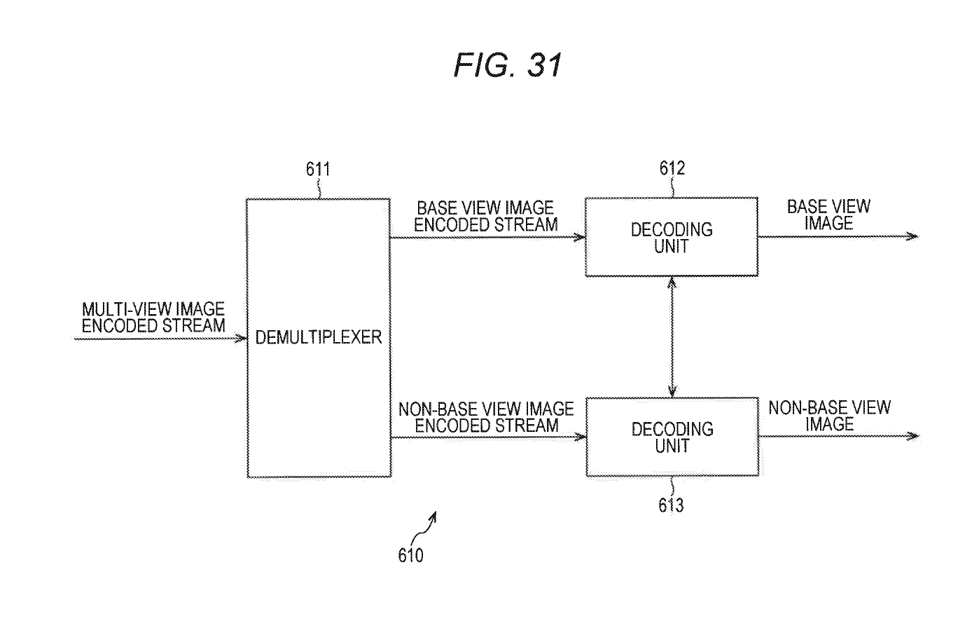

FIG. 31 is a diagram illustrating a multi-view image decoding device that performs the above-described multi-view image decoding. A multi-view image decoding device 610 includes a demultiplexer 611, a decoding unit 612, and a decoding unit 613 as illustrated in FIG. 31.

The demultiplexer 611 performs demultiplexing of the multi-view image encoded stream obtained by multiplexing the base view image encoded stream and the non-base view image encoded stream, and extracts the base view image encoded stream and the non-base view image encoded stream. The decoding unit 612 decodes the base view image encoded stream extracted by the demultiplexer 611, and obtains the base view image. The decoding unit 613 decodes the non-base view image encoded stream extracted by the demultiplexer 611, and obtains the non-base view image.

The decoding device 110 (FIG. 15) can be applied as the decoding unit 612 and the decoding unit 613 of the multi-view image decoding device 610. In other words, it is possible to decode an encoded stream in which the encoding efficiency has been improved by optimizing the transform skip when decoding of each view is performed. Further, the decoding unit 612 and the decoding unit 613 can perform decoding using the same flags or parameters (for example, syntax elements related to inter-image processing) (that is, can share the flags or the parameters), and thus it is possible to prevent the coding efficiency from degrading.

### Fifth Embodiment

### Application to Scalable Image Coding and Scalable Image Decoding

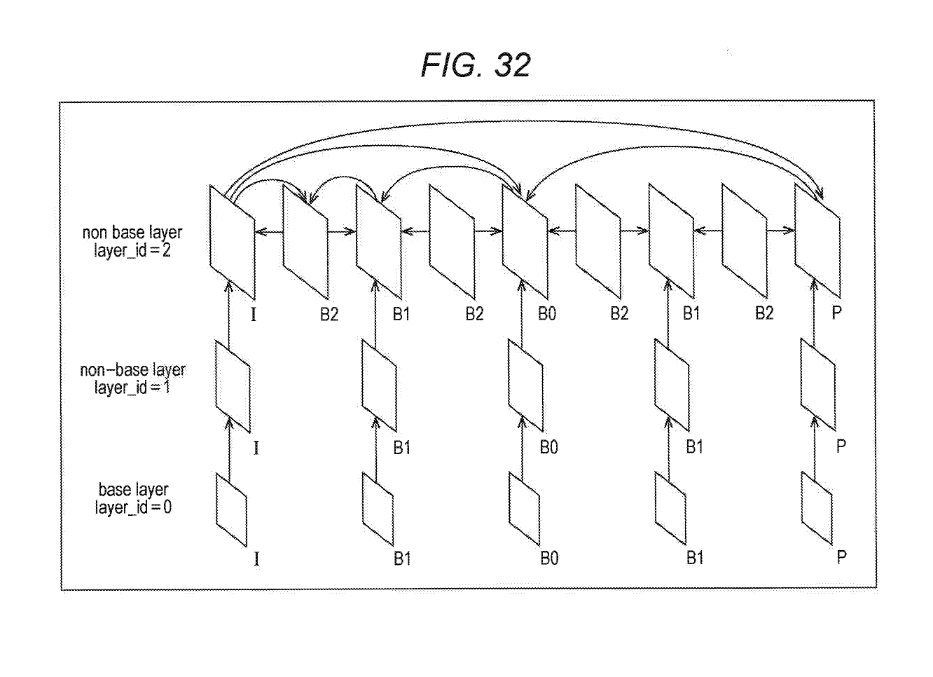

The above-described series of processes can be applied to scalable image coding and scalable image decoding (scalable coding and scalable decoding). FIG. 32 illustrates an exemplary scalable image coding scheme.

The scalable image coding (scalable coding) is a scheme in which an image is divided into a plurality of layers (hierarchized) so that image data has a scalable function for a certain parameter, and encoding is performed on each layer. The scalable image decoding (scalable decoding) is decoding corresponding to the scalable image coding.

As illustrated in FIG. 32, for hierarchization of an image, an image is divided into a plurality of images (layers) based on a certain parameter having a scalable function. In other words, a hierarchized image (a scalable image) includes images of a plurality of layers that differ in a value of the certain parameter from one another. The plurality of layers of the scalable image include a base layer in which encoding and decoding are performed using only an image of its own layer without using images of other layers and non-base layers (which are also referred to as “enhancement layers”) in which encoding and decoding are performed using images of other layers. As the non-base layer, an image of the base layer may be used, and an image of any other non-base layer may be used.

Generally, the non-base layer is configured with data (differential data) of a differential image between its own image and an image of another layer so that the redundancy is reduced. For example, when one image is hierarchized into two layers, that is, a base layer and a non-base layer (which is also referred to as an enhancement layer), an image of a quality lower than an original image is obtained when only data of the base layer is used, and an original image (that is, a high quality image) is obtained when both data of the base layer and data of the non-base layer are combined.

As an image is hierarchized as described above, images of various qualities can be easily obtained depending on the situation. For example, for a terminal having a low processing capability such as a mobile terminal, image compression information of only the base layer is transmitted, and a moving image of low spatial and temporal resolutions or a low quality is reproduced, and for a terminal having a high processing capability such as a television or a personal computer, image compression information of the enhancement layer as well as the base layer is transmitted, and a moving image of high spatial and temporal resolutions or a high quality is reproduced. In other words, without performing the transcoding process, image compression information according to a capability of a terminal or a network can be transmitted from a server.

When the scalable image illustrated in FIG. 32 is encoded and decoded, images of respective layers are encoded and decoded, but the technique according to the first embodiment may be applied to encoding and decoding of the respective layers. Accordingly, it is possible to improve the encoding efficiency by optimizing the transform skip.

Furthermore, the flags or the parameters used in the technique according to the first embodiment may be shared in encoding and decoding of respective layers. More specifically, for example, the syntax elements of the SPS, the PPS, and residual_coding may be shared in encoding and decoding of respective layers. Of course, any other necessary information may be shared in encoding and decoding of respective views.

Accordingly, it is possible to prevent transmission of redundant information and reduce an amount (bit rate) of information to be transmitted (that is, it is possible to prevent coding efficiency from degrading).

(Scalable Parameter)

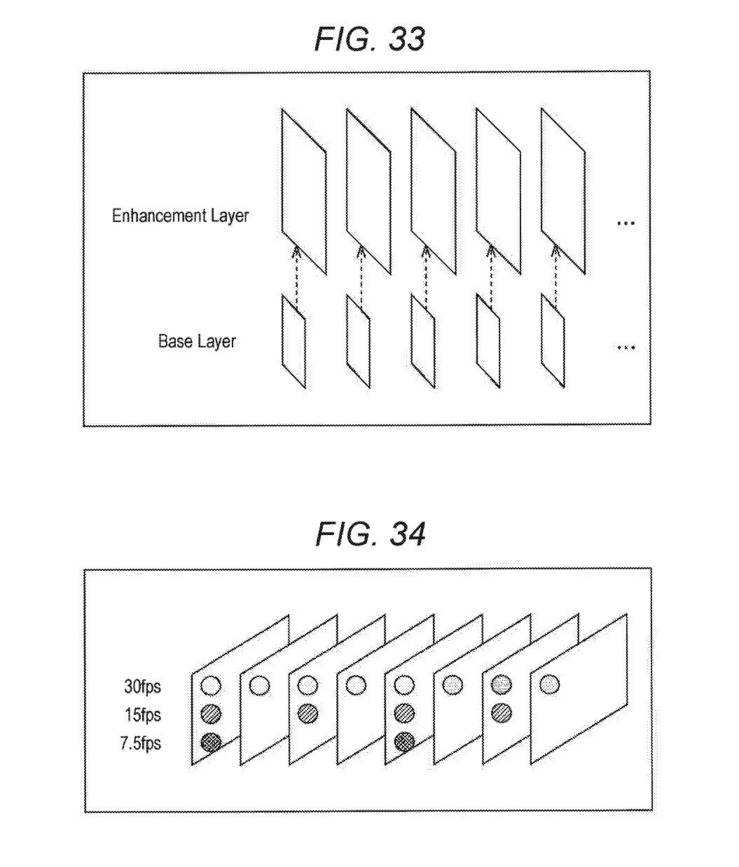

In the scalable image coding and the scalable image decoding (the scalable coding and the scalable decoding), any parameter has a scalable function. For example, a spatial resolution may be used as the parameter (spatial scalability) as illustrated in FIG. 33. In the case of the spatial scalability, respective layers have different image resolutions. In other words, in this case, each picture is hierarchized into two layers, that is, a base layer of a resolution spatially lower than that of an original image and an enhancement layer that is combined with the base layer to obtain an original spatial resolution as illustrated in FIG. 33. Of course, the number of layers is an example, and each picture can be hierarchized into an arbitrary number of layers.

As another parameter having such scalability, for example, a temporal resolution may be applied (temporal scalability) as illustrated in FIG. 34. In the case of the temporal scalability, respective layers have different frame rates. In other words, in this case, each picture is hierarchized into two layers, that is, a base layer of a frame rate lower than that of an original moving image and an enhancement layer that is combined with the base layer to obtain an original frame rate as illustrated in FIG. 34. Of course, the number of layers is an example, and each picture can be hierarchized into an arbitrary number of layers.

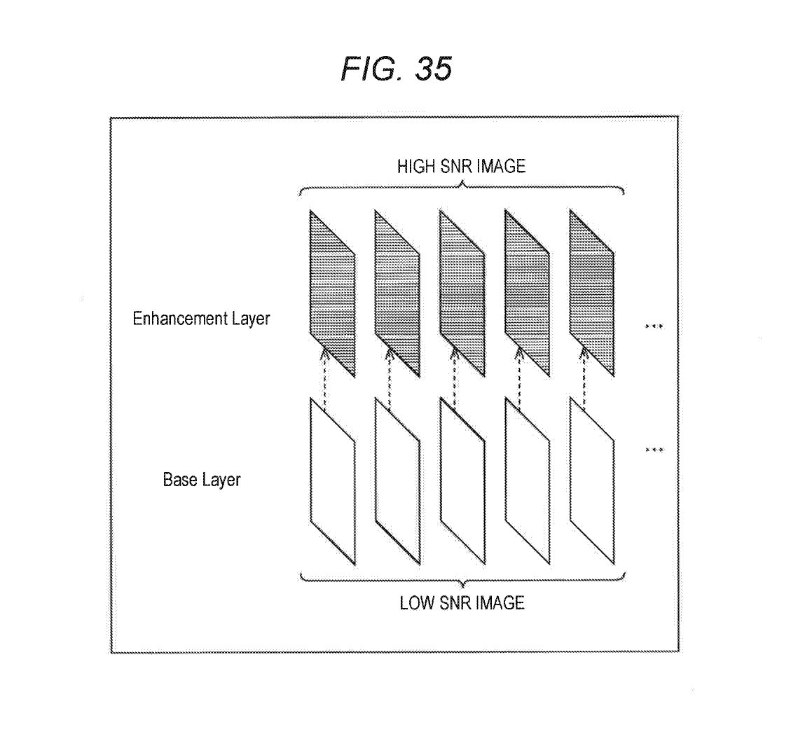

As another parameter having such scalability, for example, a signal-to-noise ratio (SNR) may be applied (SNR scalability). In the case of the SNR scalability, respective layers have different SNRs. In other words, in this case, each picture is hierarchized into two layers, that is, a base layer of a SNR lower than that of an original image and an enhancement layer that is combined with the base layer to obtain an original SNR as illustrated in FIG. 35. Of course, the number of layers is an example, and each picture can be hierarchized into an arbitrary number of layers.

A parameter other than the above-described examples may be applied as a parameter having scalability. For example, a bit depth may be used as a parameter having scalability (bit-depth scalability). In the case of the bit-depth scalability, respective layers have different bit depths. In this case, for example, the base layer (base layer) includes an 8-bit image, and a 10-bit image can be obtained by adding the enhancement layer to the base layer.

As another parameter having scalability, for example, a chroma format may be used (chroma scalability). In the case of the chroma scalability, respective layers have different chroma formats. In this case, for example, the base layer (base layer) includes a component image of a 4:2:0 format, and a component image of a 4:2:2 format can be obtained by adding the enhancement layer to the base layer.

(Scalable Image Encoding Device)

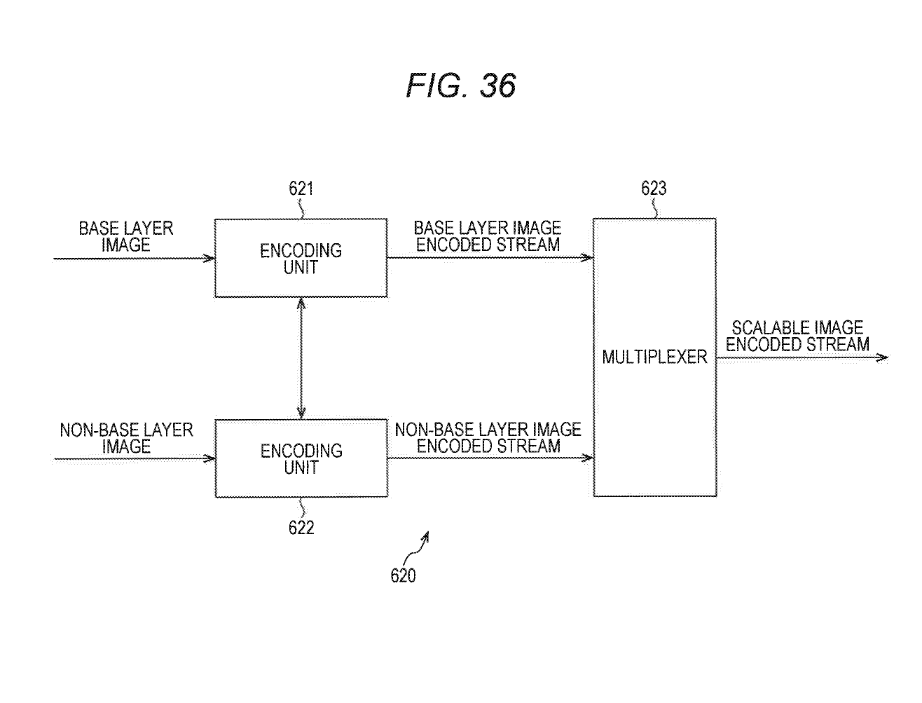

FIG. 36 is a diagram illustrating a scalable image encoding device that performs the above-described scalable image coding. A scalable image encoding device 620 includes an encoding unit 621, an encoding unit 622, and a multiplexer 623 as illustrated in FIG. 36.

The encoding unit 621 encodes a base layer image, and generates a base layer image encoded stream. The encoding unit 622 encodes a non-base layer image, and generates a non-base layer image encoded stream. The multiplexer 623 performs multiplexing the base layer image encoded stream generated by the encoding unit 621 and the non-base layer image encoded stream generated by the encoding unit 622, and generates a scalable image encoded stream.

The encoding device 10 (FIG. 1) can be applied as the encoding unit 621 and the encoding unit 622 of the scalable image encoding device 620. In other words, it is possible to improve the encoding efficiency by optimizing the transform skip when encoding of each layer is performed. Further, the encoding unit 621 and the encoding unit 622 can perform, for example, control of an intra prediction filter process using the same flags or parameters (for example, syntax elements related to inter-image processing) (that is, can share the flags or the parameters), and thus it is possible to prevent the coding efficiency from degrading.

(Scalable Image Decoding Device)

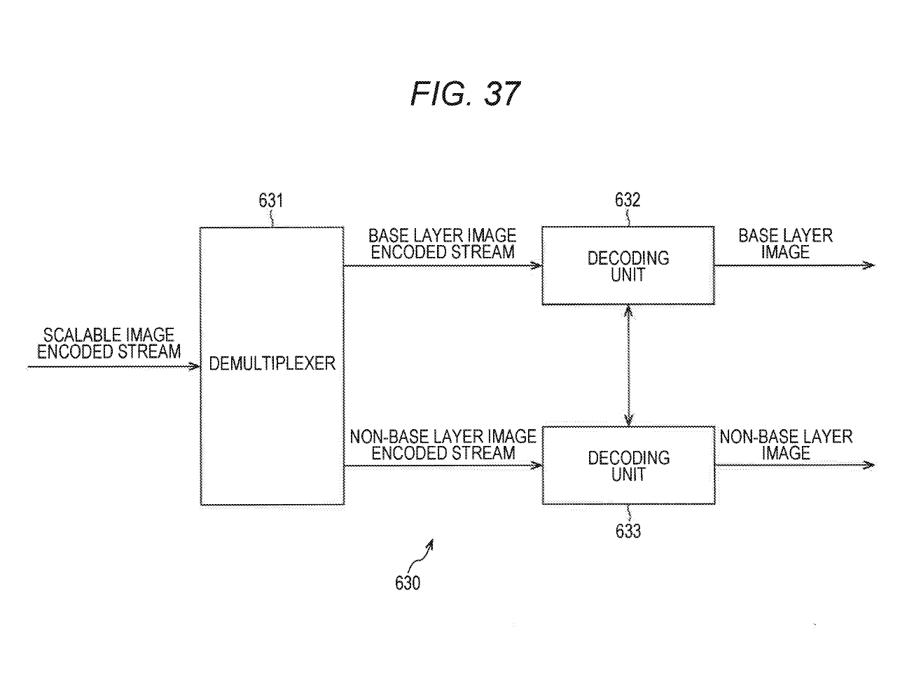

FIG. 37 is a diagram illustrating a scalable image decoding device that performs the above-described scalable image decoding. A scalable image decoding device 630 includes a demultiplexer 631, a decoding unit 632, and a decoding unit 633 as illustrated in FIG. 37.

The demultiplexer 631 performs demultiplexing of the scalable image encoded stream obtained by multiplexing the base layer image encoded stream and the non-base layer image encoded stream, and extracts the base layer image encoded stream and the non-base layer image encoded stream. The decoding unit 632 decodes the base layer image encoded stream extracted by the demultiplexer 631, and obtains the base layer image. The decoding unit 633 decodes the non-base layer image encoded stream extracted by the demultiplexer 631, and obtains the non-base layer image.

The decoding device 110 (FIG. 15) can be applied as the decoding unit 632 and the decoding unit 633 of the scalable image decoding device 630. In other words, it is possible to decode the encoded stream in which the encoding efficiency has been improved by optimizing the transform skip when decoding of each layer is performed. Further, the decoding unit 612 and the decoding unit 613 can perform decoding using the same flags or parameters (for example, syntax elements related to inter-image processing) (that is, can share the flags or the parameters), and thus it is possible to prevent the coding efficiency from degrading.

### Sixth Embodiment

### Exemplary Configuration of Television Device

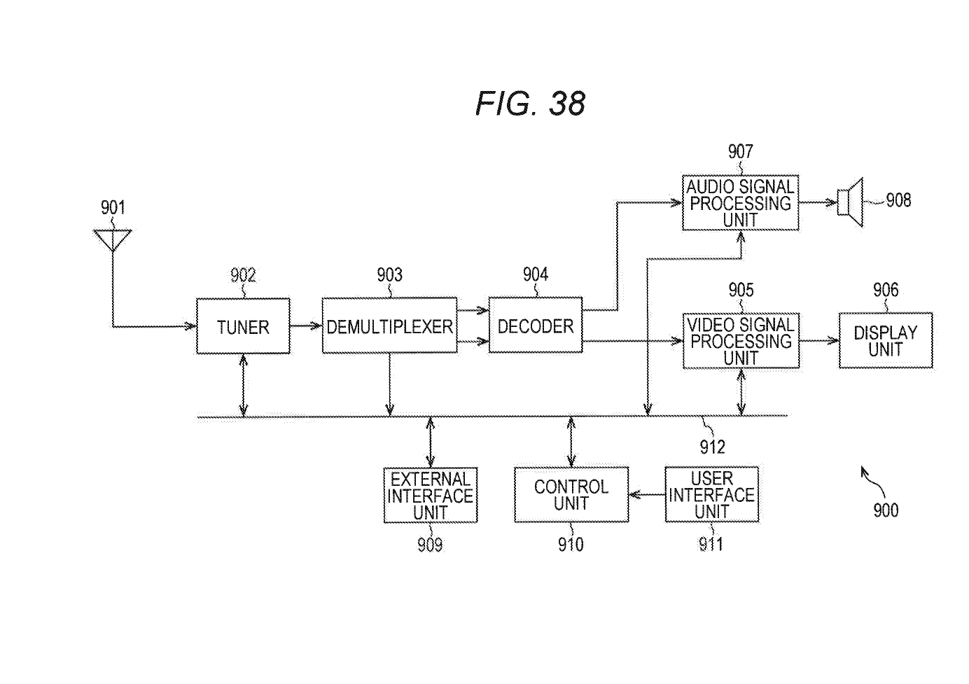

FIG. 38 illustrates a schematic configuration of a television device to which the present disclosure is applied. A television device 900 includes an antenna 901, a tuner 902, a demultiplexer 903, a decoder 904, a video signal processing unit 905, a display unit 906, an audio signal processing unit 907, a speaker 908, and an external I/F unit 909. The television device 900 further includes a control unit 910, a user I/F unit 911, and the like.

The tuner 902 tunes to a desired channel from a broadcast signal received by the antenna 901, performs demodulation, and outputs an obtained encoded bitstream to the demultiplexer 903.

The demultiplexer 903 extracts video or audio packets of a program of a viewing target from the encoded bitstream, and outputs data of the extracted packets to the decoder 904. The demultiplexer 903 provides data of packets of data such as an electronic program guide (EPG) to the control unit 910. Further, when scrambling has been performed, descrambling is performed by the demultiplexer or the like.

The decoder 904 performs a decoding process of decoding the packets, and outputs video data and audio data generated by the decoding process to the video signal processing unit 905 and the audio signal processing unit 907.

The video signal processing unit 905 performs a noise canceling process or video processing according to a user setting on the video data. The video signal processing unit 905 generates video data of a program to be displayed on the display unit 906, image data according to processing based on an application provided via a network, or the like. The video signal processing unit 905 generates video data for displaying, for example, a menu screen used to select an item, and causes the video data to be superimposed on video data of a program. The video signal processing unit 905 generates a drive signal based on the video data generated as described above, and drives the display unit 906.

The display unit 906 drives a di splay device (for example, a liquid crystal display device or the like) based on the drive signal provided from the video signal processing unit 905, and causes a program video or the like to be displayed.

The audio signal processing unit 907 performs a certain process such as a noise canceling process on the audio data, performs a digital to analog (D/A) conversion process and an amplification process on the processed audio data, and provides resultant data to the speaker 908 to output a sound.

The external I/F unit 909 is an interface for a connection with an external device or a network, and performs transmission and reception of data such as video data or audio data.

The user I/F unit 911 is connected with the control unit 910. The user I/F unit 911 includes an operation switch, a remote control signal receiving unit, and the like, and provides an operation signal according to the user's operation to the control unit 910.

The control unit 910 includes a central processing unit (CPU), a memory, and the like. The memory stores a program executed by the CPU, various kinds of data necessary when the CPU performs processing, EPG data, data acquired via a network, and the like. The program stored in the memory is read and executed by the CPU at a certain timing such as a timing at which the television device 900 is activated. The CPU executes the program, and controls the respective units such that the television device 900 is operated according to the user's operation.

The television device 900 is provided with a bus 912 that connects the tuner 902, the demultiplexer 903, the video signal processing unit 905, the audio signal processing unit 907, the external I/F unit 909, and the like with the control unit 910.

In the television device having the above configuration, the decoder 904 is provided with the function of the decoding device (decoding method) according to the present disclosure. Thus, it is possible to decode an encoded stream in which the encoding efficiency has been improved by optimizing the transform skip.

### Seventh Embodiment

### Exemplary Configuration of Mobile Telephone

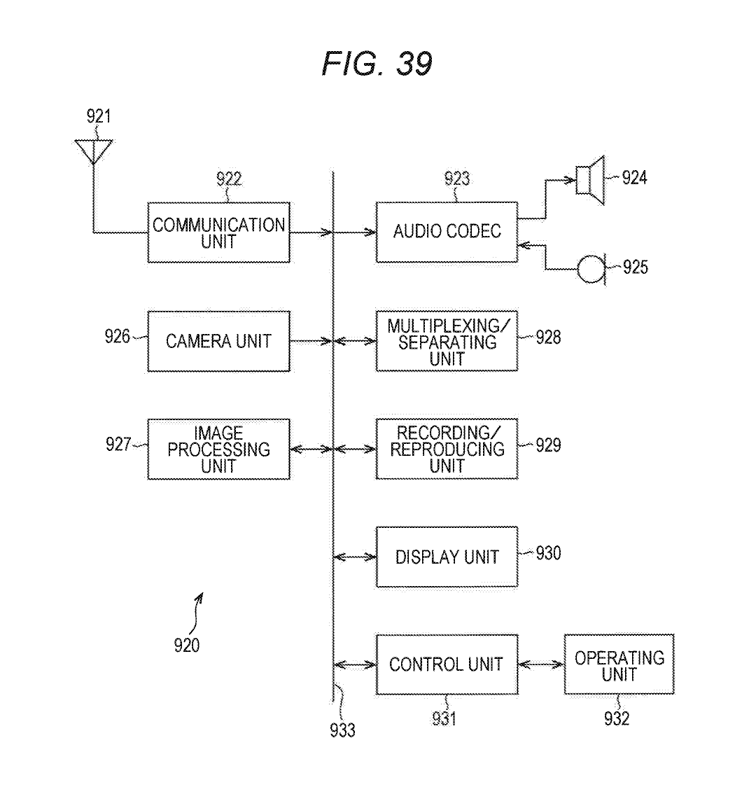

FIG. 39 illustrates a schematic configuration of a mobile telephone to which the present disclosure is applied. A mobile telephone 920 includes a communication unit 922, an audio codec 923, a camera unit 926, an image processing unit 927, a multiplexing/separating unit 928, a recording/reproducing unit 929, a display unit 930, and a control unit 931. These units are connected with one another via a bus 933.

Further, an antenna 921 is connected to the communication unit 922, and a speaker 924 and a microphone 925 are connected to the audio codec 923. Further, an operating unit 932 is connected to the control unit 931.

The mobile telephone 920 performs various kinds of operations such as transmission and reception of an audio signal, transmission and reception of an electronic mail or image data, image capturing, or data recording in various modes such as an audio call mode and a data communication mode.

In the audio call mode, an audio signal generated by the microphone 925 is converted to audio data through the audio codec 923, compressed, and then provided to the communication unit 922. The communication unit 922 performs, for example, a modulation process and a frequency transform process of the audio data, and generates a transmission signal. Further, the communication unit 922 provides the transmission signal to the antenna 921 so that the transmission signal is transmitted to a base station (not illustrated). Further, the communication unit 922 performs an amplification process, a frequency transform process, and a demodulation process of a reception signal received through the antenna 921, and provides the obtained audio data to the audio codec 923. The audio codec 923 decompresses the audio data, converts the compressed data to an analog audio signal, and outputs the analog audio signal to the speaker 924.

In the data communication mode, when mail transmission is performed, the control unit 931 receives text data input by operating the operating unit 932, and causes the input text to be displayed on the display unit 930. Further, the control unit 931 generates mail data, for example, based on a user instruction input through the operating unit 932, and provides the mail data to the communication unit 922. The communication unit 922 performs, for example, a modulation process and a frequency transform process of the mail data, and transmits an obtained transmission signal through the antenna 921. Further, the communication unit 922 performs, for example, an amplification process, a frequency transform process, and a demodulation process of a reception signal received through the antenna 921, and restores the mail data. The mail data is provided to the display unit 930 so that mail content is displayed.

The mobile telephone 920 can store the received mail data in a storage medium through the recording/reproducing unit 929. The storage medium is an arbitrary rewritable storage medium. Examples of the storage medium include a semiconductor memory such as a RAM or an internal flash memory, a hard disk, a magnetic disk, a magneto optical disk, an optical disk, and a removable medium such as a universal serial bus (USB) memory or a memory card.

In the data communication mode, when image data is transmitted, image data generated through the camera unit 926 is provided to the image processing unit 927. The image processing unit 927 performs an encoding process of encoding the image data, and generates encoded data.

The multiplexing/separating unit 928 multiplexes the encoded data generated through the image processing unit 927 and the audio data provided from the audio codec 923 according to a certain scheme, and provides resultant data to the communication unit 922. The communication unit 922 performs, for example, a modulation process and a frequency transform process of the multiplexed data, and transmits an obtained transmission signal through the antenna 921. Further, the communication unit 922 performs, for example, an amplification process, a frequency transform process, and a demodulation process of a reception signal received through the antenna 921, and restores multiplexed data. The multiplexed data is provided to the multiplexing/separating unit 928. The multiplexing/separating unit 928 demultiplexes the multiplexed data, and provides the encoded data and the audio data to the image processing unit 927 and the audio codec 923. The image processing unit 927 performs a decoding process of decoding the encoded data, and generates image data. The image data is provided to the display unit 930 so that a received image is displayed. The audio codec 923 converts the audio data into an analog audio signal, provides the analog audio signal to the speaker 924, and outputs a received audio.

In the mobile telephone having the above configuration, the image processing unit 927 is provided with the function of the encoding device and the decoding device (the encoding method and the decoding method) according to the present disclosure. Thus, it is possible to improve the encoding efficiency by optimizing the transform skip. Further, it is possible to decode the encoded stream in which the encoding efficiency has been improved by optimizing the transform skip.

### Eighth Embodiment

### Exemplary Configuration of Recording/Reproducing Device

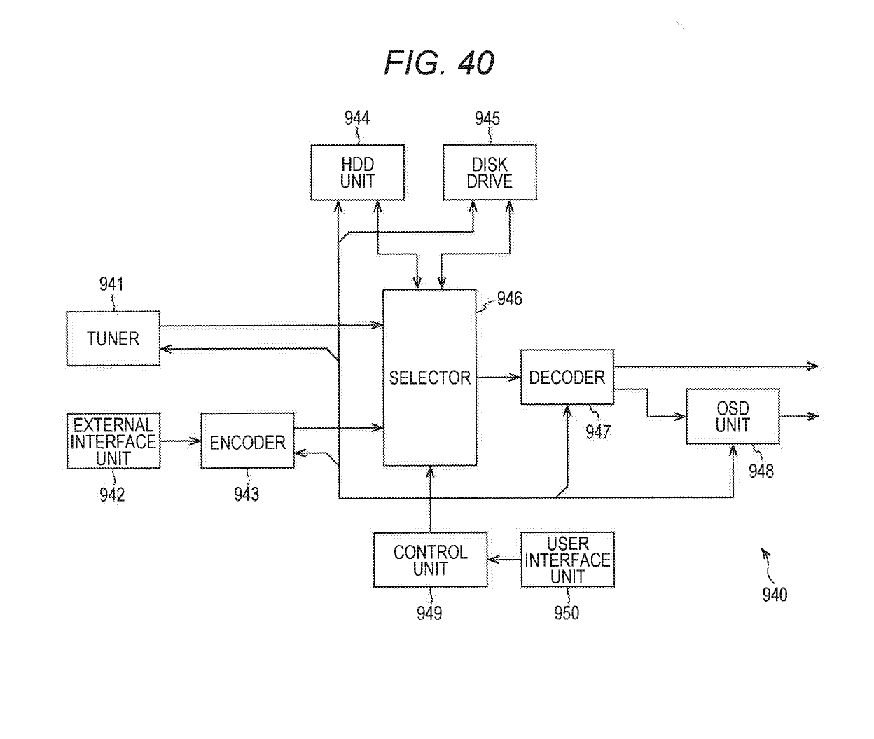

FIG. 40 illustrates a schematic configuration of a recording/reproducing device to which the present disclosure is applied. A recording/reproducing device 940 records, for example, audio data and video data of a received broadcast program in a recording medium, and provides the recorded data to the user at a timing according to the user's instruction. Further, the recording/reproducing device 940 can acquire, for example, audio data or video data from another device and cause the acquired data to be recorded in a recording medium. Furthermore, the recording/reproducing device 940 decodes and outputs the audio data or the video data recorded in the recording medium so that an image display or a sound output can be performed in a monitor device.

The recording/reproducing device 940 includes a tuner 941, an external I/F unit 942, an encoder 943, a hard disk drive (HDD) unit 944, a disk drive 945, a selector 946, a decoder 947, an on-screen display (OSD) unit 948, a control unit 949, and a user I/F unit 950.

The tuner 941 tunes to a desired channel from a broadcast signal received through an antenna (not illustrated). The tuner 941 demodulates a reception signal of the desired channel, and outputs an obtained encoded bitstream to the selector 946.

The external I/F unit 942 is configured with at least one of an IEEE1394 interface, a network interface, a USB interface, a flash memory interface, and the like. The external I/F unit 942 is an interface for a connection with an external device, a network, a memory card, and the like, and receives data such as video data and audio data to be recorded.

The encoder 943 encodes non-encoded video data or audio data provided from the external I/F unit 942 according to a certain scheme, and outputs an encoded bitstream to the selector 946.

The HDD unit 944 records content data such as a video or a sound, various kinds of programs, and other data in an internal hard disk, and reads recorded data from the hard disk at the time of reproduction or the like.

The disk drive 945 records a signal in a mounted optical disk, and reproduces a signal from the optical disk. Examples of the optical disk include a DVD disk (DVD-Video, DVD-RAM, DVD-R, DVD-RW, DVD+R, DVD+RW, and the like) and a Blu-ray™ disk.

When a video or a sound is recorded, the selector 946 selects either of an encoded bitstream provided from the tuner 941 and an encoded bitstream provided from the encoder 943, and provides the selected encoded bitstream to either of the HDD unit 944 or the disk drive 945. Further, when a video or a sound is reproduced, the selector 946 provides the encoded bitstream output from the HDD unit 944 or the disk drive 945 to the decoder 947.

The decoder 947 performs the decoding process of decoding the encoded bitstream. The decoder 947 provides video data generated by performing the decoding process to the OSD unit 948. Further, the decoder 947 outputs audio data generated by performing the decoding process.

The OSD unit 948 generates video data used to display, for example, a menu screen used to, for example, select an item, and outputs the video data to be superimposed on the video data output from the decoder 947.

The user I/F unit 950 is connected to the control unit 949. The user I/F unit 950 includes an operation switch, a remote control signal receiving unit, and the like, and provides an operation signal according to the user's operation to the control unit 949.

The control unit 949 is configured with a CPU, a memory, and the like. The memory stores a program executed by the CPU and various kinds of data necessary when the CPU performs processing. The program stored in the memory is read and executed by the CPU at a certain timing such as a timing at which the recording/reproducing device 940 is activated. The CPU executes the program, and controls the respective units such that the recording/reproducing device 940 is operated according to the user's operation.

In the recording/reproducing device having the above configuration, the decoder 947 is provided with the function of the decoding device (decoding method) according to the present disclosure. Thus, it is possible to decode the encoded stream in which the encoding efficiency has been improved by optimizing the transform skip.

### Ninth Embodiment

### Exemplary Configuration of Imaging Device

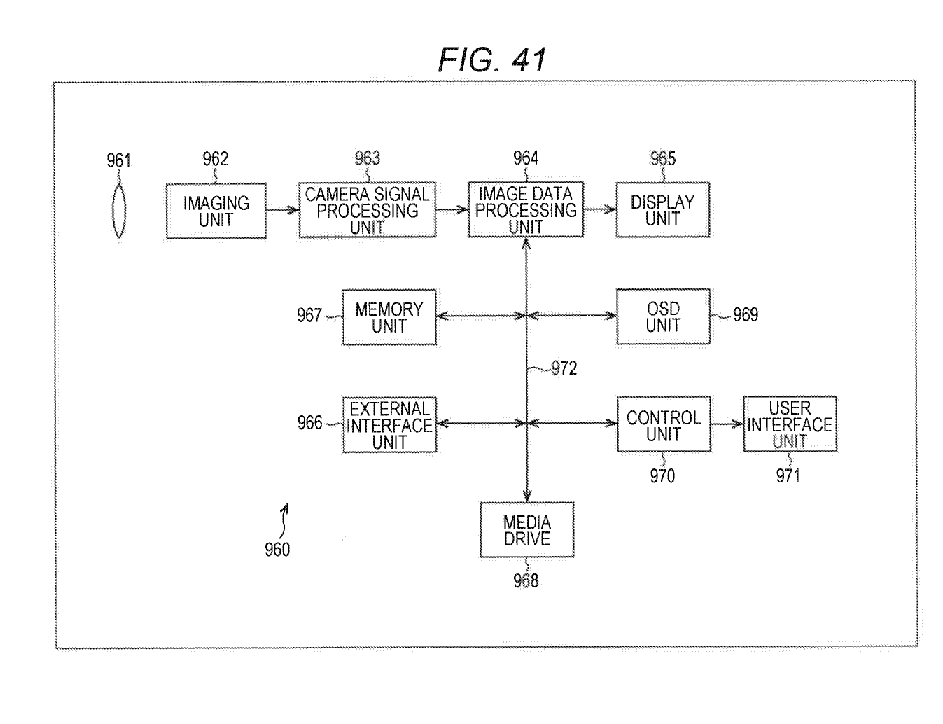

FIG. 41 illustrates a schematic configuration of an imaging device to which the present disclosure is applied. An imaging device 960 photographs a subject, and causes an image of the subject to be displayed on a display unit or records image data in a recording medium.

The imaging device 960 includes an optical block 961, an imaging unit 962, a camera signal processing unit 963, an image data processing unit 964, a display unit 965, an external I/F unit 966, a memory unit 967, a media drive 968, an OSD unit 969, and a control unit 970. Further, a user I/F unit 971 is connected to the control unit 970. Furthermore, the image data processing unit 964, the external I/F unit 966, the memory unit 967, the media drive 968, the OSD unit 969, the control unit 970, and the like are connected with one another via a bus 972.

The optical block 961 is configured with a focus lens, a diaphragm mechanism, and the like. The optical block 961 forms an optical image of a subject on an imaging plane of the imaging unit 962. The imaging unit 962 is configured with a CCD image sensor or a CMOS image sensor, and generates an electrical signal according to an optical image obtained by photoelectric conversion, and provides the electrical signal to the camera signal processing unit 963.

The camera signal processing unit 963 performs various kinds of camera signal processes such as knee correction, gamma correction, and color correction on the electrical signal provided from the imaging unit 962. The camera signal processing unit 963 provides the image data that has been subjected to the camera signal processes to the image data processing unit 964.

The image data processing unit 964 performs the encoding process of encoding the image data provided from the camera signal processing unit 963. The image data processing unit 964 provides encoded data generated by performing the encoding process to the external I/F unit 966 or the media drive 968. Further, the image data processing unit 964 performs the decoding process of decoding encoded data provided from the external I/F unit 966 or the media drive 968. The image data processing unit 964 provides image data generated by performing the decoding process to the display unit 965. Further, the image data processing unit 964 performs a process of providing the image data provided from the camera signal processing unit 963 to the display unit 965, or provides display data acquired from the OSD unit 969 to the display unit 965 to be superimposed on image data.

The OSD unit 969 generates a menu screen including a symbol, a text, or a diagram or display data such as an icon, and outputs the generated menu screen or the display data to the image data processing unit 964.

The external I/F unit 966 is configured with, for example, an USB I/O terminal or the like, and connected with a printer when an image is printed. Further, a drive is connected to the external I/F unit 966 as necessary, a removable medium such as a magnetic disk or an optical disk is appropriately mounted, and a computer program read from the removable medium is installed as necessary. Furthermore, the external I/F unit 966 includes a network interface for connecting to a certain network such as an LAN or the Internet. The control unit 970 can read encoded data from the media drive 968, for example, according to an instruction given through the user I/F unit 971 and provide the read encoded data to another device connected via a network through the external I/F unit 966. Further, the control unit 970 can acquire encoded data or image data provided from another device via a network through the external I/F unit 966 and provide the acquire encoded data or the image data to the image data processing unit 964.

As a recording media driven by the media drive 968, for example, an arbitrary readable/writable removable medium such as a magnetic disk, a magneto optical disk, an optical disk, or a semiconductor memory is used. Further, the recording medium may be a tape device, a disk, or a memory card regardless of a type of a removable medium. Of course, the recording medium may be a non-contact integrated circuit (IC) card or the like.

Further, the media drive 968 may be integrated with the recording medium to configure a non-portable storage medium such as an internal HDD or a solid state drive (SSD).

The control unit 970 is configured with a CPU. The memory unit 967 stores a program executed by the control unit 970, various kinds of data necessary when the control unit 970 performs processing, and the like. The program stored in the memory unit 967 is read and executed by the control unit 970 at a certain timing such as a timing at which the imaging device 960 is activated. The control unit 970 executes the program, and controls the respective units such that the imaging device 960 is operated according to the user's operation.

In the imaging device having the above configuration, the image data processing unit 964 is provided with the function of the encoding device and the decoding device (encoding method and decoding method) according to the present disclosure. Thus, it is possible to improve the encoding efficiency by optimizing the transform skip. Further, it is possible to decode the encoded stream in which the encoding efficiency has been improved by optimizing the transform skip.

<Applications of Scalable Coding>

(First System)

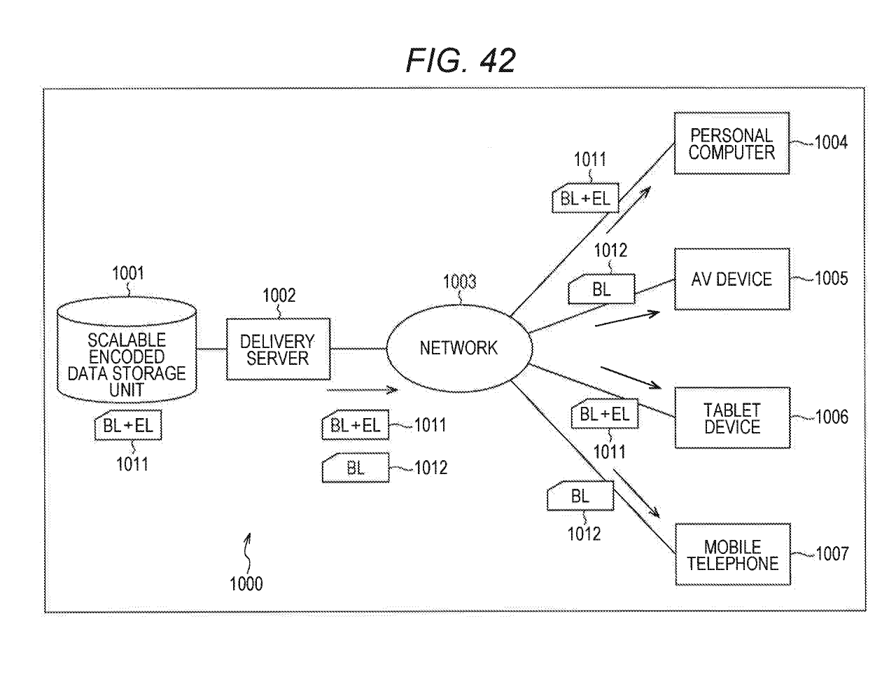

Next, specific application examples of scalable encoded data generated by scalable coding will be described. The scalable coding is used for selection of data to be transmitted, for example, as illustrated in FIG. 42.

In a data transmission system 1000 illustrated in FIG. 42, a delivery server 1002 reads scalable encoded data stored in a scalable encoded data storage unit 1001, and delivers the scalable encoded data to terminal devices such as a personal computer 1004, an AV device 1005, a tablet device 1006, and a mobile telephone 1007 via a network 1003.

At this time, the delivery server 1002 selects an appropriate high-quality encoded data according to the capabilities of the terminal devices or a communication environment, and transmits the selected high-quality encoded data. Although the delivery server 1002 transmits unnecessarily high-quality data, the terminal devices do not necessarily obtains a high-quality image, and a delay or an overflow may occur. Further, a communication band may be unnecessarily occupied, and a load of a terminal device may be unnecessarily increased. On the other hand, although the delivery server 1002 transmits unnecessarily low-quality data, the terminal devices are unlikely to obtain an image of a sufficient quality. Thus, the delivery server 1002 reads scalable encoded data stored in the scalable encoded data storage unit 1001 as encoded data of a quality appropriate for the capability of the terminal device or a communication environment, and then transmits the read data.

For example, the scalable encoded data storage unit 1001 is assumed to store scalable encoded data (BL+EL) 1011 that is encoded by the scalable coding. The scalable encoded data (BL+EL) 1011 is encoded data including both of a base layer and an enhancement layer, and both an image of the base layer and an image of the enhancement layer can be obtained by decoding the scalable encoded data (BL+EL) 1011.

The delivery server 1002 selects an appropriate layer according to the capability of a terminal device to which data is transmitted or a communication environment, and reads data of the selected layer. For example, for the personal computer 1004 or the tablet device 1006 having a high processing capability, the delivery server 1002 reads the high-quality scalable encoded data (BL+EL) 1011 from the scalable encoded data storage unit 1001, and transmits the scalable encoded data (BL+EL) 1011 without change. On the other hand, for example, for the AV device 1005 or the mobile telephone 1007 having a low processing capability, the delivery server 1002 extracts data of the base layer from the scalable encoded data (BL+EL) 1011, and transmits a scalable encoded data (BL) 1012 that is the same content as the scalable encoded data (BL+EL) 1011 but lower in quality than the scalable encoded data (BL+EL) 1011.

As described above, an amount of data can be easily adjusted using scalable encoded data, and thus it is possible to prevent the occurrence of a delay or an overflow and prevent a load of a terminal device or a communication medium from being unnecessarily increased. Further, the scalable encoded data (BL+EL) 1011 is reduced in redundancy between layers, and thus it is possible to reduce an amount of data to be smaller than when individual data is used as encoded data of each layer. Thus, it is possible to more efficiently use a memory area of the scalable encoded data storage unit 1001.

Further, various devices such as the personal computer 1004 to the mobile telephone 1007 can be applied as the terminal device, and thus the hardware performance of the terminal devices differs according to each device. Further, since various applications can be executed by the terminal devices, software has various capabilities. Furthermore, all communication line networks including either or both of a wired network and a wireless network such as the Internet or a LAN, can be applied as the network 1003 serving as a communication medium, and thus various data transmission capabilities are provided. In addition, a change may be made by another communication or the like.

In this regard, the delivery server 1002 may be configured to perform communication with a terminal device serving as a transmission destination of data before starting data transmission and obtain information related to a capability of a terminal device such as hardware performance of a terminal device or a performance of an application (software) executed by a terminal device and information related to a communication environment such as an available bandwidth of the network 1003. Then, the delivery server 1002 may select an appropriate layer based on the obtained information.

Further, the extracting of the layer may be performed in a terminal device. For example, the personal computer 1004 may decode the transmitted scalable encoded data (BL+EL) 1011 and display the image of the base layer or the image of the enhancement layer. Further, for example, the personal computer 1004 may extract the scalable encoded data (BL) 1012 of the base layer from the transmitted scalable encoded data (BL+EL) 1011, store the scalable encoded data (BL) 1012 of the base layer, transfer the scalable encoded data (BL) 1012 of the base layer to another device, decode the scalable encoded data (BL) 1012 of the base layer, and display the image of the base layer.

Of course, the number of the scalable encoded data storage units 1001, the number of the delivery servers 1002, the number of the networks 1003, and the number of terminal devices are arbitrary. The above description has been made in connection with the example in which the delivery server 1002 transmits data to the terminal devices, but the application example is not limited to this example. The data transmission system 1000 can be applied to any system in which when encoded data generated by the scalable coding is transmitted to a terminal device, an appropriate layer is selected according to a capability of a terminal devices or a communication environment, and the encoded data is transmitted.

(Second System)

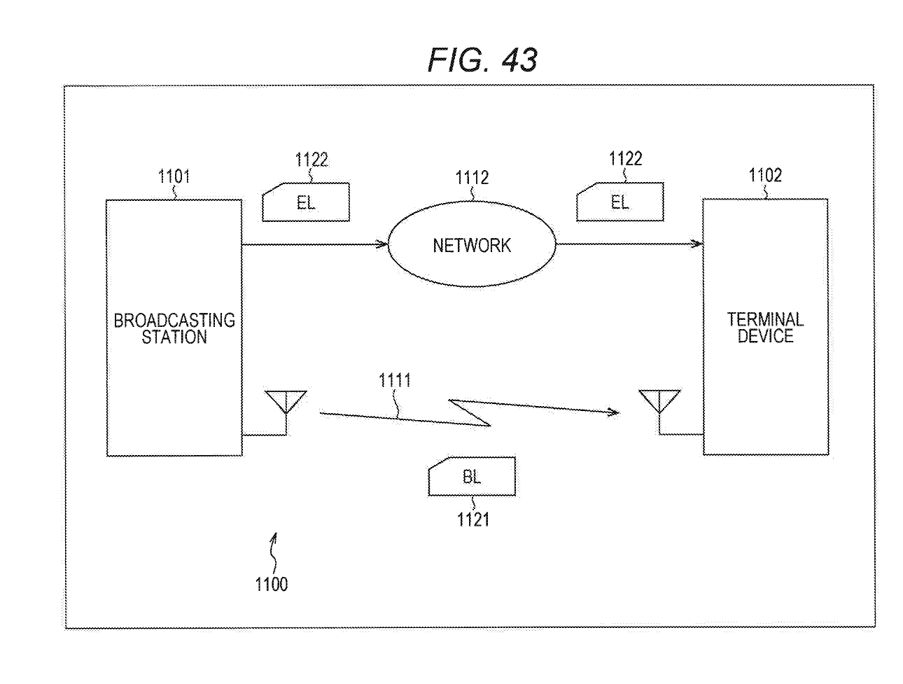

The scalable coding is used for transmission using a plurality of communication media, for example, as illustrated in FIG. 43.

In a data transmission system 1100 illustrated in FIG. 43, a broadcasting station 1101 transmits scalable encoded data (BL) 1121 of abase layer through terrestrial broadcasting 1111. Further, the broadcasting station 1101 transmits scalable encoded data (EL) 1122 of an enhancement layer (for example, packetizes the scalable encoded data (EL) 1.122 and then transmits resultant packets) via an arbitrary network 1112 configured with a communication network including either or both of a wired network and a wireless network.

A terminal device 1102 has a reception function of receiving the terrestrial broadcasting 1111 broadcast by the broadcasting station 1101, and receives the scalable encoded data (BL) 1121 of the base layer transmitted through the terrestrial broadcasting 1111. The terminal device 1102 further has a communication function of performing communication via the network 1112, and receives the scalable encoded data (EL) 1122 of the enhancement layer transmitted via the network 1112.

The terminal device 1102 decodes the scalable encoded data (BL) 1121 of the base layer acquired through the terrestrial broadcasting 1111, for example, according to the user's instruction or the like, obtains the image of the base layer, stores the obtained image, and transmits the obtained image to another device.

Further, the terminal device 1102 combines the scalable encoded data (BL) 1121 of the base layer acquired through the terrestrial broadcasting 1111 with the scalable encoded data (EL) 1122 of the enhancement layer acquired through the network 1112, for example, according to the user's instruction or the like, obtains the scalable encoded data (BL+EL), decodes the scalable encoded data (BL+EL) to obtain the image of the enhancement layer, stores the obtained image, and transmits the obtained image to another device.

As described above, it is possible to transmit scalable encoded data of respective layers, for example, through different communication media. Thus, it is possible to distribute a load, and it is possible to prevent the occurrence of a delay or an overflow.

Further, it is possible to select a communication medium used for transmission for each layer according to the situation. For example, the scalable encoded data (BL) 1121 of the base layer having a relative large amount of data may be transmitted through a communication medium having a large bandwidth, and the scalable encoded data (EL) 1122 of the enhancement layer having a relative small amount of data may be transmitted through a communication medium having a small bandwidth. Further, for example, a communication medium for transmitting the scalable encoded data (EL) 1122 of the enhancement layer may be switched between the network 1112 and the terrestrial broadcasting 1111 according to an available bandwidth of the network 1112. Of course, the same applies to data of an arbitrary layer.

As control is performed as described above, it is possible to further suppress an increase in a load in data transmission.

Of course, the number of layers is an arbitrary, and the number of communication media used for transmission is also arbitrary. Further, the number of the terminal devices 1102 serving as a data delivery destination is also arbitrary. The above description has been described in connection with the example of broadcasting from the broadcasting station 1101, and the application example is not limited to this example. The data transmission system 1100 can be applied to any system in which encoded data generated by the scalable coding is divided into two or more in units of layers and transmitted through a plurality of lines.

(Third System)

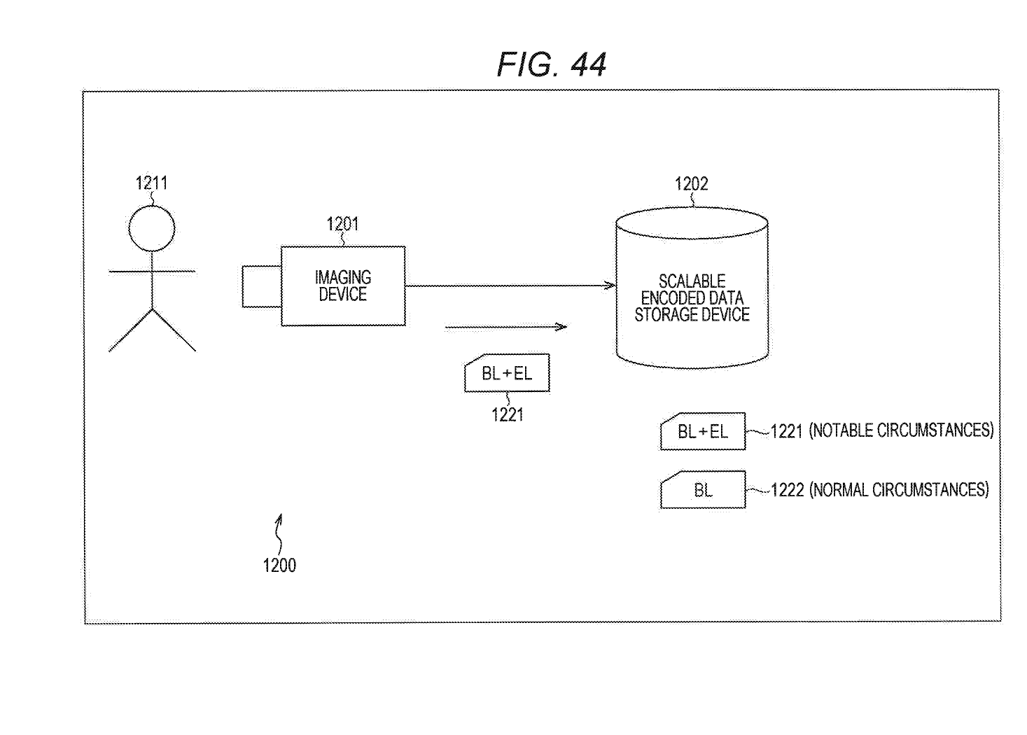

The scalable coding is used for storage of encoded data, for example, as illustrated in FIG. 44.

In an imaging system 1200 illustrated in FIG. 44, an imaging device 1201 photographs a subject 1211, performs the scalable coding on obtained image data, and provides scalable encoded data (BL+EL) 1221 to a scalable encoded data storage device 1202.

The scalable encoded data storage device 1202 stores the scalable encoded data (BL+EL) 1221 provided from the imaging device 1201 in a quality according to the situation. For example, during a normal time, the scalable encoded data storage device 1202 extracts data of the base layer from the scalable encoded data (BL+EL) 1221, and stores the extracted data as scalable encoded data (BL) 1222 of the base layer having a small amount of data in a low quality. On the other hand, for example, during an observation time, the scalable encoded data storage device 1202 stores the scalable encoded data (BL+EL) 1221 having a large amount of data in a high quality without change.

Accordingly, the scalable encoded data storage device 1202 can store an image in a high quality only when necessary, and thus it is possible to suppress an increase in an amount of data and improve use efficiency of a memory area while suppressing a reduction in a value of an image caused by quality deterioration.

For example, the imaging device 1201 is a monitoring camera. When monitoring target (for example, intruder) is not shown on a photographed image (during a normal time), content of the photographed image is likely to be inconsequential, and thus a reduction in an amount of data is prioritized, and image data (scalable encoded data) is stored in a low quality. On the other hand, when a monitoring target is shown on a photographed image as the subject 1211 (during an observation time), content of the photographed image is likely to be consequential, and thus an image quality is prioritized, and image data (scalable encoded data) is stored in a high quality.

It may be determined whether it is the normal time or the observation time, for example, by analyzing an image through the scalable encoded data storage device 1202. Further, the imaging device 1201 may perform the determination and transmits the determination result to the scalable encoded data storage device 1202.

Further, a determination criterion as to whether it is the normal time or the observation time is arbitrary, and content of an image serving as the determination criterion is arbitrary. Of course, a condition other than content of an image may be a determination criterion. For example, switching may be performed according to the magnitude or a waveform of a recorded sound, switching may be performed at certain time intervals, or switching may be performed according an external instruction such as the user's instruction.

The above description has been described in connection with the example in which switching is performed between two states of the normal time and the observation time, but the number of states is arbitrary. For example, switching may be performed among three or more states such as a normal time, a low-level observation time, an observation time, a high-level observation time, and the like. Here, an upper limit number of states to be switched depends on the number of layers of scalable encoded data.

Further, the imaging device 1201 may decide the number of layers for the scalable coding according to a state. For example, during the normal time, the imaging device 1201 may generate the scalable encoded data (BL) 1222 of the base layer having a small amount of data in a low quality and provide the scalable encoded data (BL) 1222 of the base layer to the scalable encoded data storage device 1202. Further, for example, during the observation time, the imaging device 1201 may generate the scalable encoded data (BL+EL) 1221 of the base layer having a large amount of data in a high quality and provide the scalable encoded data (BL+EL) 1221 of the base layer to the scalable encoded data storage device 1202.

The above description has been made in connection with the example of a monitoring camera, but the purpose of the imaging system 1200 is arbitrary and not limited to a monitoring camera.

### Tenth Embodiment

### Other Embodiments

The above embodiments have been described in connection with the example of the device, the system, or the like according to the present disclosure, but the present disclosure is not limited to the above examples and may be implemented as any component mounted in the device or the device configuring the system, for example, a processor serving as a system large scale integration (LSI) or the like, a module using a plurality of processors or the like, a unit using a plurality of modules or the like, a set (that is, some components of the device) in which any other function is further added to a unit, or the like.

(Exemplary Configuration of Video Set)

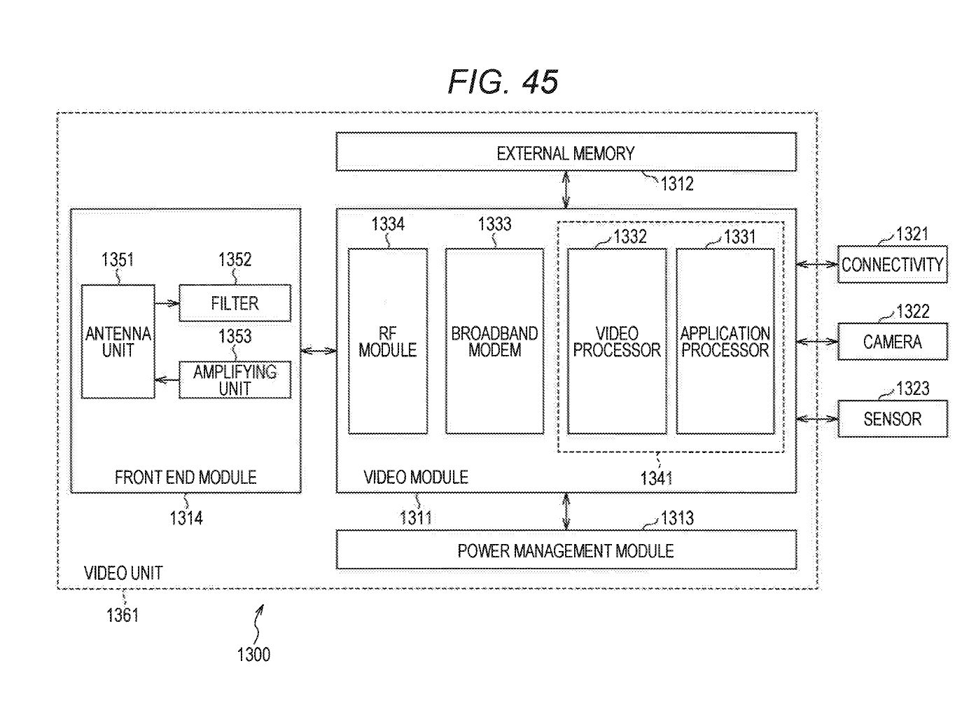

An example in which the present disclosure is implemented as a set will be described with reference to FIG. 45. FIG. 45 illustrates an exemplary schematic configuration of a video set to which the present disclosure is applied.

In recent years, functions of electronic devices have become diverse, and when some components are implemented as sale, provision, or the like in development or manufacturing, there are many cases in which a plurality of components having relevant functions are combined and implemented as a set having a plurality of functions as well as cases in which an implementation is performed as a component having a single function.

A video set 1300 illustrated in FIG. 45 is a multi-functionalized configuration in which a device having a function related to image encoding and/or image decoding is combined with a device having any other function related to the function.

As illustrated in FIG. 45, the video set 1300 includes a module group such as a video module 1311, an external memory 1312, a power management module 1313, and a front end module 1314 and a device having relevant functions such as a connectivity 1321, a camera 1322, and a sensor 1323.

A module is a part having multiple functions into which several relevant part functions are integrated. A specific physical configuration is arbitrary, but, for example, it is configured such that a plurality of processes having respective functions, electronic circuit elements such as a resistor and a capacitor, and other devices are arranged and integrated on a wiring substrate. Further, a new module may be obtained by combining another module or a processor with a module.

In the case of the example of FIG. 45, the video module 1311 is a combination of components having functions related to image processing, and includes an application processor, a video processor, a broadband modem 1333, and a radio frequency (RF) module 1334.

A processor is one in which a configuration having a certain function is integrated into a semiconductor chip through System On a Chip (SoC), and also refers to, for example, a system LSI or the like. The configuration having the certain function may be a logic circuit (hardware configuration), may be a CPU, a ROM, a RAM, and a program (software configuration) executed using the CPU, the ROM, and the RAM, and may be a combination of a hardware configuration and a software configuration. For example, a processor may include a logic circuit, a CPU, a ROM, a RAM, and the like, some functions may be implemented through the logic circuit (hardware configuration), and the other functions may be implemented through a program (software configuration) executed by the CPU.

The application processor 1331 of FIG. 45 is a processor that executes an application related to image processing. An application executed by the application processor 1331 can not only perform a calculation process but also control components inside and outside the video module 1311 such as the video processor 1332 as necessary in order to implement a certain function.

The video processor 1332 is a processor having a function related to image encoding and/or image decoding.

The broadband modem 1333 is a processor (or module) that performs a process related to wired and/or wireless broadband communication that is performed via broadband line such as the Internet or a public telephone line network. For example, the broadband modem 1333 converts data (digital signal) to be transmitted into an analog signal, for example, through digital modulation, demodulates a received analog signal, and converts the analog signal into data (digital signal). For example, the broadband modem 1333 can perform digital modulation and demodulation on arbitrary information such as image data processed by the video processor 1332, a stream in which image data is encoded, an application program, or setting data.

The RF module 1334 is a module that performs a frequency transform process, a modulation/demodulation process, an amplification process, a filtering process, and the like on an RF signal transceived through an antenna. For example, the RF module 1334 performs, for example, frequency transform on a baseband signal generated by the broadband modem 1333, and generates an RF signal. Further, for example, the RF module 1334 performs, for example, frequency transform on an RF signal received through the front end module 1314, and generates a baseband signal.

Further, a dotted line 1341, that is, the application processor 1331 and the video processor 1332 may be integrated into a single processor as illustrated in FIG. 45.

The external memory 1312 is installed outside the video module 1311, and a module having a storage device used by the video module 1311. The storage device of the external memory 1312 can be implemented by any physical configuration, but is commonly used to store large capacity data such as image data of frame units, and thus it is desirable to implement the storage device of the external memory 1312 using a relatively cheap large-capacity semiconductor memory such as a dynamic random access memory (DRAM).

The power management module 1313 manages and controls power supply to the video module 1311 (the respective components in the video module 1311).

The front end module 1314 is a module that provides a front end function (a circuit of a transceiving end at an antenna side) to the RF module 1334. As illustrated in FIG. 45, the front end module 1314 includes, for example, an antenna unit 1351, a filter 1352, and an amplifying unit 1353.

The antenna unit 1351 includes an antenna that transceives a radio signal and a peripheral configuration. The antenna unit 1351 transmits a signal provided from the amplifying unit 1353 as a radio signal, and provides a received radio signal to the filter 1352 as an electrical signal (RF signal). The filter 1352 performs, for example, a filtering process on an RF signal received through the antenna unit 1351, and provides a processed RF signal to the RF module 1334. The amplifying unit 1353 amplifies the RF signal provided from the RF module 1334, and provides the amplified RF signal to the antenna unit 1351.

The connectivity 1321 is a module having a function related to a connection with the outside. A physical configuration of the connectivity 1321 is arbitrary. For example, the connectivity 1321 includes a configuration having a communication function other than a communication standard supported by the broadband modem 1333, an external I/O terminal, or the like.

For example, the connectivity 1321 may include a module having a communication function based on a wireless communication standard such as Bluetooth (registered trademark), IEEE 802.11 (for example, Wireless Fidelity (Wi-Fi)™), Near Field Communication (NFC), InfraRed Data Association (IrDA), an antenna that transceives a signal satisfying the standard, or the like. Further, for example, the connectivity 1321 may include a module having a communication function based on a wired communication standard such as Universal Serial Bus (USB), or High-Definition Multimedia Interface (HDMI) (registered trademark) or a terminal that satisfies the standard. Furthermore, for example, the connectivity 1321 may include any other data (signal) transmission function or the like such as an analog I/O terminal.

Further, the connectivity 1321 may include a device of a transmission destination of data (signal). For example, the connectivity 1321 may include a drive (including a hard disk, an SSD, a Network Attached Storage (NAS), or the like as well as a drive of a removable medium) that reads/writes data from/in a recording medium such as a magnetic disk, an optical disk, a magneto optical disk, or a semiconductor memory. Furthermore, the connectivity 1321 may include an output device (a monitor, a speaker, or the like) that outputs an image or a sound.

The camera 1322 is a module having a function of photographing a subject and obtaining image data of the subject. For example, image data obtained by the photographing of the camera 1322 is provided to and encoded by the video processor 1332.

The sensor 1323 is a module having an arbitrary sensor function such as a sound sensor, an ultrasonic sensor, an optical sensor, an illuminance sensor, an infrared sensor, an image sensor, a rotation sensor, an angle sensor, an angular velocity sensor, a velocity sensor, an acceleration sensor, an inclination sensor, a magnetic identification sensor, a shock sensor, or a temperature sensor. For example, data detected by the sensor 1323 is provided to the application processor 1331 and used by an application or the like.

A configuration described above as a module may be implemented as a processor, and a configuration described as a processor may be implemented as a module.

In the video set 1300 having the above configuration, the present disclosure can be applied to the video processor 1332 as will be described later. Thus, the video set 1300 can be implemented as a set to which the present disclosure is applied.

(Exemplary Configuration of Video Processor)

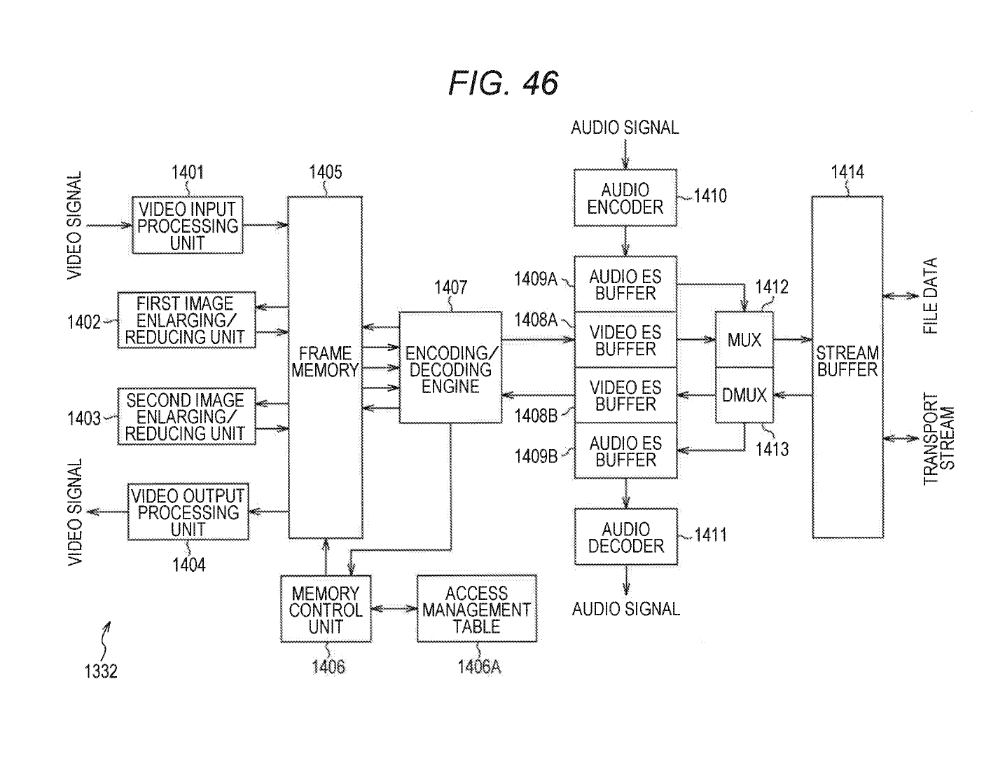

FIG. 46 illustrates an exemplary schematic configuration of the video processor 1332 (FIG. 45) to which the present disclosure is applied.

In the case of the example of FIG. 46, the video processor 1332 has a function of receiving an input of a video signal and an audio signal and encoding the video signal and the audio signal according to a certain scheme and a function of decoding encoded video data and audio data, and reproducing and outputting a video signal and an audio signal.

The video processor 1332 includes a video input processing unit 1401, a first image enlarging/reducing unit 1402, a second image enlarging/reducing unit 1403, a video output processing unit 1404, a frame memory 1405, and a memory control unit 1406 as illustrated in FIG. 46. The video processor 1332 further includes an encoding/decoding engine 1407, video elementary stream (ES) buffers 1408A and 1408B, and audio ES buffers 1409A and 1409B. The video processor 1332 further includes an audio encoder 1410, an audio decoder 1411, a multiplexer (multiplexer (MUX)) 1412, a demultiplexer (demultiplexer (DMUX)) 1413, and a stream buffer 1414.

For example, the video input processing unit 1401 acquires a video signal input from the connectivity 1321 (FIG. 45) or the like, and converts the video signal into digital image data. The first image enlarging/reducing unit 1402 performs, for example, a format conversion process and an image enlargement/reduction process on the image data. The second image enlarging/reducing unit 1403 performs an image enlargement/reduction process on the image data according to a format of a destination to which the image data is output through the video output processing unit 1404 or performs the format conversion process and the image enlargement/reduction process which are identical to those of the first image enlarging/reducing unit 1402 on the image data. The video output processing unit 1404 performs format conversion and conversion into an analog signal on the image data, and outputs a reproduced video signal to, for example, the connectivity 1321 (FIG. 45) or the like.

The frame memory 1405 is an image data memory that is shared by the video input processing unit 1401, the first image enlarging/reducing unit 1402, the second image enlarging/reducing unit 1403, the video output processing unit 1404, and the encoding/decoding engine 1407. The frame memory 1405 is implemented as, for example, a semiconductor memory such as a DRAM.

The memory control unit 1406 receives a synchronous signal from the encoding/decoding engine 1407, and controls writing/reading access to the frame memory 1405 according to an access schedule for the frame memory 1405 written in an access management table 1406A. The access management table 1406A is updated through the memory control unit 1406 according to processing executed by the encoding/decoding engine 1407, the first image enlarging/reducing unit 1402, the second image enlarging/reducing unit 1403, or the like.

The encoding/decoding engine 1407 performs an encoding process of encoding image data and a decoding process of decoding a video stream that is data obtained by encoding image data. For example, the encoding/decoding engine 1407 encodes image data read from the frame memory 1405, and sequentially writes the encoded image data in the video ES buffer 1408A as a video stream. Further, for example, the encoding/decoding engine 1407 sequentially reads the video stream from the video ES buffer 1408B, sequentially decodes the video stream, and sequentially writes the decoded image data in the frame memory 1405. The encoding/decoding engine 1407 uses the frame memory 1405 as a working area at the time of the encoding or the decoding. Further, the encoding/decoding engine 1407 outputs the synchronous signal to the memory control unit 1406, for example, at a timing at which processing of each macroblock starts.

The video ES buffer 1408A buffers the video stream generated by the encoding/decoding engine 1407, and then provides the video stream to the multiplexer (MUX) 1412. The video ES buffer 1408B buffers the video stream provided from the demultiplexer (DMUX) 1413, and then provides the video stream to the encoding/decoding engine 1407.

The audio ES buffer 1409A buffers an audio stream generated by the audio encoder 1410, and then provides the audio stream to the multiplexer (MUX) 1412. The audio ES buffer 1409B buffers an audio stream provided from the demultiplexer (DMUX) 1413, and then provides the audio stream to the audio decoder 1411.

For example, the audio encoder 1410 converts an audio signal input from, for example, the connectivity 1321 (FIG. 45) or the like into a digital signal, and encodes the digital signal according to a certain scheme such as an MPEG audio scheme or an Audio Code number 3 (AC3) scheme. The audio encoder 1410 sequentially writes the audio stream that is data obtained by encoding the audio signal in the audio ES buffer 1409A. The audio decoder 1411 decodes the audio stream provided from the audio ES buffer 1409B, performs, for example, conversion into an analog signal, and provides a reproduced audio signal to, for example, the connectivity 1321 (FIG. 45) or the like.

The multiplexer (MUX) 1412 performs multiplexing of the video stream and the audio stream. A multiplexing method (that is, a format of a bitstream generated by multiplexing) is arbitrary. Further, at the time of multiplexing, the multiplexer (MUX) 1412 may add certain header information or the like to the bitstream. In other words, the multiplexer (MUX) 1412 may convert a stream format by multiplexing. For example, the multiplexer (MUX) 1412 multiplexes the video stream and the audio stream to be converted into a transport stream that is a bitstream of a transfer format. Further, for example, the multiplexer (MUX) 1412 multiplexes the video stream and the audio stream to be converted into data (file data) of a recording file format.

The demultiplexer (DMUX) 1413 demultiplexes the bitstream obtained by multiplexing the video stream and the audio stream by a method corresponding to the multiplexing performed by the multiplexer (MUX) 1412. In other words, the demultiplexer (DMUX) 1413 extracts the video stream and the audio stream (separates the video stream and the audio stream) from the bitstream read from the stream buffer 1414. In other words, the demultiplexer (DMUX) 1413 can perform conversion (inverse conversion of conversion performed by the multiplexer (MUX) 1412) of a format of a stream through the demultiplexing. For example, the demultiplexer (DMUX) 1413 can acquire the transport stream provided from, for example, the connectivity 1321 or the broadband modem 1333 (both FIG. 45) through the stream buffer 1414 and convert the transport stream into a video stream and an audio stream through the demultiplexing. Further, for example, the demultiplexer (DMUX) 1413 can acquire file data read from various kinds of recording media (FIG. 45) by, for example, the connectivity 1321 through the stream buffer 1414 and converts the file data into a video stream and an audio stream by the demuitiplexing.

The stream buffer 1414 buffers the bitstream. For example, the stream buffer 1414 buffers the transport stream provided from the multiplexer (MUX) 1412, and provides the transport stream to, for example, the connectivity 1321 or the broadband modem 1333 (both FIG. 45) at a certain timing or based on an external request or the like.

Further, for example, the stream buffer 1414 buffers file data provided from the multiplexer (MUX) 1412, provides the file data to, for example, the connectivity 1321 (FIG. 45) or the like at a certain timing or based on an external request or the like, and causes the file data to be recorded in various kinds of recording media.

Furthermore, the stream buffer 1414 buffers the transport stream acquired through, for example, the connectivity 1321 or the broadband modem 1333 (both FIG. 45), and provides the transport stream to the demultiplexer (DMUX) 1413 at a certain timing or based on an external request or the like.

Further, the stream buffer 1414 buffers file data read from various kinds of recording media in, for example, the connectivity 1321 (FIG. 45) or the like, and provides the file data to the demultiplexer (DMUX) 1413 at a certain timing or based on an external request or the like.

Next, an operation of the video processor 1332 having the above configuration will be described. The video signal input to the video processor 1332 from, for example, the connectivity 1321 (FIG. 45) or the like is converted into digital image data according to a certain scheme such as a 4:2:2Y/Cb/Cr scheme in the video input processing unit 1401 and sequentially written in the frame memory 1405. The digital image data is read out to the first image enlarging/reducing unit 1402 or the second image enlarging/reducing unit 1403, subjected to a format conversion process of performing a format conversion into a certain scheme such as a 4:2:0Y/Cb/Cr scheme and an enlargement/reduction process, and written in the frame memory 1405 again. The image data is encoded by the encoding/decoding engine 1407, and written in the video ES buffer 1408A as a video stream.

Further, an audio signal input to the video processor 1332 from the connectivity 1321 (FIG. 45) or the like is encoded by the audio encoder 1410, and written in the audio ES buffer 1409A as an audio stream.

The video stream of the video ES buffer 1408A and the audio stream of the audio ES buffer 1409A are read out to and multiplexed by the multiplexer (MUX) 1412, and converted into a transport stream, file data, or the like. The transport stream generated by the multiplexer (MUX) 1412 is buffered in the stream buffer 1414, and then output to an external network through, for example, the connectivity 1321 or the broadband modem 1333 (both FIG. 45). Further, the file data generated by the multiplexer (MUX) 1412 is buffered in the stream buffer 1414, then output to, for example, the connectivity 1321 (FIG. 45) or the like, and recorded in various kinds of recording media.

Further, the transport stream input to the video processor 1332 from an external network through, for example, the connectivity 1321 or the broadband modem 1333 (both FIG. 45) is buffered in the stream buffer 1414 and then demultiplexed by the demultiplexer (DMUX) 1413. Further, the file data that is read from various kinds of recording media in, for example, the connectivity 1321 (FIG. 45) or the like and then input to the video processor 1332 is buffered in the stream buffer 1414 and then demultiplexed by the demultiplexer (DMUX) 1413. In other words, the transport stream or the file data input to the video processor 1332 is demultiplexed into the video stream and the audio stream through the demultiplexer (DMUX) 1413.

The audio stream is provided to the audio decoder 1411 through the audio ES buffer 1409B and decoded, and so an audio signal is reproduced. Further, the video stream is written in the video ES buffer 1408B, sequentially read out to and decoded by the encoding/decoding engine 1407, and written in the frame memory 1405. The decoded image data is subjected to the enlargement/reduction process performed by the second image enlarging/reducing unit 1403, and written in the frame memory 1405. Then, the decoded image data is read out to the video output processing unit 1404, subjected to the format conversion process of performing format conversion to a certain scheme such as a 4:2:2Y/Cb/Cr scheme, and converted into an analog signal, and so a video signal is reproduced.

When the present disclosure is applied to the video processor 1332 having the above configuration, it is preferable that the above embodiments of the present disclosure be applied to the encoding/decoding engine 1407. In other words, for example, the encoding/decoding engine 1407 preferably has the function of the encoding device or the decoding device according to the first embodiment. Accordingly, the video processor 1332 can obtain the same effects as the effects described above with reference to FIGS. 1 to 20.

Further, in the encoding/decoding engine 1407, the present disclosure (that is, the functions of the image encoding devices or the image decoding devices according to the above embodiment) may be implemented by either or both of hardware such as a logic circuit or software such as an embedded program.

(Another Exemplary Configuration of Video Processor)

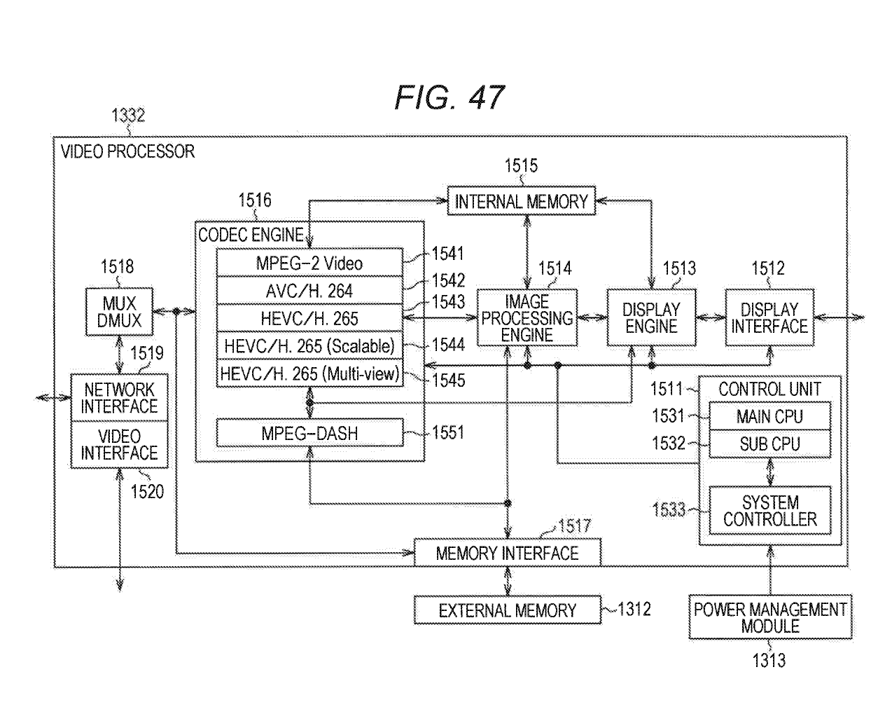

FIG. 47 illustrates another exemplary schematic configuration of the video processor 1332 (FIG. 45) to which the present disclosure is applied. In the case of the example of FIG. 47, the video processor 1332 has a function of encoding and decoding video data according to a certain scheme.

More specifically, the video processor 1332 includes a control unit 1511, a display interface 1512, a display engine 1513, an image processing engine 1514, and an internal memory 1515 as illustrated in FIG. 47. The video processor 1332 further includes a codec engine 1516, a memory interface 1517, a multiplexing/demultiplexing unit (MUX DMUX) 1518, a network interface 1519, and a video interface 1520.

The control unit 1511 controls an operation of each processing unit in the video processor 1332 such as the display interface 1512, the display engine 1513, the image processing engine 1514, and the codec engine 1516.

The control unit 1511 includes, for example, a main CPU 1531, a sub CPU 1532, and a system controller 1533 as illustrated in FIG. 47. The main CPU 1531 executes, for example, a program for controlling an operation of each processing unit in the video processor 1332. The main CPU 1531 generates a control signal, for example, according to the program, and provides the control signal to each processing unit (that is, controls an operation of each processing unit). The sub CPU 1532 plays a supplementary role of the main CPU 1531. For example, the sub CPU 1532 executes a child process or a subroutine of a program executed by the main CPU 1531. The system controller 1533 controls operations of the main CPU 1531 and the sub CPU 1532, for example, designates a program executed by the main CPU 1531 and the sub CPU 1532.

The display interface 1512 outputs image data to, for example, the connectivity 1321 (FIG. 45) or the like under control of the control unit 1511. For example, the display interface 1512 converts image data of digital data into an analog signal, and outputs the analog signal to, for example, the monitor device of the connectivity 1321 (FIG. 45) as a reproduced video signal or outputs the image data of the digital data to, for example, the monitor device of the connectivity 1321 (FIG. 45).

The display engine 1513 performs various kinds of conversion processes such as a format conversion process, a size conversion process, and a color gamut conversion process on the image data under control of the control unit 1511 to comply with, for example, a hardware specification of the monitor device that displays the image.

The image processing engine 1514 performs certain image processing such as a filtering process for improving an image quality on the image data under control of the control unit 1511.

The internal memory 1515 is a memory that is installed in the video processor 1332 and shared by the display engine 1513, the image processing engine 1514, and the codec engine 1516. The internal memory 1515 is used for data transfer performed among, for example, the display engine 1513, the image processing engine 1514, and the codec engine 1516. For example, the internal memory 1515 stores data provided from the display engine 1513, the image processing engine 1514, or the codec engine 1516, and provides the data to the display engine 1513, the image processing engine 1514, or the codec engine 1516 as necessary (for example, according to a request). The internal memory 1515 can be implemented by any storage device, but since the internal memory 1515 is mostly used for storage of small-capacity data such as image data of block units or parameters, it is desirable to implement the internal memory 1515 using a semiconductor memory that is relatively small in capacity (for example, compared to the external memory 1312) and fast in response speed such as a static random access memory (SRAM).

The codec engine 1516 performs processing related to encoding and decoding of image data. An encoding/decoding scheme supported by the codec engine 1516 is arbitrary, and one or more schemes may be supported by the codec engine 1516. For example, the codec engine 1516 may have a codec function of supporting a plurality of encoding/decoding schemes and perform encoding of image data or decoding of encoded data using a scheme selected from among the schemes.

In the example illustrated in FIG. 47, the codec engine 1516 includes, for example, an MPEG-2 Video 1541, an AVC/H.264 1542, a HEVC/H.265 1543, a HEVC/H.265 (Scalable) 1544, a HEVC/H.265 (Multi-view) 1545, and an MPEG-DASH 1551 as functional blocks of processing related to a codec.

The MPEG-2 Video 1541 is a functional block of encoding or decoding image data according to an MPEG-2 scheme. The AVC/H.264 1542 is a functional block of encoding or decoding image data according to an AVC scheme. The HEVC/H.265 1543 is a functional block of encoding or decoding image data according to a HEVC scheme. The HEVC/H.265 (Scalable) 1544 is a functional block of performing scalable encoding or scalable decoding on image data according to a HEVC scheme. The HEVC/H.265 (Multi-view) 1545 is a functional block of performing multi-view encoding or multi-view decoding on image data according to a HEVC scheme.

The MPEG-DASH 1551 is a functional block of transmitting and receiving image data according to an MPEG-Dynamic Adaptive Streaming over HTTP (MPEG-DASH). The MPEG-DASH is a technique of streaming a video using a HyperText Transfer Protocol (HTTP), and has a feature of selecting appropriate one from among a plurality of pieces of encoded data that differ in a previously prepared resolution or the like in units of segments and transmitting a selected one. The MPEG-DASH 1551 performs generation of a stream complying with a standard, transmission control of the stream, and the like, and uses the MPEG-2 Video 1541 to the HEVC/H.265 (Multi-view) 1545 for encoding and decoding of image data.

The memory interface 1517 is an interface for the external memory 1312. Data provided from the image processing engine 1514 or the codec engine 1516 is provided to the external memory 1312 through the memory interface 1517. Further, data read from the external memory 1312 is provided to the video processor 1332 (the image processing engine 1514 or the codec engine 1516) through the memory interface 1517.

The multiplexing/demultiplexing unit (MUX DMUX) 1518 performs multiplexing and demultiplexing of various kinds of data related to an image such as a bitstream of encoded data, image data, and a video signal. The multiplexing/demultiplexing method is arbitrary. For example, at the time of multiplexing, the multiplexing/demultiplexing unit (MUX DMUX) 1518 can not only combine a plurality of data into one but also add certain header information or the like to the data. Further, at the time of demultiplexing, the multiplexing/demultiplexing unit (MUX DMUX) 1518 can not only divide one data into a plurality of data but also add certain header information or the like to each divided data. In other words, the multiplexing/demultiplexing unit (MUX DMUX) 1518 can converts a data format through multiplexing and demultiplexing. For example, the multiplexing/demultiplexing unit (MUX DMUX) 1518 can multiplex a bitstream to be converted into a transport stream serving as a bitstream of a transfer format or data (file data) of a recording file format. Of course, inverse conversion can be also performed through demultiplexing.

The network interface 1519 is an interface for, for example, the broadband modem 1333 or the connectivity 1321 (both FIG. 45). The video interface 1520 is an interface for, for example, the connectivity 1321 or the camera 1322 (both FIG. 45).

Next, an exemplary operation of the video processor 1332 will be described. For example, when the transport stream is received from the external network through, for example, the connectivity 1321 or the broadband modem 1333 (both FIG. 45), the transport stream is provided to the multiplexing/demultiplexing unit (MUX DMUX) 1518 through the network interface 1519, demultiplexed, and then decoded by the codec engine 1516. Image data obtained by the decoding of the codec engine 1516 is subjected to certain image processing performed, for example, by the image processing engine 1514, subjected to certain conversion performed by the display engine 1513, and provided to, for example, the connectivity 1321 (FIG. 45) or the like through the display interface 1512, and so the image is displayed on the monitor. Further, for example, image data obtained by the decoding of the codec engine 1516 is encoded by the codec engine 1516 again, multiplexed by the multiplexing/demultiplexing unit (MUX DMUX) 1518 to be converted into file data, output to, for example, the connectivity 1321 (FIG. 45) or the like through the video interface 1520, and then recorded in various kinds of recording media.

Furthermore, for example, file data of encoded data obtained by encoding image data read from a recording medium (not illustrated) through the connectivity 1321 (FIG. 45) or the like is provided to the multiplexing/demultiplexing unit (MUX DMUX) 1518 through the video interface 1520, and demultiplexed, and decoded by the codec engine 1516. Image data obtained by the decoding of the codec engine 1516 is subjected to certain image processing performed by the image processing engine 1514, subjected to certain conversion performed by the display engine 1513, and provided to, for example, the connectivity 1321 (FIG. 45) or the like through the display interface 1512, and so the image is displayed on the monitor. Further, for example, image data obtained by the decoding of the codec engine 1516 is encoded by the codec engine 1516 again, multiplexed by the multiplexing/demultiplexing unit (MUX DMUX) 1518 to be converted into a transport stream, provided to, for example, the connectivity 1321 or the broadband modem 1333 (both FIG. 45) through the network interface 1519, and transmitted to another device (not illustrated).

Further, transfer of image data or other data between the processing units in the video processor 1332 is performed, for example, using the internal memory 1515 or the external memory 1312. Furthermore, the power management module 1313 controls, for example, power supply to the control unit 1511.

When the present disclosure is applied to the video processor 1332 having the above configuration, it is desirable to apply the above embodiments of the present disclosure to the codec engine 1516. In other words, for example, it is preferable that the codec engine 1516 have a functional block of implementing the encoding device and the decoding device according to the first embodiment. Furthermore, for example, as the codec engine 1516 operates as described above, the video processor 1332 can have the same effects as the effects described above with reference to FIGS. 1 to 20.

Further, in the codec engine 1516, the present disclosure (that is, the functions of the image encoding devices or the image decoding devices according to the above embodiments) may be implemented by either or both of hardware such as a logic circuit or software such as an embedded program.

The two exemplary configurations of the video processor 1332 have been described above, but the configuration of the video processor 1332 is arbitrary and may have any configuration other than the above two exemplary configurations. Further, the video processor 1332 may be configured with a single semiconductor chip or may be configured with a plurality of semiconductor chips. For example, the video processor 1332 may be configured with a three-dimensionally stacked LSI in which a plurality of semiconductors are stacked. Further, the video processor 1332 may be implemented by a plurality of LSIs.

(Application Examples to Devices)

The video set 1300 may be incorporated into various kinds of devices that process image data. For example, the video set 1300 may be incorporated into the television device 900 (FIG. 38), the mobile telephone 920 (FIG. 39), the recording/reproducing device 940 (FIG. 40), the imaging device 960 (FIG. 41), or the like. As the video set 1300 is incorporated, the devices can have the same effects as the effects described above with reference to FIGS. 1 to 20.

Further, the video set 1300 may be also incorporated into a terminal device such as the personal computer 1004, the AV device 1005, the tablet device 1006, or the mobile telephone 1007 in the data transmission system 1000 of FIG. 42, the broadcasting station 1101 or the terminal device 1102 in the data transmission system 1100 of FIG. 43, or the imaging device 1201 or the scalable encoded data storage device 1202 in the imaging system 1200 of FIG. 44. As the video set 1300 is incorporated, the devices can have the same effects as the effects described above with reference to FIGS. 1 to 20.

Further, even each component of the video set 1300 can be implemented as a component to which the present disclosure is applied when the component includes the video processor 1332. For example, only the video processor 1332 can be implemented as a video processor to which the present disclosure is applied. Further, for example, the processors indicated by the dotted line 1341 as described above, the video module 1311, or the like can be implemented as, for example, a processor or a module to which the present disclosure is applied. Further, for example, a combination of the video module 1311, the external memory 1312, the power management module 1313, and the front end module 1314 can be implemented as a video unit 1361 to which the present disclosure is applied. These configurations can have the same effects as the effects described above with reference to FIGS. 1 to 20.

In other words, a configuration including the video processor 1332 can be incorporated into various kinds of devices that process image data, similarly to the case of the video set 1300. For example, the video processor 1332, the processors indicated by the dotted line 1341, the video module 1311, or the video unit 1361 can be incorporated into the television device 900 (FIG. 38), the mobile telephone 920 (FIG. 39), the recording/reproducing device 940 (FIG. 40), the imaging device 960 (FIG. 41), the terminal device such as the personal computer 1004, the AV device 1005, the tablet device 1006, or the mobile telephone 1007 in the data transmission system 1000 of FIG. 42, the broadcasting station 1101 or the terminal device 1102 in the data transmission system 1100 of FIG. 43, the imaging device 1201 or the scalable encoded data storage device 1202 in the imaging system 1200 of FIG. 44, or the like. Further, as the configuration to which the present disclosure is applied is incorporated, the devices can have the same effects as the effects described above with reference to FIGS. 1 to 20, similarly to the video set 1300.

In the present specification, the description has been made in connection with the example in which various kinds of information such as the transform skip information and the transform skip flag are multiplexed into encoded data and transmitted from an encoding side to a decoding side. However, the technique of transmitting the information is not limited to this example. For example, the information may be transmitted or recorded as individual data associated with encoded data without being multiplexed into encoded data. Here, a term “associated” means that an image (or a part of an image such as a slice or a block) included in a bitstream can be linked with information corresponding to the image at the time of decoding. In other words, the information may be transmitted through a transmission path different from encoded data. Further, the information may be recorded in a recording medium (or a different recording area of the same recording medium) different from encoded data. Furthermore, the information and the encoded data may be associated with each other, for example, in arbitrary units of a plurality of frames, a frame, or parts of a frame.

In the present specification, a system represents a set of a plurality of components (devices, modules (parts), and the like), and all components need not be necessarily arranged in a single housing. Thus, both a plurality of devices that are arranged in individual housings and connected with one another via a network and a single device including a plurality of modules arranged in a single housing are regarded as a system.

The effects described in the present specification are merely examples, and other effects may be obtained.

Further, an embodiment of the present disclosure is not limited to the above embodiments, and various changes can be made within a scope not departing from the gist of the present disclosure.

For example, the present disclosure can also be applied to an encoding device or a decoding device according to an encoding scheme other than the HEVC scheme in which the transform skip can be performed.

Further, the present disclosure can be applied to an encoding device or a decoding device used when an encoded stream is received through a network medium such as satellite broadcasting, a cable television, the Internet, or a mobile telephone or when an encoded stream is processed on a storage medium such as an optical disk, a magnetic disk, or a flash memory.

For example, the present disclosure may have a cloud computing configuration in which one function is shared and jointly processed by a plurality of devices via a network.

The steps described above with reference to the flowchart may be performed by a single device or may be shared and performed by a plurality of devices.

Furthermore, when a plurality of processes are included in a single step, the plurality of processes included in the single step may be performed by a single device or may be shared and performed by a plurality of devices.

The present disclosure can have the following configurations as well.

(1)

A decoding device, including:

an inverse orthogonal transform unit that performs a transform skip in one of a horizontal direction and a vertical direction on a difference between an image and a predicted image of the image that has undergone the transform skip in one of the horizontal direction and the vertical direction.

(2)

The decoding device of (1), wherein

the inverse orthogonal transform unit is configured to perform an inverse orthogonal transform in the other of the horizontal direction and the vertical direction on the difference that has undergone the transform skip in one of the horizontal direction and the vertical direction.

(3)

The decoding device of (1) or (2), wherein

the inverse orthogonal transform unit performs the transform skip in one of the horizontal direction and the vertical direction on the difference based on transform skip information identifying which of the horizontal direction and the vertical direction the transform skip has been performed in.

(4)

The decoding device of (1) or (2), wherein

the inverse orthogonal transform unit performs the transform skip in one of the horizontal direction and the vertical direction on the difference based on a transform skip flag identifying that the transform skip has been performed and a prediction direction of intra prediction of the predicted image.

(5)

The decoding device of (1), (2) or (4), wherein

the inverse orthogonal transform unit performs the transform skip in one of the horizontal direction and the vertical direction on the difference based on a transform skip flag identifying that the transform skip has been performed and a shape of an inter prediction block of the predicted image.

(6)

The decoding device of any of (1) to (5), further including,

an inverse quantization unit that performs inverse quantization on the difference that has undergone the transform skip in the horizontal direction and been quantized using a quantization matrix that does not change in a row direction and changes in a column direction, wherein

the inverse orthogonal transform unit performs the transform skip in the horizontal direction on the difference that has undergone the inverse quantization by the inverse quantization unit.

(7)

The decoding device of any of (1) to (6), further including,

an inverse quantization unit that performs inverse quantization on the difference that has undergone the transform skip in the vertical direction and been quantized using a quantization matrix that does not change in a column direction and changes in a row direction, wherein

the inverse orthogonal transform unit performs the transform skip in the vertical direction on the difference that has undergone the inverse quantization by the inverse quantization unit.

(8)

The decoding device of any of (1) to (7), further including:

a lossless decoding unit that performs lossless decoding on a lossless encoding result of the difference that has undergone the transform skip in one of the horizontal direction and the vertical direction and been rotated in one of the horizontal direction and the vertical direction; and

a rotation unit that rotates the difference that has undergone the lossless decoding by the lossless decoding unit in one of the horizontal direction and the vertical direction, wherein

the inverse orthogonal transform unit is configured to perform the transform skip in one of the horizontal direction and the vertical direction on the difference rotated by the rotation unit.

(9)

The decoding device of (8), wherein

the predicted image is generated by intra prediction.

(10)

A decoding method, including:

an inverse orthogonal transform step of performing, by a decoding device, a transform skip in one of a horizontal direction and a vertical direction on a difference between an image and a predicted image of the image that has undergone the transform skip in one of the horizontal direction and the vertical direction.

(11)

An encoding device, including:

an orthogonal transform unit that performs a transform skip in one of a horizontal direction and a vertical direction on a difference between an image and a predicted image of the image.

(12)

The encoding device of (11), wherein

the orthogonal transform unit is configured to perform an orthogonal transform in the other of the horizontal direction and the vertical direction on the difference.

(13)

The encoding device of (11) or (12), further including,

a transmitting unit that transmits transform skip information identifying which of the horizontal direction and the vertical direction the transform skip has been performed on the difference through the orthogonal transform unit.

(14)

The encoding device of (11) or (12), further including,

a transmitting unit that transmits a transform skip flag identifying that the transform skip has been performed on the difference through the orthogonal transform unit, wherein

the orthogonal transform unit selects one of the horizontal direction and the vertical direction based on a prediction direction of intra prediction of the predicted image.

(15)

The encoding device of (11) or (12), further including,

a transmitting unit that transmits a transform skip flag identifying that the transform skip has been performed on the difference through the orthogonal transform unit, wherein

the orthogonal transform unit selects one of the horizontal direction and the vertical direction based on a shape of an inter prediction block of the predicted image.

(16)

The encoding device of any of (11) to (15), further including,

a quantization unit that performs quantization on the difference that has undergone the transform skip in the horizontal direction by the orthogonal transform unit using a quantization matrix that does not change in a row direction but changes in a column direction.

(17)

The encoding device of any of (11) to (16), further including,

a quantization unit that performs quantization on the difference that has undergone the transform skip in the vertical direction by the orthogonal transform unit using a quantization matrix that does not change in a column direction but changes in a row direction.

(18)

The encoding device of any of (11) to (17), further including:

a rotation unit that rotates the difference that has undergone the transform skip by the orthogonal transform unit in one of the horizontal direction and the vertical direction; and

a lossless encoding unit that performs lossless encoding on the difference rotated by the rotation unit.

(19)

The encoding device of (18), wherein

the predicted image is generated by intra prediction.

(20)

An encoding method, including:

an orthogonal transform step of performing, by an encoding device, a transform skip in one of a horizontal direction and a vertical direction on a difference between an image and a predicted image of the image.

### REFERENCE SIGNS LIST

10 Encoding device
13 Transmitting unit
34 Orthogonal transform unit
35 Quantization unit
110 Decoding device
132 Lossless decoding unit
133 Inverse quantization unit
134 Inverse orthogonal transform unit
161 Rotation unit
162 Lossless encoding unit
181 Rotation unit

1. A decoding device, comprising:
an inverse orthogonal transform unit that performs a transform skip in one of a horizontal direction and a vertical direction on a difference between an image and a predicted image of the image that has undergone the transform skip in one of the horizontal direction and the vertical direction.

2. The decoding device according to claim 1, wherein
the inverse orthogonal transform unit is configured to perform an inverse orthogonal transform in the other of the horizontal direction and the vertical direction on the difference that has undergone the transform skip in one of the horizontal direction and the vertical direction.

3. The decoding device according to claim 1, wherein
the inverse orthogonal transform unit performs the transform skip in one of the horizontal direction and the vertical direction on the difference based on transform skip information identifying which of the horizontal direction and the vertical direction the transform skip has been performed in.

4. The decoding device according to claim 1, wherein
the inverse orthogonal transform unit performs the transform skip in one of the horizontal direction and the vertical direction on the difference based on a transform skip flag identifying that the transform skip has been performed and a prediction direction of intra prediction of the predicted image.

5. The decoding device according to claim 1, wherein
the inverse orthogonal transform unit performs the transform skip in one of the horizontal direction and the vertical direction on the difference based on a transform skip flag identifying that the transform skip has been performed and a shape of an inter prediction block of the predicted image.

6. The decoding device according to claim 1, further comprising,
an inverse quantization unit that performs inverse quantization on the difference that has undergone the transform skip in the horizontal direction and been quantized using a quantization matrix that does not change in a row direction and changes in a column direction, wherein
the inverse orthogonal transform unit performs the transform skip in the horizontal direction on the difference that has undergone the inverse quantization by the inverse quantization unit.

7. The decoding device according to claim 1, further comprising,
an inverse quantization unit that performs inverse quantization on the difference that has undergone the transform skip in the vertical direction and been quantized using a quantization matrix that does not change in a column direction and changes in a row direction, wherein
the inverse orthogonal transform unit performs the transform skip in the vertical direction on the difference that has undergone the inverse quantization by the inverse quantization unit.

8. The decoding device according to claim 1, further comprising:
a lossless decoding unit that performs lossless decoding on a lossless encoding result of the difference that has undergone the transform skip in one of the horizontal direction and the vertical direction and been rotated in one of the horizontal direction and the vertical direction; and
a rotation unit that rotates the difference that has undergone the lossless decoding by the lossless decoding unit in one of the horizontal direction and the vertical direction, wherein
the inverse orthogonal transform unit is configured to perform the transform skip in one of the horizontal direction and the vertical direction on the difference rotated by the rotation unit.

9. The decoding device according to claim 8, wherein
the predicted image is generated by intra prediction.

10. A decoding method, comprising:
an inverse orthogonal transform step of performing, by a decoding device, a transform skip in one of a horizontal direction and a vertical direction on a difference between an image and a predicted image of the image that has undergone the transform skip in one of the horizontal direction and the vertical direction.

11. An encoding device, comprising:
an orthogonal transform unit that performs a transform skip in one of a horizontal direction and a vertical direction on a difference between an image and a predicted image of the image.

12. The encoding device according to claim 11, wherein
the orthogonal transform unit is configured to perform an orthogonal transform in the other of the horizontal direction and the vertical direction on the difference.

13. The encoding device according to claim 11, further comprising,
a transmitting unit that transmits transform skip information identifying which of the horizontal direction and the vertical direction the transform skip has been performed on the difference through the orthogonal transform unit.

14. The encoding device according to claim 11, further comprising,
a transmitting unit that transmits a transform skip flag identifying that the transform skip has been performed on the difference through the orthogonal transform unit, wherein
the orthogonal transform unit selects one of the horizontal direction and the vertical direction based on a prediction direction of intra prediction of the predicted image.

15. The encoding device according to claim 11, further comprising,
a transmitting unit that transmits a transform skip flag identifying that the transform skip has been performed on the difference through the orthogonal transform unit, wherein
the orthogonal transform unit selects one of the horizontal direction and the vertical direction based on a shape of an inter prediction block of the predicted image.

16. The encoding device according to claim 11, further comprising,
a quantization unit that performs quantization on the difference that has undergone the transform skip in the horizontal direction by the orthogonal transform unit using a quantization matrix that does not change in a row direction but changes in a column direction.

17. The encoding device according to claim 11, further comprising,
a quantization unit that performs quantization on the difference that has undergone the transform skip in the vertical direction by the orthogonal transform unit using a quantization matrix that does not change in a column direction but changes in a row direction.

18. The encoding device according to claim 11, further comprising:
a rotation unit that rotates the difference that has undergone the transform skip by the orthogonal transform unit in one of the horizontal direction and the vertical direction; and
a lossless encoding unit that performs lossless encoding on the difference rotated by the rotation unit.

19. The encoding device according to claim 18, wherein
the predicted image is generated by intra prediction.

20. An encoding method, comprising:
an orthogonal transform step of performing, by an encoding device, a transform skip in one of a horizontal direction and a vertical direction on a difference between an image and a predicted image of the image.
